(19) United States
(12) Patent Application Publication
(10) Pub. No.: US 2021/0272040 A1
(43) Pub. Date: Sep. 2, 2021

(54) SYSTEMS AND METHODS FOR LANGUAGE AND SPEECH PROCESSING WITH ARTIFICIAL INTELLIGENCE

(71) Applicant: Decooda International, Inc., Atlanta, GA (US)

(72) Inventors: David Johnson, Atlanta, GA (US); Venkata Aditya Chintala, Atlanta, GA (US); Charles Wardell, Atlanta, GA (US); Guruprasad Venkataraghavan, Atlanta, GA (US)

(21) Appl. No.: 17/185,721

(22) Filed: Feb. 25, 2021

Related U.S. Application Data
(60) Provisional application No. 62/983,420, filed on Feb. 28, 2020.

(51) Int. Cl. G06Q 10/06; G06F 40/284; G06F 40/30; G10L 25/63; G10L 25/24; G10L 15/06; G10L 15/22; G06N 5/02; G06Q 40/04

(52) U.S. Cl. CPC G06Q 10/06375; G06F 40/284; G06F 40/30; G10L 25/63; G06F 40/205; G10L 15/063; G10L 15/22; G06N 5/02; G06Q 40/04; G10L 25/24

(57) ABSTRACT

A language computing system includes one or more processing circuits having one or more processors and memory. The memory store instructions that, when executed by the one or more processors, cause the one or more processors to perform operations including obtaining one or more textual documents including information related to a company, generating a future pattern model describing patterns of the company, providing the one or more textual documents to the future pattern model to generate a predicted pattern of the company, and providing the predicted pattern to a user.

### CROSS-REFERENCE TO RELATED PATENT APPLICATIONS

This application claims priority from U.S. Provisional Patent Application No. 62/983,420, filed Feb. 28, 2020, incorporated herein by reference in its entirety.

### BACKGROUND

The present disclosure relates generally to systems for and methods of data processing including but not limited to language and speech processing, such as language and speech processing with artificial intelligence.

Analyzing textual information related to companies (or other establishments) can be valuable in learning information regarding the companies. However, information related a particular company may disjointed and may include a large amount of information that is difficult for an individual to manually parse through. These and other limitations may prevent users from gaining valuable insight to the companies that can help inform decisions of the users.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of a language computing system, according to some embodiments.

FIG. 2 is a block diagram of hypothesis engine of the language computing system illustrated in FIG. 1, according to some embodiments.

FIG. 3 is an illustration of a convolutional neural network (CNN), according to some embodiments.

FIG. 4 is a block diagram of ontology graph generator illustrated in the language computing system of FIG. 1, according to some embodiments.

FIG. 5 is a block diagram of a common sense knowledge (CSK) engine of the language computing system illustrated in FIG. 1, according to some embodiments.

FIG. 6 is a block diagram of a pattern validator of the language computing system illustrated in FIG. 1, according to some embodiments.

FIG. 7A is a flow diagram of a process illustrating communication and operation among the hypothesis engine illustrated in FIG. 2, the CSK engine illustrated in FIG. 5, and the pattern validator illustrated in FIG. 6, according to some embodiments.

FIG. 7B is an illustration of an interaction between a CSK database with the ontology graph generator illustrated in FIG. 4 and the hypothesis engine illustrated in FIG. 2, according to some embodiments.

FIG. 8 is a flow diagram of a process for generating predictions of stock prices, according to some embodiments.

FIG. 9A is a flow diagram of a process for generating and evaluating historical and future patterns, according to some embodiments.

FIG. 9B is a flow diagram of a process for generating and evaluating historical and future patterns, according to some embodiments.

FIG. 10 is a flow diagram of a process performed by a second deep learning model of the processes of FIGS. 9A and 9B, according to some embodiments.

FIG. 11 is a flow diagram of a process for providing predicted patterns to a user, according to some embodiments.

FIG. 12 is a flow diagram of a process for generating and revising predicted patterns, according to some embodiments.

FIG. 13A is an illustration of an event pattern that can be generated by the hypothesis engine illustrated in FIG. 2, according to some embodiments.

FIG. 13B is a graph of associations that can be stored in a CSK database, according to some embodiments.

FIG. 14 is a flow diagram of a process for allowing users to provide information for generating predictions and updating the predictions, according to some embodiments.

FIG. 15 is a flow diagram of a process for predicting future probabilities and forecasting future events, according to some embodiments.

FIG. 16 is a flow diagram of a process for generating predictions and storing knowledge of regarding a company, according to some embodiments.

FIG. 17 is a block diagram of a decentralized artificial intelligence (AI) system, according to some embodiments.

FIG. 18 is a flow diagram of a process that can be performed by an AI system, according to some embodiments.

FIG. 19 is a flow diagram of a process for performing auto-topic discovery and validating results of the auto-topic discovery, according to some embodiments.

FIG. 20 is a block diagram of an emotion recognition system, according to some embodiments.

FIG. 21A is a graph illustrating a number of frames versus a number of utterances, according to some embodiments.

FIG. 21B is an illustration representing an example structure of a long short-term memory (LSTM) autoencoder, according to some embodiments.

FIG. 22 is an illustration of a structure of an LSTM categorical embedding extractor, according to some embodiments.

FIG. 23A is a block diagram of an impact analyzer for identifying an impact of topics on customer behavior changes, according to some embodiments.

FIG. 23B is a block diagram of an impact analysis module of the impact analyzer illustrated in FIG. 23A, according to some embodiments.

FIG. 23C is a flow diagram of a process for performing an impact analysis, according to some embodiments.

FIG. 23D is a flow diagram of a process for performing an impact analysis, according to some embodiments.

FIG. 23E is an illustration representing a flow of information in an impact analysis, according to some embodiments.

FIG. 24A is an illustration of usage of an imaginative question, according to some embodiments.

FIG. 24B is an illustration of information that can be extracted from an example imaginative question, according to some embodiments.

FIG. 25A is a graph illustrating an impact score scatter plot, according to some embodiments.

FIG. 25B is a graph illustrating a unified impact score bar chart, according to some embodiments.

FIG. 26A is a block diagram of a content summarization engine, according to some embodiments.

FIG. 26B is a diagram of a summarization engine architecture, according to some embodiments.

FIG. 27 is an illustration of an example domain graph, according to some embodiments.

FIG. 28 is a flow diagram of a process for generating a content summarization, according to some embodiments.

FIG. 29 is a graphical illustration of a user interface that can be provided to a user device, according to some embodiments.

FIG. 30A is a flow diagram of a process for utilizing a price-value optimization model, according to some embodiments.

FIG. 30B is a flow diagram of a process continuing the process of FIG. 30A, according to some embodiments.

FIG. 31 is a flow diagram of a process for calculating a reward function, according to some embodiments.

FIG. 32A is a graph illustrating an example stock price over time, according to some embodiments.

FIG. 32B is a graph illustrating a de-trended version of the graph of FIG. 32A, according to some embodiments.

FIG. 32C is an illustration of an example rolling window forecast, according to some embodiments.

FIG. 32D is a graph of an example comparison between actual stock prices versus predicted stock prices, according to some embodiments.

### DETAILED DESCRIPTION

Referring generally to the FIGURES, systems for and methods of performing data processing including but not limited to language, speech, and text processing using artificial intelligence (AI) are shown and described, according to some embodiments. As referred to herein, language processing may be used to refer generally to processing of text, speech, and/or other forms of language-based communication. Utilizing artificial intelligence in language processing can allow systems to extract various information from articles (e.g., interview, television broadcasts, speeches, phone conversations, news articles, social media posts, etc.). Based on the extracted information, predictions can be made regarding trends of a company or other establishment (e.g., an individual, a government, etc.). If a large data set (e.g., hundreds of documents, thousands of documents, etc.) is utilized, AI can be trained to make predictions based on the information extracted.

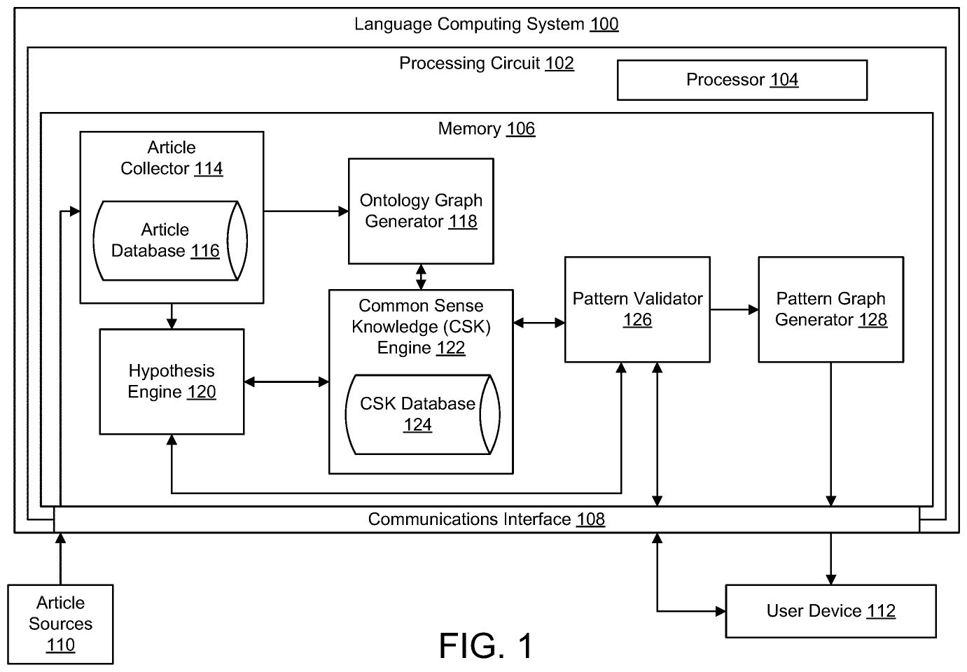

Referring now to FIG. 1, a block diagram of a language computing system 100 is shown, according to some embodiments. Language computing system 100 can provide various utilities in performing language processing. In particular, language computing system 100 can predict patterns in real world scenarios based on preexisting information.

Language computing system 100 is shown to include a communications interface 108 and a processing circuit 102. Communications interface 108 may include wired or wireless interfaces (e.g., jacks, antennas, transmitters, receivers, transceivers, wire terminals, etc.) for conducting data communications with various systems, devices, or networks. For example, communications interface 108 may include an Ethernet card and port for sending and receiving data via an Ethernet-based communications network and/or a Wi-Fi transceiver for communicating via a wireless communications network. Communications interface 108 may be configured to communicate via local area networks or wide area networks (e.g., the Internet, a building WAN, etc.) and may use a variety of communications protocols (e.g., BACnet, IP, LON, etc.).

Communications interface 108 may be a network interface configured to facilitate electronic data communications between language computing system 100 and various external systems or devices (e.g., article sources 110, a user device 112, etc.). For example, language computing system 100 may receive articles from article sources 110 via communications interface 108.

Language computing system 100 is shown to communicate with a user device 112. User device 112 can be any sort of computing device associated with a user. In some embodiments, language computing system 100 communicates with multiple user devices 112. In this case, each user device 112 may be associated with a particular user that may interact with language computing system 100. For example, users may include experts/analysts that language computing system 100 is obtaining feedback on patterns from, a user who is requesting patterns and other predictions from language computing system 100, etc.

User device 112 can allow a user to interact with language computing system 100. For example, user device 112 may allow the user to view/access graphs, provide feedback on predicted patterns, etc. User device 112 may include any wearable or non-wearable device (e.g., a computer a laptop, a work station, etc.). Wearable devices can refer to any type of device that an individual wears including, but not limited to, a watch (e.g., a smart watch), glasses (e.g., smart glasses), bracelet (e.g., a smart bracelet), etc. User device 112 may also include any type of mobile device including, but not limited to, a phone (e.g., smart phone), a tablet, a personal digital assistant, etc. In some embodiments, user device 112 includes other computing devices such as a desktop computer, a laptop computer, etc.

Processing circuit 102 is shown to include a processor 104 and memory 106. Processor 104 may be a general purpose or specific purpose processor, an application specific integrated circuit (ASIC), one or more field programmable gate arrays (FPGAs), a group of processing components, or other suitable processing components. Processor 104 may be configured to execute computer code or instructions stored in memory 106 or received from other computer readable media (e.g., CDROM, network storage, a remote server, etc.).

Memory 106 may include one or more devices (e.g., memory units, memory devices, storage devices, etc.) for storing data and/or computer code for completing and/or facilitating the various processes described in the present disclosure. Memory 106 may include random access memory (RAM), read-only memory (ROM), hard drive storage, temporary storage, non-volatile memory, flash memory, optical memory, or any other suitable memory for storing software objects and/or computer instructions. Memory 106 may include database components, object code components, script components, or any other type of information structure for supporting the various activities and information structures described in the present disclosure. Memory 106 may be communicably connected to processor 104 via processing circuit 102 and may include computer code for executing (e.g., by processor 104) one or more processes described herein. In some embodiments, one or more components of memory 106 are part of a singular component. However, each component of memory 106 is shown independently for ease of explanation.

In some embodiments, one or more components of memory 106 are implemented in separate computing systems. For example, article collector 114 and article database 116 may be implemented in a separate computing system. In the example, article collector 114 can provide articles to language computing system 100 for further processing. If components of memory are divided among multiple computing systems, each computing system may be configured to communicate with one another such that data and other information can be transferred between computing systems. Nonetheless, each component of memory 106 is shown in a single computing system (i.e., language computing system 100) for ease of explanation.

In some embodiments, language computing system 100 is a distributed computing system. In this case, language computing system 100 may include multiple processing circuits 102, multiple processors 104, etc., that are distributed across multiple computing systems. In some embodiments, language computing system 100 implements parallel computing functionality such that multiple processors can operate concurrently to expedite data processing.

Memory 106 is shown to include an article collector 114. Article collector 114 can collect articles from article sources 110 to store in an article database 116. As described herein, articles can include any documents that include some form of textual language. For example, articles may include news articles, analyst notes, journals, books, social media posts (e.g., Twitter posts, Facebook posts, etc.), transcribed speeches, emails, etc. Likewise, article sources 110 can include various sources of articles such as, for example, newspapers, journals, external databases, news websites, application programming interfaces (APIs) that can provide textual documents, manual user entries, etc. As used herein, “text data” or “textual data” may be used interchangeably with articles to describe information/data including text.

In some embodiments, article sources 110 include internal sources of information a company. For example, a call operator in a call center may be equipped with a universal serial bus (USB) device (or other storage device) that can track and record all calls between the call operator and customers. The USB can provide a mobile storage platform that can be used by the call operator across the call center. For example, the call operator may move between call stations in the call center and can plug the USB into each call station to record calls at each station. In this example, after one or more calls between the call operator and customers are recorded and stored on the USB, the call operator can connect the USB to a device (e.g., a computer, a mobile device, etc.) that can communicate the stored audio recordings to language computing system 100. In some embodiments, the USB includes transcription functionality such that all calls and saved call information provided as textual documents to language computing system 100 are provided using the USB. The functionality can be trained for the particular user over time as the USB is allocated to the particular user. Information provided by the USB may provide valuable insight for language computing system 100 in generating predictions of the company. For example, if the information recorded by the USB indicates that fewer customers are purchasing products, language computing system 100 may determine that earnings will be lower over a next quarter and can predict a decrease in stock value. As should be appreciated, if internal sources of information are available as article sources 110, the internal sources can be valuable for language computing system 100 in generating predictions for a company.

In some embodiments, article database 116 requires all documents stored therein to be text-based. In this case, if article sources 110 provide articles in other formats (e.g., audio-based), article collector 114 may require the documents be transcribed. In some embodiments, article collector 114 includes transcription functionality such that incoming documents that are not text-based can be converted into a text format. For example, article collector 114 may be able to receive an audio file and transcribe the audio file into a textual document. In some embodiments, article collector 114 can directly store audio or other types of documents for direct processing. In some embodiments, article collector 114 may discard documents and files that are not text-based if received from article sources 110. As should be appreciated, article collector 114 can be configured and customized to handle different forms of language documents depending on implementation. However, as described below, textual documents are the primary point of focus for ease of explanation and understanding.

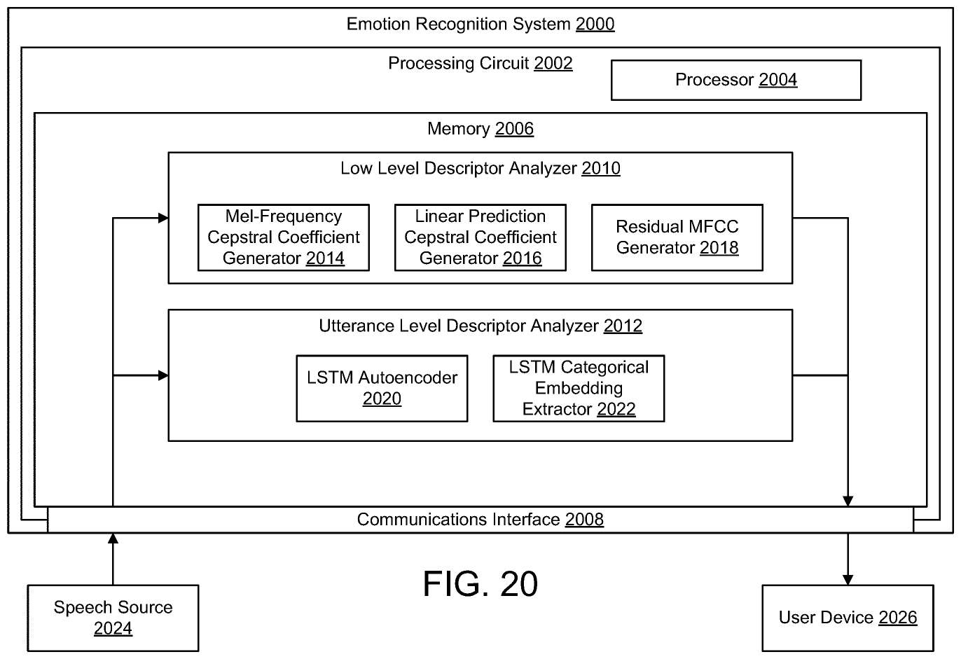

Article collector 114 can incorporate various methodologies for article collection. For example, article collector 114 may utilize web scrapers, bots that monitor and extract information from calls and conferences (e.g., earnings calls, video conferences, etc.), request articles from APIs, receive documents manually entered by users, etc. In some embodiments, article collector 114 includes functionality to extract information from live sources of data. For example, article collector 114 may include a transcription module that can monitor an earnings call for a company and extract words, phrases, etc. from the earnings call. In this way, predictions can be generated by language computing system 100 dynamically and based on live data. In the example of the earnings call, this may be helpful such that stock predictions can be made as the earnings call is occurring and faster than a human analyst could generate, thereby providing a user a competitive advantage in determining whether to buy, sell, and/or hold stock. In some embodiments, article collector 114 includes emotion recognition capabilities such that audio inputs can be interpreted for both language and emotion of a person speaking. As such, article collector 114 may include some and/or all of the functionality of emotion recognition system 2000 as described below with reference to FIG. 20.

In some embodiments, article collector 114 includes one or more bots that can contact specific people and gather their input on certain topics. For example, a bot of article collector 114 may periodically and/or occasionally reach out to an executive of a company (e.g., a chief executive officer (CEO), a chief financial officer (CFO), a chief security office (CSO), etc.) to request feedback of the executive to particular questions (e.g., via text messages, phone calls, emails, voice over Internet Protocol (VoIP), or other appropriate forms of communication). In the example, the bot may request the executive to provide an opinion on questions regarding earnings of the company. Responsive to feedback from the executive, the bot may be configured to ask follow-up questions to gather additional clarifying information from the executive. For example, if the executive responds a question requesting projected earnings over a quarter, the bot may follow up with questions requesting estimated expenses for the quarter, estimated sales for the quarter, etc., in order to gather more information regarding the projected earnings.

Bots for requesting information from individuals can be particularly useful in private equity situations where investors in a company want to identify as much information regarding a direction of the company as possible. In this way, rather than requiring investors to personally reach out to executives (or other employees) of the company to obtain new information, one or more bots of article collector 114 can automatically obtain feedback from the executives which can be used by language computing system 100 in predicting a trajectory of the company. In some embodiments, questions asked by the one or more bots are automatically generated by article collector 114 based on previous questions that generate meaningful feedback, are provided by a user (e.g., via user device 112), or are obtained from any other appropriate source.

Some and/or all documents procured by article collector 114 can be stored in article database 116 for later access and processing. In some embodiments, article database 116 is hosted by an external system/provider (e.g., a cloud provider). However, article database 116 is shown as a component of language computing system 100 for ease of explanation.

Article collector 114 can provide articles stored in article database 116 to an ontology graph generator 118 and a hypothesis engine 120. Described broadly, ontology graph generator 118 can generate graphs describing information extracted from the articles stored in article database 116. More particularly, ontology graph generator 118 can generate graphs that capture the various relationships, knowledge, and/or other information describing companies as extracted from the articles. It should be appreciated that while companies are referred to specifically throughout the present disclosure, similar approaches to those described herein can be applied to other establishments such as governments, individuals, etc., that may be analyzed based on articles and other textual documents. For example, article-based predictions as described below can be generated similarly with respect to governments as with companies. However, in the example, predictions may be with respect to variables such as government debt as opposed to variables such as stock price for companies. As such, specific references to companies should not be interpreted as limiting on the present disclosure.

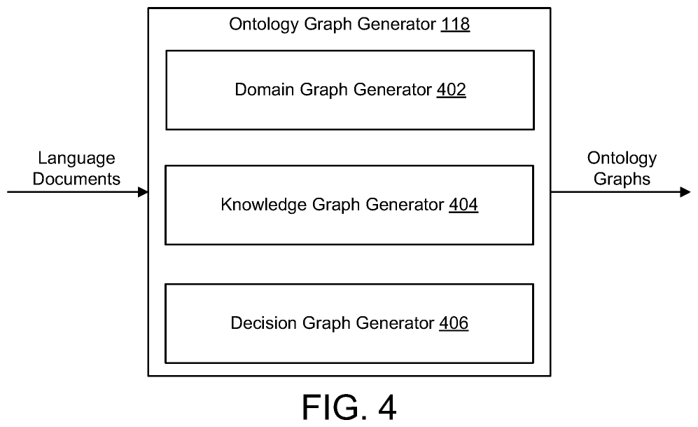

Ontology graph generator 118 can generate graphs that include some and/or all the information being tracked regarding a company and any other information necessary to track knowledge regarding the company into the future. The graphs generated by ontology graph generator 118 may include domain graphs, knowledge graphs, and decision graphs. The graphs and other functionality of ontology graph generator 118 is described in greater detail with reference to FIG. 4. In some embodiments, some and/or all of the functionality of ontology graph generator 118 is incorporated in common sense knowledge engine 122 described in detail below.

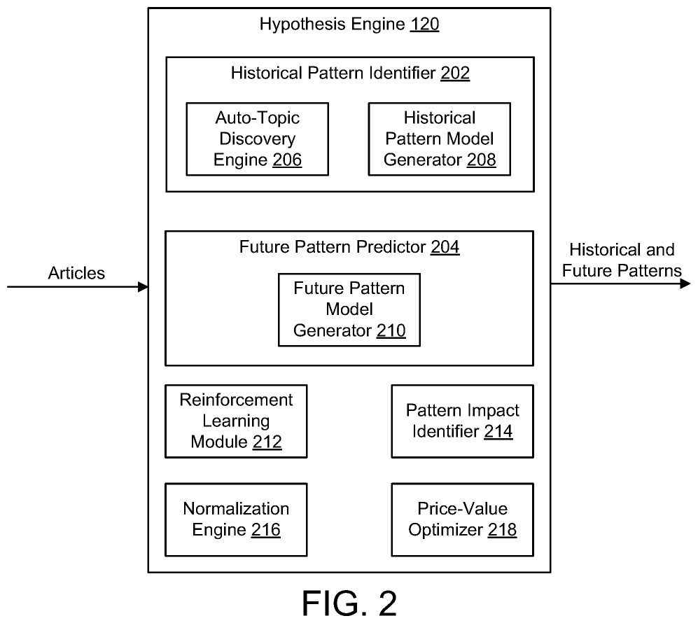

Hypothesis engine 120 can also receive text data (i.e., articles) from article collector 114. While hypothesis engine 120 is described in detail below with reference to FIG. 2, a brief description of hypothesis engine 120 will be provided here. Hypothesis engine 120 can be generally described as a knowledge pattern predictor. Hypothesis engine 120 can take many articles (e.g., hundreds of articles, thousands of articles, etc.) as an input and can generate meaningful insights into the future. Hypothesis engine 120 can also take historical text data describing a company stored in article database 116 and can identify meaningful events in the company's history.

Hypothesis engine 120 can utilize artificial intelligence to generate various predictions. For example, hypothesis engine 120 may utilize AI to identify market events from raw text data feeds that can help predict financial results such as stock price trend, earnings, earnings per share, cash flow, revenue, and credit risk. In this way, hypothesis engine 120 may effectively be a standardized engine that can generate predictive results across various financial metrics using a wide variety of text documents. Ideally, even with respect to volatility and unpredictability of asset pricing and their underlying drivers, hypothesis engine 120 can identify correct stock direction and improve predictions upon consensus estimates so that users can make more informed decisions.

In some embodiments, hypothesis engine 120 takes historical text data and identifies meaningful events in a company's recent history. An estimated impact of the identified events on variables of interest can be recorded by hypothesis engine 120. For example, hypothesis engine 120 may record an impact on variables of interest such as a company's quarterly-reported free cash flow, revenue, earnings per share (EPS), credit risk, and stock changes. Once significant events have been identified, hypothesis engine 120 can generate predictions/hypothesis. As a specific example, hypothesis engine 120 may record how quarterly reports (e.g., quarterly earnings reports) for a company change over time and generate predictions based on the change. Hypothesis engine 120 can be configured to predict possible meaningful events in the future and estimate an effect of the possible events on the variables of interest. In some embodiments, predictions made by hypothesis engine 120 are solely based on the information found in the form of text. However, in some embodiments, hypothesis engine 120 may be able to utilize other forms of information such as audio or video.

In some embodiments, after predictions are generated, hypothesis engine 120 can continuously update forecasts based on newly obtained articles. For example, article collector 114 may collect articles from a live newsfeed that can be fed to hypothesis engine 120 to update the forecasts. If the newly received articles support the predictions, hypothesis engine 120 can update a confidence value associated with a predicted pattern. However, if the newly received articles do not support the prediction, hypothesis engine 120 may enter a simulation mode and output a new prediction with a low confidence value. If a prediction is based on simulated data and provided to a user, hypothesis engine 120 can make a user aware that the predictions are simulated (e.g., by flagging simulated predictions). In addition, hypothesis engine 120 may be able to store some and/or all the information collected through text in a graph database (e.g., CSK database 124) for future reference and prediction justification.

Hypothesis engine 120 can utilize artificial intelligence models to identify historical patterns and to predict future patterns for companies. In effect, hypothesis engine 120 can represent patterns of information from previous events and can predict future patterns by adapting historical patterns to solve a knowledge gap. Approaches utilized by hypothesis engine 120 may be similar to case-based reasoning and model-based reasoning. Advantageously, hypothesis engine 120 can provide straightforward knowledge representation and can automatically improve knowledge of events over time. Hypothesis engine 120 can highlight important case representations and can quickly identify solutions based on previous events. Due to incorporation of AI models, hypothesis engine 120 may be implemented on a computer system that facilitates parallel processing to significantly expedite processing times.

Prior to hypothesis engine 120 generating predictions, hypothesis engine 120 may require extensive human interaction to refine an AI model and predictions associated therewith. In an initial phase of deployment, a series of quick-like questions can be provided to users (e.g., via user device 112) in order to determine a viability of patterns identified by hypothesis engine 120. Based on user feedback, the AI models of hypothesis engine 120 can be progressively refined to reach a higher level of viability. Over time, a confidence level in statistical patterns detected by the AI models may increase, thereby resulting less need for human interaction. In this way, hypothesis engine 120 can adapt to maximize viability and accuracy of identified patterns.

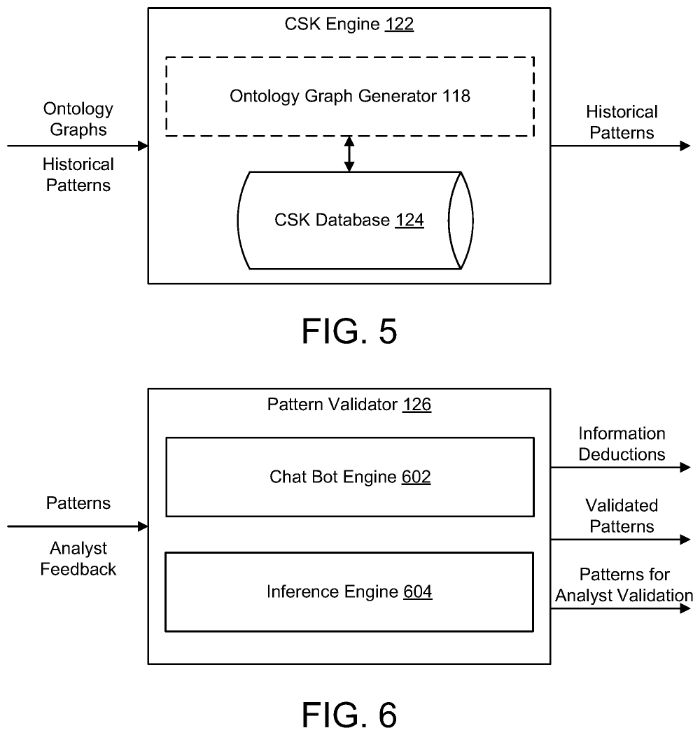

In language computing system 100, ontology graph generator 118 can provide the ontological graphs (e.g., the domain graphs, the knowledge graphs, and the decision graphs) to a common sense knowledge (CSK) engine 122. Likewise, hypothesis engine 120 can provide identified historical and/or future patterns to CSK engine 122. Based on the ontological graphs and patterns, CSK engine 122 can extract entities associated with patterns to store in a CSK database 124. CSK database 124 can include all the reasoning behind patterns, facts, entities, logical and causal links surrounding various entities, etc. As described herein, an entity may refer to subjects or names. In some embodiments, CSK database 124 is effectively a combination of domain graphs and knowledge graphs provided by ontology graph generator 118 with unnecessary information removed. In this way, CSK database 124 can store entities related to companies and organizations that analysts (or other individuals) care about as well as user-defined classifiers that are deemed necessary. CSK engine 122 is described in greater detail below with reference to FIG. 5.

CSK engine 122 can provide historical patterns and reasoning behind the patterns as stored in CSK database 124 to a pattern validator 126. Pattern validator 126 may also receive predicted future patterns from hypothesis engine 120. Based on received patterns, pattern validator 126 may determine a validity of the patterns and can generate knowledge surrounding new patterns. In some embodiments, to perform validation and generation of knowledge, pattern validator 126 incorporates one or more chat bots. A chat bot can interact with users (e.g., via user device 112) such that the users can provide feedback regarding the patterns. In particular, based on the received patterns, pattern validator 126 can identify experts that may be qualified to provide meaningful feedback on the patterns. The chat bots can then contact the experts to solicit their feedback regarding whether each expert thinks the patterns are valid, why the experts believe the patterns are valid/invalid, etc.

The chat bots may obtain information from users in a variety of ways. For example, the chat bots may text a specific user device 112 of an expert and obtain feedback by a text message. As another example, the users may access a specific website and/or computer application to provide feedback through. As yet another example, the expert may provide an audio recording that articulates their feedback. In this case, pattern validator 126 may transcribe the audio recording into textual data.

The experts can indicate whether a provided pattern is valid. If the experts indicate the pattern is valid, pattern validator 126 can provide the pattern to pattern graph generator 128 to be provided to an end user. However, if the experts indicate the pattern is not valid, various actions can be taken. For example, an indication that a pattern is invalid may result in a retraining of predictive models (e.g., the historical pattern model or the future pattern model). As another example, the pattern may nonetheless be provided to the end user, but can be marked as possibly invalid.

Based on feedback of the experts, pattern validator 126 can extract important information and provide the information to CSK engine 122 and/or hypothesis engine 120 to help refine further predictions. Additionally, based on the feedback, pattern validator 126 can generate/identify new knowledge surrounding the patterns as provided by the experts. Pattern validator 126 is described in greater detail below with reference to FIG. 6.

Still referring to FIG. 1, memory 106 is also shown to include a pattern graph generator 128. Pattern graph generator 128 can receive verified and/or validated patterns along with associated reasoning from pattern validator 126. In this case, an expert may, as a result of operations performed by pattern validator 126, indicate that a future prediction pattern is accurate and can be provided confidently to users. Based on the verified/validated patterns and associated reasoning, pattern graph generator 128 can generate real world pattern graphs that allow users to view the patterns and perform further analysis. In some embodiments, pattern graph generator 128 generates associated graphical displays for the real world pattern graphs. Pattern graph generator 128 can provide the real world pattern graphs and/or the graphical displays to user device 112 via communications interface 108. This allows a user to visually observe the patterns and perform additional analysis based on the patterns.

In some embodiments, language computing system 100 includes some and/or all of the functionality of the knowledge extraction techniques described with reference to U.S. Provisional Patent Application No. 62/887,609 filed Aug. 15, 2019, the entirety of which is incorporated by reference herein. In this way, language computing system 100 may include additional functionality for generating granular insights into text documents that may help in various applications such as preparing high quality classifiers and for automatically generating classifiers as described in greater detail in U.S. Provisional Patent Application No. 62/887,609. In some embodiments, the various knowledge extraction techniques described in U.S. Provisional Patent Application No. 62/887,609 are implemented as a separate system that may be able to communicate with language computing system 100 and/or other systems/devices described throughout the FIGURES.

Referring now to FIG. 2, hypothesis engine 120 of language computing system 100 is shown in greater detail, according to some embodiments. Hypothesis engine 120 can incorporate various machine learning architectures to generate future pattern predictions. In particular, hypothesis engine 120 may utilize a convolutional neural network (CNN) and a recurrent neural network (RNN) in the form of a long short-term memory (LSTM) model. Advantageously, hypothesis engine 120 can combine the CNN and LSTM to utilize their respective abilities on different aspects of data (e.g., a likelihood of impactful events occurring, a trend of a stock, etc.) to create future predictions. In this case, the CNN can be used to calculate probabilities of events being mentioned in a text document. The RNN/LSTM model may work well with time-series and sequence data and therefore can be used to predict various trends based on historical trends (e.g., predict 180-day stock prices based on historical stock prices). Based on the historic trends, predictions can be adjusted by performing column-wise and time-series normalization that allows for certain events (e.g., one-off events) to be muted and other events (e.g., events with high recurring likelihood) to be amplified. The term “trend” may be used interchangeably with the term “pattern” herein.

Hypothesis engine 120 is shown to include a historical pattern identifier 202 and a future pattern predictor 204. Historical pattern identifier 202 can extract/identify patterns associated with companies based on provided articles. In some embodiments, historical pattern identifier 202 requires a minimum amount of article data for a company to be provided before historical pattern identifier 202 extracts the patterns and/or provides the identified patterns to other components of language computing system 100 (e.g., to future pattern predictor 204). For example, historical pattern identifier 202 may require a minimum of two years of textual data, at least 1000 articles, etc., for a particular company before historical pattern identifier 202 identifies historical patterns for the company. Setting a minimum amount of article data can ensure that historical patterns identified based on the text data have a higher likelihood of being valid as opposed to patterns identified based on small amounts of data (e.g., based on 2 articles, 1 week worth of data, etc.).

To identify the historical patterns, historical pattern identifier 202 can utilize AI models (e.g., CNNs) to identify/extract the historical patterns for various companies. A historical pattern model generator 208 of historical pattern identifier 202 may generate a specific model for each company being analyzed. In other words, historical pattern identifier 202 may generate models for companies on a one-to-one basis (i.e., one model for one company). In this way, historical pattern identifier 202 can identify historical patterns respective to each company based on a specialized model for each company. Historical pattern model generator 208 and the historical pattern models are described in greater detail below.

Before generating a model for a company, a first piece of information to obtain is a uniquely identifying piece of information of the company (e.g., a name of the company, a ticker symbol associated with the company, etc.). Based on the unique identifier, historical pattern identifier 202 can gather articles associated with the company from article collector 114. If a minimum required amount of articles regarding the company (e.g., 2 years of articles, 10,000 articles, etc.) are already stored in article database 116, article collector 114 can directly provide the articles to historical pattern identifier 202. However, if more articles are required for historical pattern identification, historical pattern identifier 202 can instruct article collector 114 to gather additional articles. In this case, if the company of interest has little coverage (e.g., one article is published regarding the company per day or less), article collector 114 may search for the unique identifier in both a title and body of articles. If the company is well covered (e.g., multiple articles are published regarding the company per day), article collector 114 may search exclusively based on titles of articles to reduce computational load on language computing system 100. In some cases, article collector 114 may search for the unique identifier in both the title and body or exclusively in the title regardless of overall coverage of the company.

Once a sufficient amount of articles are gathered regarding the company of interest, historical pattern identifier 202 can obtain classifiers describing the company. Classifiers can describe various sentiments, events, descriptions, etc. that may be associated with the company. In effect, classifiers may be classes and/or categories that are used to tag and identify contents of text documents. In some embodiments, historical pattern identifier 202 stores a set of classifiers that can be applied as needed to companies of interest. This set of classifiers may be predefined by a linguist and/or other experts associated with language computing system 100. In some embodiments, classifiers are provided to historical pattern identifier 202 by a user (e.g., via user device 112). In this case, the user may desire to learn more about a company with regard to a specific classifier. However, user-defined classifiers may be discouraged due to a need to retrain models as well as the fact that user-defined classifiers may be too narrow or too broad and/or otherwise poorly chosen such that valuable information is much more difficult to identify.

In some embodiments, classifiers are divided into “classifier types.” For example, classifiers may be divided into sentiment classifiers and event classifiers. In this case, sentiment classifiers may be general-purpose and include emotions such as gratitude, anger, crave, frustration, happiness, disappointment, excitement, confusion, etc. Sentiment classifiers may be, for example, defined by a linguist to capture general sentiments that customers may have towards the company. Event classifiers may define various events that can affect a company. Examples of event classifiers for companies may include media leak, customers, weakening, positive signal, management change, earnings revision, CEO management, environmental regulations, natural disaster, litigations, accident, supply chain, civil unrest, mergers and acquisitions, CFO management, inflation, interest rates, consumer sentiment, etc.

In some embodiments, the event classifiers are defined based on themes. Broad themes related to companies may include, for example, risks, commodities, customer/consumer, investor risk/stock market movement, operations/supply chain, management, products and product families, economic conditions, regulations, markets, company financial information, etc. Within each theme, classifiers can be defined. For example, a regulation theme may include classifiers such as certifications and standards, trademark/copyright trends, intellectual property/patents, trade restrictions, trade war, etc.

The historical pattern model generated by historical pattern model generator 208 can be trained to properly identify patterns. Before or during initial training of the model, a user(s) may perform a manual annotation process, described below, for various text snippets such that the certain classifiers can be associated with certain snippets of text. Based on the manual annotation process, the model can be trained to learn how to associate text and classifiers to predict a probability that a new text document is associated with a particular classifier. As should be appreciated, the manual annotation process described below is given for sake of example. The model can be trained by other processes that may or may not require user interaction.

In the manual annotation process, the user may be provided text snippets to qualify. For a particular text snippet a user may be asked a series of questions. One example question may include whether the text snippet is meaningful to a given theme. Another example question may require the user to rate an overall sentiment of the text snippet (e.g., positive, negative, or neutral). Yet another example question may require the user to indicate which classifiers, if any, that the text snippet includes. To determine whether what classifiers the text snippet includes, the user may be provided with a list of classifiers and can identify which classifiers in the list are explicitly mentioned in the text and/or are otherwise associated with the text.

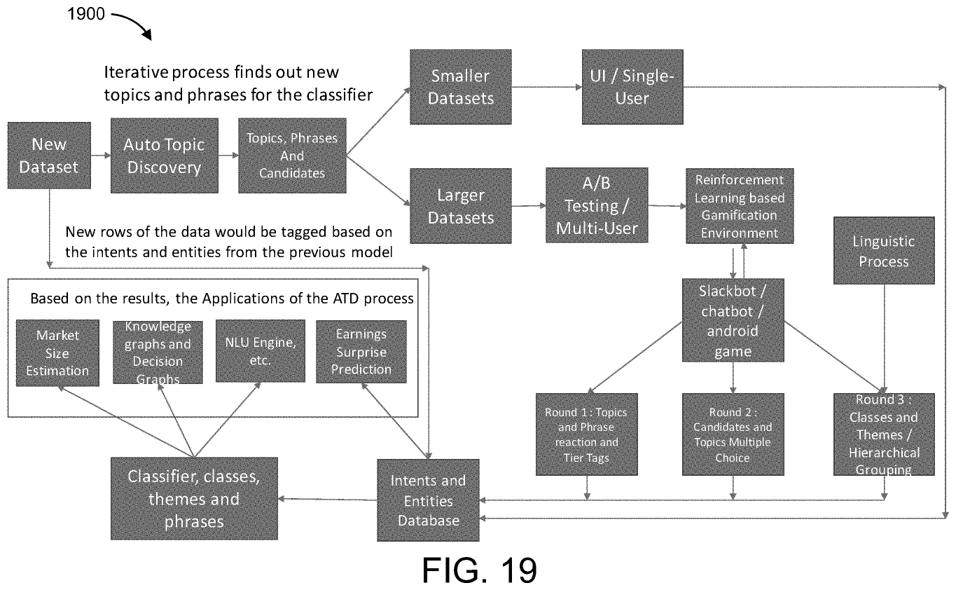

Historical pattern identifier 202 is shown to include an auto-topic discovery engine 206. As a result of the manual annotation, a set of text snippets with associated tags (classifiers) can be generated. Once manual annotation is complete, auto-topic discovery engine 206 can be initiated to process the text snippets and tags associated with each snippet using various classification algorithms to identify prevalent key-words surrounding each tag. In particular, auto-topic discovery engine 206 may utilize the text snippets and associated tags to identify prevalent key-words surrounding each tag. Examples of classification algorithms used by auto-topic discovery engine 206 may include logistic regression, linear discriminant analysis, K nearest neighbors classifier, decision tree classifier, naïve Bayes classifier, support-vector machine (SVM) classifiers, scaled linear regression classifier, scaled linear discriminant analysis, scaled K nearest neighbors classifier, scaled decision tree classifier, scaled naïve Bayes Classifier, scaled SVM, adaptive boosting (AdaBoost) classifier, gradient boost classifier, random forest classifier, extra trees classifier, and/or XGBoost classifier. Auto-topic discovery engine 206 and associated functionality is described in greater detail below with reference to FIG. 19.

Results of the classification performed by auto-topic discovery engine 206 can be reviewed by a user (e.g., a linguist) such that finalized classifier attributes can be determined. For example, a partial representation of a “trade restriction” classifier may be [trade restriction: tariff, trade barrier, restrictions on imports]. In this case, “trade restriction” is the name of the classifier and “tariff”, “trade barrier” and “restrictions on imports” are key phrases which, if encountered in text, indicate with a high probability that the article talks about “trade restriction.” The classifiers and classifier attributes can be used to train a model, described in detail below, such that the model can identify a probability that some text is associated with certain classifiers.

It should be understood that classifiers may be generated and defined in a variety of ways. For example, machine learning classifiers may be discovered from text by an algorithm (e.g., performed by auto-topic discovery engine 206), semantic classifiers may be manually defined based on linguistic or domain knowledge, binary classifiers may be defined for cases in which an individual may desire to search for logical concatenations of words and phrases (e.g., “CEO” and “stepping down” or “retiring”).

Another example of classifiers that can be defined and used by historical pattern identifier 202 may include a more general classifier category including both “events” and “factors.” In this case, an events bucket can be defined to include events desired to be tracked. Examples of events to include in the events bucket for a company may include management changes, supply chain disruptions, new product releases, etc. Likewise, a factors bucket can be defined to include factors that may lead up to and/or cause events. For example, the factors bucket may include factors such as negative sentiment towards management, natural disasters, customer satisfaction, etc.

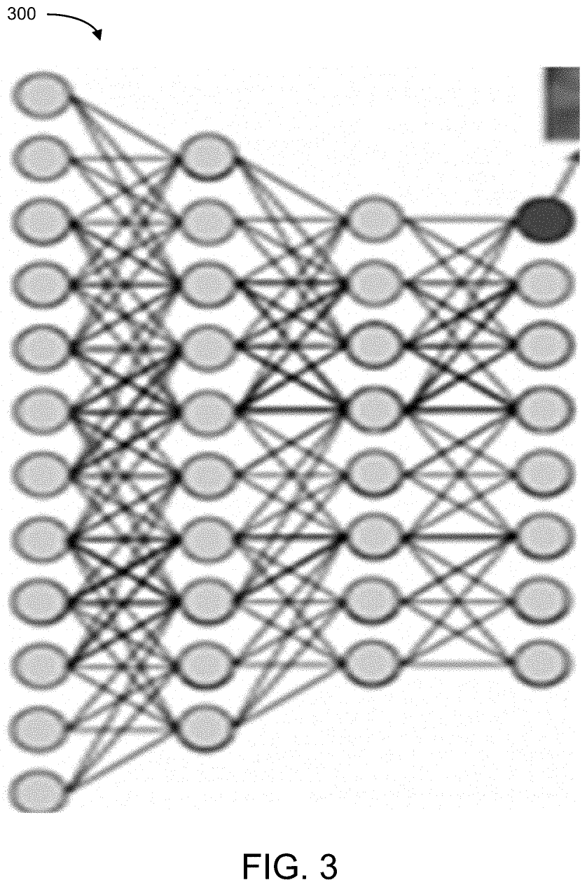

Based on the classifiers and text data, historical pattern model generator 208 can generate a historical pattern model to predict a probability that an article includes each defined classifier. In some embodiments, the historical pattern model generated by historical pattern model generator 208 is a multi-layer deep neural network generated based on convolutional custom-made layers to help identify patterns. As such, the historical pattern model may be a CNN for predicting event probabilities, according to some embodiments. An example of the CNN is described in greater detail below with reference to FIG. 3. An output of the historical pattern model may include information such as an article ID, an article timestamp (e.g., when the article was published, received by language computing system 100, etc.), and a probability that the article includes the defined classifiers. The historical pattern model may also detect probabilities of articles including certain sentiments. For example, the historical pattern model may output a probability that a particular document has an overall positive, negative, or neutral sentiment associated therewith. As the articles can be defined as time-series data, generation of the historical pattern model can be performed by using some (e.g., half) of the articles for training and the remaining articles for validation. For example, if two years of text data is available, a first year of the text data may be used to train the historical pattern model whereas data from the second year can be used to validate accuracy of the model.

Outputs of the historical pattern model may include two types of output. First, raw output of the historical pattern model may include a table including all of the defined classifiers and computed probabilities that an article include each classifier. The raw output can be stored and consumed by a subsequent model for predicting future patterns. A second output of the historical pattern model can be derived from the raw output by searching for classifiers whose probability exceeds a certain threshold (e.g., 0.90, 0.95, etc.).

To determine the second output, historical pattern model generator 208 (or another component of historical pattern identifier 202), may parse through the file including article IDs and probabilities (i.e., the raw output). If a probability of an event is greater than a predefined threshold (e.g., 0.95), the event can be determined to be a part of a pattern. A subsequent event which exceeds the predefined threshold can be considered the next event in the pattern. The pattern can continue until no more subsequent events are detected. The next event exceeding the threshold can then start the next pattern.

As an example of determining the second output, suppose a user is interested in tracking the following event classifiers: hostile takeover, lawsuit, new product development, customer churn, market share growth, union strike, and management change. For each predefined classifier, a list of key-words can be used. For example, the language that may signal management change includes (but is not limited to) “CEO stepping down,” “new leadership,” “corporate officers change,” etc. An example raw data output for which the second output can be determined is shown below in Table 1:

TABLE 1
Example Raw Data Output of AI Model

| | | | | | Market | | |
|---|---|---|---|---|---|---|---|
| | Hostile | | New Product | Customer | Share | Union | Management |
| Time | Takeover | Lawsuit | Development | Churn | Growth | Strike | Change |
| September 2 | 0.96 | 0.031 | 0.001 | 0.001 | 0.001 | 0.001 | 0.005 |
| September 3 | 0.50 | 0.45 | 0.01 | 0.01 | 0.01 | 0.01 | 0.01 |
| September 4 | 0.002 | 0.98 | 0.001 | 0.005 | 0.001 | 0.008 | 0.003 |
| September 5 | 0.001 | 0.002 | 0.001 | 0.002 | 0.001 | 0.951 | 0.042 |

In Table 1, the first row can specify the classifiers defined by the user. The first column can provide a timestamp as articles are stored based on the time they were published such that the articles can be considered time-series data. The remaining cells of Table 1 can provide a probability that a given article includes a classifier of interest. For example, the probability that the article that came out on September 2 includes a “hostile takeover” classifier is 0.96. Because this probability is greater than a predefined threshold of 0.95, “hostile takeover” can be considered the first event in a pattern. However, no articles on September 3 include a classifier that has a probability exceeding the predefined threshold. Hence, the pattern may break at this point. In this example, a new pattern can be started on September 4 because the “lawsuit” classifier is represented in the article with probability that is greater than 0.95. The next event in the pattern may be “union strike.” It should be noted that a user may not see the output of the model directly. However, the output can be stored and utilized by the next model.

In some embodiments, the output of the historical pattern model includes a sequence of patterns. In the above example relating to Table 1, “hostile takeover” in the first row may constitute an event of interest, but is not followed by any other event because September 3^{rd} does not have a classifier with the probability greater than the predefined threshold of 0.95. As such, this single event can define the first pattern. The rows of September 4 and September 5 both have events of interest and thus can constitute a pattern of “lawsuit→union strike”. In other words, a first sequence of events is “hostile takeover” followed by a second sequence of “lawsuit→union strike.”

In some embodiments, the determined patterns are provided to pattern validator 126 for validation/verification purposes. For example, pattern validator 126 may request an expert(s) to answer questions such as “Model 1 detected a pattern “lawsuit→union strike” for company X. Do you find these patterns agreeable for company X? (yes/no).” Other questions provided to the expert(s) may include, for example, “did this pattern happen last month for company X,” “do you want the associated factors for the reasoning behind these patterns,” or “do you want to connect to the Common-Sense Database to get the historical knowledge representation of company X for last month?” If the expert(s) verifies/approves the patterns, the patterns can be stored in a graph database for future utilization and/or provided to a user requesting information related to the company.

It should be noted that, if the expert(s) does not agree with the computer-generated patterns, historical pattern identifier 202 may provide the expert with an opportunity to rearrange the patterns (e.g., via user device 112). If the expert rearranges the patterns and provides the reasoning for such rearrangement, the patterns can be sent to other experts for peer review. Once the patterns have been reviewed and verified by the other experts, they can be stored in a graph database and/or provided to an end user. If there is no agreement among experts, the computer-generated pattern may be discarded.

In some embodiments, historical pattern identifier 202 is provided with one or more validation signals to map with hypothesis engine 120. A validation signal can define time-series numerical data that can be mapped alongside patterns in hypothesis engine 120. In this case, when future patterns are predicted for a required time period as described in detail below, the numerical data of the validation signal can be predicted as well. It should be noted that, as hypothesis engine 120 is a reinforcement learning based real-time engine, the predicted values of the validation signal can also be updated in real-time to match the patterns of hypothesis engine 120 in real-time. Examples of validation signals can include Starmine-based daily earnings gap prediction as the validation signal to be used, calculation of daily earnings-per-share (EPS) from a standard EPS, daily EPS derived from a price/earnings ratio and daily stock market price, historical EPS values for quarter 1 (Q1), Q2, Q3, and Q4 as interpolated on a daily basis, etc.

Historical pattern identifier 202 can provide the identified historical patterns to future pattern predictor 204. Future pattern predictor 204 is shown to include a future pattern model generator 210. Future pattern model generator 210 can generate a future pattern model for the company to select appropriate features. In some embodiments, the model generated by future pattern model generator 210 is an encoder-decoder long short-term memory (LSTM) deep learning model or other appropriate deep learning model. In some embodiments, future pattern model generator 210 utilizes associative memory in some parts of the future pattern model in place of and/or in addition to deep learning neural network models.

LSTM models may be utilized for their ability to identify complex trends that may otherwise be undetected by traditional methods. In some sense, LSTM models are a machine learning equivalent of autoregressive integrated moving average (ARIMA) models used in traditional statistical modeling and mathematics. LSTM models are a class of recurrent neural networks with sophisticated recurrent hidden and gated units and are particularly successful due to their ability to learn hidden long-term sequential dependencies. LSTM models can use historical data to predict future results and operate under the assumption that previous results can be used to predict future results. However, this assumption may not be the most suitable for stock prices or stock market results. As such, fundamental factors (e.g. inflation, interest rates, consumer confidence) can be used as the basis for predicting future baseline results, and can be adjusted using the event probabilities calculated by the LSTM model. However, if fundamental factors are not available, the LSTM model can predict future baseline trends for each company which can be adjusted based on the presence of the event probabilities of interest.

Like the CNN models generated by historical pattern model generator 208, future pattern model generator 210 may generate a separate LSTM model for each company of interest. It should be appreciated that traditional measures of model fit (e.g., R-squared) may not be meaningful in future pattern model generation as the future pattern models can be modified based on event probabilities outputted by the CNN model. A goal of future pattern model generator 210 can be to optimize accuracy of future predictions using additional classifiers. For example, in terms of company stocks, future pattern model generator 210 may work to generate a model that can more accurately predict 180-day stock prices using additional classifiers such as classifiers derived from traditional fundamental market factors (e.g., inflation, interest rates, consumer confidence, etc.).

To train the future pattern model, future pattern model generator 210 can utilize the raw output of the first model (i.e., the historical pattern model). Because articles are stored sequentially and can represent time-series data, a first portion (e.g., a first half) of the articles can be used by future pattern model generator 210 for training. In this case, future pattern model generator 210 may utilize the first line of the raw output to calculate optimal weights to predict a sequence of probabilities in the second line. Future pattern model generator 210 can use the second line as input and attempt to predict a sequence of probabilities in the third line. In particular, future pattern model generator 210 may minimize a loss function on the third line's prediction by starting with weights previously generated by the model. In this case, the goal of future pattern model generator 210 may be to minimize a total mean squared error loss.

Based on the first half of the articles, future pattern model generator 210 may have ran through half of the training predictions and, based on the optimal weights, can attempt to predict a sequence of patterns for the second half. For example, if the available articles include two years of text data, future pattern model generator 210 may run through 364 “training predictions” with the first year's data and can predict a sequence of patterns for the entire second year. At this stage, based on a comparison between the second year predictions and a real events that occurred, future pattern model generator 210 may readjust the weights and can generate predictions for an upcoming year (i.e., a third and unobserved year). In this way, the model can be generated based on the text data of the first year and refined based on the text data of the second year such that predictions can be made for the unobserved third year.

Using a predefined threshold (e.g., 0.95), future pattern predictor 204 can search for predicted patterns. In some embodiments, the predefined threshold is generated by hypothesis engine 120 or is user-defined. The sequence of predicted events can be presented to analysts (e.g., by pattern validator 126) for user verification. If the patterns are verified by the users (e.g., by experts), confidence values can be updated and the patterns can be stored in a separate graph of predicted patterns. Once/if the predicted patterns actualize (occur), the predicted patterns can be stored in CSK database 124 for future usage.

In terms of a live data flow, if a new article is received by hypothesis engine 120, the new article can first be provided to historical pattern identifier 202 to be processed by the historical pattern model generated by historical pattern model generator 208. Output of the historical pattern model can be searched for classifiers meeting the predefined threshold (e.g., 0.95). If classifiers meeting the predefined threshold are located, results can be compared to the predicted patterns (i.e., the output of the future pattern model). If the newly-found classifier and an event in the predicted pattern are the same, no additional processing may be required. In this case, the confidence for the remaining events in the pattern can be updated (e.g., increased). However, if the newly-found classifier is not the same as the event in the predicted pattern, hypothesis engine 120 can search the graph database (e.g., CSK database 124) for the event in other articles. If no such event is found, hypothesis engine 120 can start recording a new pattern of events. If such an event is found in the graph database, all the adjacent nodes (that are linked in a timeline) can be collected until a full pattern is extracted. If the current event has a few patterns with overlapping events, only the pattern that represents the overlap may be extracted. For example, if the current event is A and the following two patterns are stored in a graph database A→B→C→D and A→B→C→E, then the pattern A→B→C can be extracted as a predicted pattern. The newly-extracted pattern can be considered a candidate for a new predicted pattern and can sent to pattern validator 126 for human verification.

In some embodiments, future pattern predictor 204 includes functionality to explain a reasoning behind why particular predictions are made. For example, future pattern predictor 204 may generate a visual representation of entities, properties, and events as it relates to predicting a specific event. Further, future pattern predictor 204 may be able to output specific text snippets as well as their source that represents a chain of reasoning of future pattern predictor 204 in terms of predicting a pattern. These explanations of reasoning may be provided to user device 112 such that a user can appreciate why certain predictions were made and can more easily determine a relative accuracy of the predictions.

In some embodiments, future pattern predictor 204 provides additional predictions of information that may be valuable for users. For example, if hypothesis engine 120 is generating patterns regarding a company's historical and future financial state, future pattern predictor 204 may generate forecast EPS calculations. As a few examples, future pattern predictor 204 may calculate a future earnings per share, an estimated forward price-to-earnings (P/E) ratio, estimated earnings, and a market capitalization. Equations for the examples that can be utilized by future pattern predictor 204 can be given as:

Estimated Market Capitalization=Forecasted Stock Price*Number of Shares

Estimated Earnings=Forecasted Sales−Forecasted Expenses

Estimated Forward P/E=Estimated Market Capitalization/Estimated Earnings

Future EPS=Current Share Price/Estimated Forward P/E

Results of these equations may be useful to a user in providing additional insight into expected financial dynamics of a company. It should be noted that determining forecasted expenses for an organization may be difficult to obtain. In some embodiments, if additional information cannot be calculated (e.g., due to a lack of knowledge regarding a certain variable), future pattern predictor 204 may determine what information, in addition to an output of the future pattern model, can be provided to the user.

In some embodiments, if a few patterns could occur but do not have overlap, hypothesis engine 120 may apply a reinforcement learning (RL) model generated/managed by a reinforcement learning module 212. The reinforcement learning model may also be applied by hypothesis engine 120 if there is a mismatch between the predicted pattern and live data collected by article collector 114.

In some embodiments, reinforcement learning module 212 can represent reinforcement learning via a game theory framework. In this case, the reinforcement model may include a decision-maker referred to as an agent. The reinforcement model may also include every other aspect of the mathematical model which can be referred to as an environmental. The agent can reside in an environment and can observe states of the environment. Based on the state, the agent can decide on an action. Once the action has been performed, the environment can return the next state and a reward associated with the performed action. The decision-maker (i.e., the agent) can be executed by reinforcement learning module 212 to maximize a discounted sum of the rewards. Further, reinforcement learning module 212 can compute a current state of a value function using Bellman equations.

In the context of articles, the current state may be an event that has been detected in articles on a current day. The decision-maker simulated by reinforcement learning module 212 can attempt to predict future events. As an example, if the predicted event is correct, a reward can be set to 1 whereas if the predicted event is incorrect, the reward can be set to 0.

It should be noted that the reinforcement model managed by reinforcement learning module 212 may require a large amount of data. As such, reinforcement learning module 212 may rely on text data from both more credible sources (e.g., news articles) as well as generally less credible sources (e.g., social media). In some embodiments, reinforcement learning module 212 may utilize a feedback loop to gather expert opinions for reinforcement purposes. Once the vast quantity of data is consumed by the reinforcement model, the reinforcement model can simulate the possible outcomes. At the beginning of a reinforcement process, the reinforcement model may simulate future events randomly. However, over time the reinforcement model can adjust the probabilities on the events/sequences of events to maximize the reward function. The simulations can be run as soon as new textual data becomes available. The predictions based on the simulated data may have a lower confidence than those extracted from historical patterns.

As an example of a reinforcement learning process, suppose events are forecasted for the next 6 months, but a pattern extracted from the graph ends after one month. In this example, the reinforcement learning model can take the predicted pattern for the next month as something that “will” happen. As time progresses, the data from multiple sources can be pulled to train the model (i.e., “reinforce” the forecast). Based on the data, reinforcement learning module 212 may attempt to simulate the course of events for the 6 months. Every time an article is obtained, reinforcement learning module 212 can simulate the forecast. In this example, reinforcement learning module 212 may simulate the forecast for the next 30 days. The more data that is available to reinforcement learning module 212, the higher the confidence level in the prediction may be. After the historical pattern is extracted from the graph ends, the reinforcement learning model can keep updating itself as new articles are obtained. It should be noted that the confidence level of the forecast based on the simulated model may be lower than that of a future pattern prediction model. In some embodiments, a warning to exercise caution when using simulated forecasts is displayed to the user via user device 112. In some embodiments, reinforcement learning module is a component of future pattern predictor 204.

Still referring to FIG. 2, hypothesis engine 120 may include a pattern impact identifier 214 to determine an impact of patterns on variables of interest. With regard to companies, some variables of interest may include a ratio of stock price to EPS, a ratio of stock price to sales (i.e., revenue), and a ratio of stock price to free cash flow to proxy EPS, revenue, and free cash flow. If forecasts are made for a company based on quarterly-reported values that remain the same for the entire quarter, a denominator of the ratios may be constant. Because the denominator is a scalar, pattern impact identifier 214 may focus on predicting the stock price with a possibility of scaling at the end if needed.

In some embodiments, pattern impact identifier 214 may utilize two approaches to determine the impact of patterns on variables of interest. A first approach may effectively be an extension of the historical pattern model. The historical pattern model can be used as a basis as the historical pattern model can use sequence-to-sequence modeling where each line of probabilities can represent a sequence of numbers and a similar sequence for the next day can be predicted. One way in which pattern impact identifier 214 can train a model is to extend the sequence-to-sequence model to include an additional variable. In regard to companies, the additional variable may be stock price. In this way, pattern impact identifier 214 can predict the stock price in the future using the sequence-to-sequence modeling approach and the future pattern model associated with future pattern predictor 204.

In some embodiments, pattern impact identifier 214 utilizes a multivariate regression setup in which the stock price becomes a dependent variable and is modeled as a linear combination of multiple classifier probabilities.

In some embodiments, pattern impact identifier 214 predicts the stock price based on historic stock price data using an LSTM. Essentially, the approach can be thought of as an autoregressive integrated moving average (ARIMA) model which captures trends based on previous data. Pattern impact identifier 214 can utilize a rolling-window approach by predicting one-step ahead at each time. For example, if 540 data points are available, the first 360 observations can be considered and the 361^{st} observation can be predicted. In this example, observations 2-361 can be considered and the 362^{nd} observation can be predicted. This process can continue until the forecast for observations 361-540 is made.

Based on the observations, pattern impact identifier 214 can determine a prevalence of a particular topic in a time period. For example, consider a scenario with three classifiers for the next two days as shown below in Table 2.

TABLE 2
Example Raw Data Output of AI Model

| | Classifier 1 | Classifier 2 | Classifier 3 |
|---|---|---|---|
| Day 1 | 0.5 | 0.4 | 0.1 |
| Day 2 | 0.2 | 0.6 | 0.2 |

Based on Table 2, a sum of all entries can be computed by pattern impact identifier 214 as:

0.5+0.4+0.1+0.2+0.6+0.2=2

Further, pattern impact identifier 214 can compute a prevalence for each classifier based on the following equations:

$$\begin{matrix}\frac{0.5 + 0.2}{2} = \frac{0.7}{2} = 0 .35 & Classifier 1 \\ \frac{0.4 + 0.6}{2} = \frac{1}{2} = 0.5 & Classifier 2 \\ \frac{0.1 + 0.2}{2} = \frac{0.3}{2} = 0.15 & Classifier 3\end{matrix}$$

In this example, the most prevalent classifier over the 2-day period is Classifier 2. The scaled prevalence for each day can be given as

$$\frac{0.4}{2} = 0.2$$

for the first day and

$$\frac{0.6}{2} = 0.3$$

for the second day.

Pattern impact identifier 214 can further normalize the stock price for each day by

$$\frac{{p}_{c u r r e n t} - {p}_{min}}{{p}_{max} - {p}_{min}}$$

so that the maximum value for the scaled price can be set to 1 and the minimum price can be set to zero. In this way, the scaled predicted price can be computed by pattern impact identifier 214 by multiplying the scaled stock price, the scaled probability classifier for that day, and the user-defined weight which can capture the impact of the predicted event on the stock price.

Hypothesis engine 120 is also shown to include a normalization engine 216. Normalization engine 216 can perform column-wise and time-series normalization based on outputs of the future pattern model and the historical pattern model. Normalization engine 216 can implement a feature fusion that takes advantage of features drawn from both the historical pattern model and the future pattern model. As such, normalization engine 216 may take advantage of features from both a CNN and an LSTM. As described below, reference may be made particularly to CNN and LSTM models. However, it should be appreciated that may take advantage of features from other types of models depending on a model type of the historical and future pattern models.

Normalization engine 216 can combine outputs of the CNN and LSTM to utilize their respective abilities on different aspects of data. For example, normalization engine 216 may combine 180-day stock price predictions from the LSTM model and adjust the predictions by the probability of events occurring as outputted by the CNN model.

Normalization engine 216 may require two inputs to normalize the outputs. First, normalization engine 216 may require event probabilities from the CNN as described in greater detail above. Second, normalization engine 216 may require a weight (impact) applied if an event occurs (e.g., how much a stock price is affected by an event). To determine the weights, normalization engine 216 may, for example, identify historical events of interest and measure an immediate corresponding change in resulting from the events (e.g., changes in stock price). The process can be performed for each company of interest. In this case, the changes (e.g., stock price changes) can be averaged for each event and results can be normalized across each event. Advantageously, normalization can allow for values to show greater differentiation and relative values.

In some embodiments, normalization engine 216 performs adjustments using time-series normalization. Time-series normalization can allow for infrequency events (e.g., one-off events) to be muted and events with a high recurring likelihood to be amplified. Adjustments can be made by identifying the most predominant event for each day and normalizing the cumulative probabilities for that event across the cumulative probabilities of all events.

The final step performed by normalization engine 216 may be to adjust predictions based on the normalized time-series values and respective event weight. For example, normalization engine 216 may adjusted predicted stock prices up or down based on the normalized time-series values and respective event weight. If the event is negative for a particular day, normalization engine 216 may utilize the following equation to determine an adjusted value:

|predₙₒᵣₘ−pₙₒᵣₘ|·w_{c}

where predₙₒᵣₘ is a normalized prediction for the particular day, pₙₒᵣₘ is a normalized event probability score for the particular day, and w_{c} is a weightage of the classifier. It should be understood that the above equation illustrates the dot product of |predₙₒᵣₘpₙₒᵣₘ| and w_{c}. If the event is positive for the particular day, normalization engine 216 may utilize the following equation:

|predₙₒᵣₘ+pₙₒᵣₘ|·w_{c}

In some embodiments, as opposed to the normalization technique described above, normalization engine 216 utilizes a deep learning model that incorporates a feature fusion layer that merges the event probabilities and LSTM model predictions. In this case, the feature fusion layer can combine the output results from the LSTM and CNN models to form joint features. The joint features can be fed to an output layer to provide a trend prediction. The output layer may be a fully-connected layer following the feature fusion layer. By integrating the steps together into a single model, the model can optimize the weights described above instead of a separate general calculation.

An output of normalization engine 216 can be fed to CSK engine 122 and/or pattern validator 126. In effect, the output of normalization engine 216 can result in future pattern predictions that account for various identified events. Predictions generated by normalization engine 216 can be compared against actual trends observed over time to determine a relative accuracy of the predictions. If the predictions are overall accurate, the historical and future predictions models can be reinforced. However, if the predictions end up being inaccurate (e.g., predicted stock prices over time are not similar to actual stock prices), one or both of the models may be retrained to better model predictions for the particular company.

Referring now to FIG. 3, an illustration of a convolutional neural network (CNN) 300 is shown, according to some embodiments. CNN 300 can further illustrate the CNN utilized by hypothesis engine 120 as described above with reference to FIG. 2. Convolutional neural networks are deep learning models that are used to classify inputs. CNNs are can be used in a variety of scenarios such as, for example, image classification. For example, CNNs can be used in classifying images of cats and dogs, identifying handwriting, and classifying images of numbers.

In the context of hypothesis engine 120, CNN 300 can work by disaggregating an input document into many smaller pieces and identifying the relationships and interactions between the pieces. CNN 300 may have one or many hidden “layers” (e.g., convolution layers, pooling layer, dropout layer, etc.) that serve different purposes. The convolutional layers may serve as sliding window filters to capture features of the document. The pooling layer can identify the most important features from all the extracted features. The dropout layer can perform regularization on the features and can remove features to avoid overfitting, thereby making CNN 300 less sensitive to small variations in the data. The number of layers and nodes within each layer can be optimized by hypothesis engine 120. The output of CNN 300 if integrated in hypothesis engine 120 may be a set of event probabilities for each event of interest.

CNN 300 can learn from cases identified by humans. A pre-classified set of text documents can be used to train CNN 300. CNN 300 can learn key features from the training articles and thereby be optimized. Validation of CNN 300 may be necessary to ensure CNN 300 generates accurate predictions. As such, a validation metric can be used by hypothesis engine 120 to determine whether CNN 300 succeeds of fails at accurately classifying events included in articles provided for validation. If CNN 300 properly accurately classifies a predefined amount of events (e.g., 70% of events, 80% of events, etc.), CNN 300 can be considered usable. If CNN 300 fails to properly classify at least the predefined amount of events, CNN 300 can be retrained.

Referring now to FIG. 4, a block diagram of ontology graph generator 118 in greater detail is shown, according to some embodiments. Ontology graph generator 118 is shown to include a domain graph generator 402, a knowledge graph generator 404, and a decision graph generator 406. The graphs generated by components of ontology graph generator 118 can be utilized to identify various information surrounding a company. Graphs generated and used by various components of language computing system 100, as described with reference to FIG. 1, can include nodes and edges representing relationships between different pieces of information. In various embodiments, graphs may include unidirectional edges and/or bidirectional edges, depending on a purpose of a particular graph. Further, again depending on a purpose of a particular graph, the graphs described herein may include directed graphs, undirected graphs, cyclic graphs, acyclic graphs, etc. Graphs generated by components of ontology graph generator 118 may be stored in a graph database such as CSK database 124 of CSK engine 122.

Domain graphs generated by domain graph generator 402 can represent all of the knowledge for a company from available text data in graph nodes and edge relationships. To generate a domain graph, domain graph generator 402 can parse through textual data provided by article collector 114 to determine certain relationships between information for a particular company. Domain graph generator 402 can parse each article of text and extract entities from the articles. In some embodiments, all entities appearing within an article are considered connected and relationships can be stored as an edge list. Such connections can be referred to as “corpus connections” because the entities are encountered within the same corpus of text. If another article mentions the same words as the first article, the articles may adjoin on the overlapping nodes. For example, suppose a first article contains the following sentence: “There was an earthquake in China. Many people were evacuated.” Further, suppose a second article contains the following sentence: “Company X is moving its production to China.” In this case, the edge list for the first article may be [earthquake, China]. The edge list for the second article may be [company X, China]. As such, the two graphs would be joined by domain graph generator 402 on the node “China” to form an edge list [earthquake, China, company X]. Of course, there are many other ways in which entities can be connected.

Connections between entities can be also drawn between articles based on a semantic relationship between terms used in the article. For example, suppose that one article mentions “cinnamon latte” from a Coffee Shop A and another article mentions “hazelnut latte” from a Coffee Shop B. As “hazelnut latte” and “cinnamon latte” may be interpreted to have a similar meaning (i.e., they are both drinks that have coffee as the main ingredient), domain graph generator 402 may semantically join the two articles by a term “coffee.”

Knowledge graphs generated by knowledge graph generator 404 can represent all of the real world information regarding entities. Specifically, knowledge graph generator 404 can construct graphs based on properties associated with each entity. For example, an entity “Obama” may have properties such as a date of birth, years of presidency, occupation, location of residence, etc. Each of the properties can be represented in a knowledge graph generated by knowledge graph generator 404. The knowledge graphs may include both generally available knowledge regarding entities as well as specialized knowledge that can be particularly useful for other processes such as information deduction.

Decision graphs generated by decision graph generator 406 can help in causal link analysis from the text data. Causal link analysis can be used to identify certain events that may result in other events occurring. For example, a natural disaster may result in supply chain issues for a company. In particular, decision graph generator 406 may utilize timestamps associated with articles to identify important events that may affect a company and what events occurred afterwards to generate the decision graphs. In some embodiments, hypothesis engine 120 helps decision graph generator 406 in causal link analysis for building the decision graphs.

More specifically, decision graphs can be utilized in creating factors and deducing causal relationships between events. For example, if an expert or some other source of information indicates that a company closing a plant in China causes a management change, a decision graph of causal relationship can be created as “closed plant in China→management chance.” Created decision graphs can be incorporated in a greater ontology graph (e.g., a combination graph of domain, knowledge, and decision graphs). The ontology graphs may be stored in CSK database 124 of CSK engine 122.

In some embodiments, as described above, ontology graph generator 118 may combine some and/or all of the graphs generated by generators 402-406 into a larger ontology graph. A combined ontology graph can capture information surrounding a company overall and how certain events, knowledge, relationships, etc., are associated and interact. In some embodiments, ontology graph generator 118 provides the combined ontology graph(s) and/or the individual graphs generated by generators 402-406 to CSK engine 122 to be stored in CSK database 124.

Referring now to FIG. 5, a block diagram of CSK engine 122 in greater detail is shown, according to some embodiments. CSK engine 122 can integrate model AI techniques to solve specific problems where expert knowledge may be required. In particular, CSK engine 122 can capture enterprise knowledge in a secure environment. CSK engine 122 can capture all of the important facts about an organization (company) through a heuristic approach in real time. As described above, some and/or all of the functionality of ontology graph generator 118 may incorporated in CSK engine 122. As such, CSK engine 122 may include functionality to parse articles, generate graphs, etc.

CSK engine 122 is shown to include CSK database 124 and optionally include ontology graph generator 118. Ontology graph generator 118 is shown as an optional component of CSK engine 122 as ontology graph generator 118 may be implemented separately from CSK engine 122. In either case, CSK engine 122 can utilize ontology graph generator 118 to extract current and past facts as well as entities to be stored in CSK database 124. In other words, ontology graph generator 118 can help extract information such that CSK engine 122 can represent facts and entities to deduce further information.

In some embodiments, some and/or all of the information stored in CSK database 124 is represented in a graph format. In particular, CSK database 124 can include domain, knowledge, and decision graphs generated by components of ontology graph generator 118. As such, based on information extracted by ontology graph generator 118, graphs can be generated and stored in CSK database 124 to represent the current/past facts and entities regarding an organization. In some embodiments, CSK engine 122 provides received historical patterns to pattern validator 126. In some embodiments, however, hypothesis engine 120 may directly provide the historical patterns to pattern validator 126.

Domain graphs and knowledge graphs as described above and stored in CSK database 124 may include a vast body of information. However, not all information of the graphs may be useful at a given moment in time. For example, suppose an analyst wants to track developments of company X. In the example, company X and company Y may be previously mentioned in the same article and, hence, are connected in CSK database 124. Company X may have no operations in China while company Y does. As such, information regarding an earthquake in China, may be irrelevant to the analyst of company X as company X has no operations in China. In order to display only the information relevant to the analyst's query, CSK database 124 may be designed as a combination of the domain graph and knowledge graph with unnecessary information removed. The entities stored in CSK database 124 may be those that are related to companies and organizations that the analysts care about as well as user-defined classifiers which are deemed necessary. The subclass of these classifiers may be referred to as “events”. Surrounding each event, CSK engine 122/CSK database 124 can determine the classifiers that are closely related to the event and that may be strongly indicative of the fact that the event will take place in the near future. Such classifiers are called “factors.” In this case, CSK database 124 may only store the information extracted from the articles that contain events and factors relevant to analysis. Further, CSK database 124 can be designed to be easily scalable and parallelizable to maximize efficiency and ability to store information regarding entities.

CSK database 124 can also store decision graphs generated by ontology graph generator 118. In some embodiments, the decision graphs are further combined with the domain and knowledge graphs described above. In this way, CSK database 124 can store ontological graphs that include knowledge graphs, domain graphs, and decision graphs.

In some embodiments, CSK database 124 stores additional information that can be used in representing facts and entities. For example, CSK database 124 may store graphs generated by ontology graph generator 118 representing information extracted from sources such as images, video footage, etc. Information and knowledge based on sources such as images and video footage can be helpful for hypothesis engine 120 in generating predictions of future events. As some specific examples, CSK database 124 may store/process satellite images of cargo ships in the Panama Canal, a video feed from a webcam in an unemployment office, daily satellite pictures of a coal mine, etc. In the example, the satellite images of cargo ships in the Panama Canal may be an indicator of global trade. In particular, if the images indicate an increase in cargo ships, CSK database 124 may include a representation of a fact indicating an increase in economic trade. The video feed from the webcam in the unemployment office may be used to determine changes in unemployment rates that may be indicative of economic change. If the video feed indicates more people are visiting the unemployment office over time, CSK database 124 may include representation of a fact indicating an increase in unemployment rates. The daily satellite pictures of the coal mine may indicate a flow of resources for a company or economy. If daily satellite pictures indicate less activity is occurring at the coal mine over time, CSK database 124 may include representation of a fact indicating that energy resources for a company may decrease. As should be appreciated, CSK database 124 can store any information that can be useful for later information deduction.

CSK engine 122 differs from hypothesis engine 120, as described with reference to FIGS. 1 and 2, in a few ways. Firstly, hypothesis engine 120 can help to identify patterns of events over a period of time whereas CSK engine 122 can represent facts and entities to deduce further information. Likewise, where hypothesis engine 120 can be used to predict future patterns of events, CSK engine 122 may be limited to represent the current/past facts and entities in CSK database 124. Further, a structure of hypothesis engine 120 may be different than that of CSK engine 122. In particular, hypothesis engine 120 can be represented with deep learning models whereas CSK engine 122 can incorporate architecture that involves graph databases (e.g., via CSK database 124) and information extraction techniques (e.g., via ontology graph generator 118).

Hypothesis engine 120 can utilize ontology graphs stored in CSK database 124. If a forecast is made, hypothesis engine 120 can output a predicted pattern of events. Suppose, for example, the predicted pattern is “management change->customers.” CSK database 124 can be queried for the term “management change.” A “management change” node stored in CSK database 124 may have multiple future effects and only those effects that have been predicted by the future pattern model are extracted, in this case “customers”. “Management change” may also have predeceasing “causes” (i.e., entities from the domain graph and facts from the knowledge base connected to it). All of the information can be presented to the user via a chat bot managed by pattern validator 126 for verification. In particular, the user may be able to verify accuracy of the predicted information via user device 112. For example, the cause of “management change” may be “offshore accounts” or “earthquake in China.” The user can be asked to detect the viable cause in this specific case. The company may be connected to another company based on the domain graph. Afterwards, the user may want to investigate the relationships between the companies and whether the change in management in company X affects company Y. Once the user inputs their reasoning, the graph of causes and effects, entities and the relevant knowledge associated with them can be stored in CSK database 124. In this way, CSK database 124 can retain large amounts of information regarding how various events, entities, factors, etc., are interconnected.

Referring now to FIG. 6, a block diagram of pattern validator 126 in greater detail is shown, according to some embodiments. As mentioned above with reference to FIG. 1, pattern validator 126 can determine whether patterns generated by hypothesis engine 120 are valid. To do so, pattern validator 126 can obtain feedback from experts in a particular field to provide feedback on generated patterns. In some embodiments, pattern validator 126 also performs inferencing to deduce new information by combining the capabilities of both CSK engine 122 and hypothesis engine 120.

Pattern validator 126 is shown to include a chat bot engine 602. A chat bot managed by chat bot engine 602 can be used to obtain feedback from users (e.g., experts in a field) and can parse through the feedback to obtain an understanding of the feedback. In particular, the chat bot may interact with the users by providing questions, patterns, etc. to user devices 112 (e.g., via communications interface 108). The chat bot can incorporate AI models that can extract a meaning from the feedback.

In some embodiments, after being provided a pattern (e.g., a historical pattern or a predicted future pattern), chat bot engine 602 can initiate a particular chat bot to communicate with a user to obtain feedback on the pattern. Based on the pattern, chat bot engine 602 can identify experts that are qualified to give feedback on the pattern. For example, if the pattern is in relation to stock prices in a company, chat bot engine 602 may identify experts in the stock market to provide feedback on the pattern. In some embodiments, CSK database 124 stores information regarding experts to contact to provide feedback on various types of patterns. In some embodiments, pattern validator 126 includes a database indicating experts for providing feedback on various types of patterns.

In addition to providing the pattern itself, the chat bot may also provide a reasoning behind generation of the pattern (e.g., articles the pattern is based on, key words used to generate the pattern, etc.). In essence, the chat bot can provide any information regarding the pattern that may be available and/or that may be helpful to the user in evaluating the pattern.

The chat bot managed by chat bot engine 602 may communicate with users in a variety of mediums. For example, the chat bot may communicate with users via a text messaging service (e.g., SMS), a mobile/computer application installed on user device 112 designed for soliciting feedback from users, on a website, etc. As should be appreciated, the chat bot can be implemented in any appropriate setting that allows users to provide feedback on patterns and/or other information to be validated.

Based on a pattern and other information provided by the chat bot, the user can respond with feedback on the pattern/information. The feedback may include information such as a binary opinion (e.g., yes or no) on whether the pattern is reasonable, a rating of the pattern (e.g., on a 1 to 10 scale), a reasoning behind the evaluation (e.g., additional articles for consideration, a typed explanation of the reasoning, etc.), and/or any other feedback that can indicate aa relative opinion of the user. The user may also provide additional information applicable to the pattern such as suggested actions based on the pattern. The additional information can be useful in further refining predictions as it may include information not discovered in obtained articles.

Based on feedback provided by the user, chat bot engine 602 can utilize AI models to identify critical information in the feedback. The AI models may search for key phrases in the feedback, an overall sentiment of the feedback (e.g., positive, negative, or neutral), additional information that can be used for future predictions, and/or any other information that can be utilized in prediction of future patterns, rating a current predicted pattern, etc. The information can be provided back to CSK engine 122 to be incorporated into graphs of CSK database 124.

Chat bot engine 602 may instruct the chat bot (or multiple chat bots) to interact with multiple users. In this way, feedback on patterns can be obtained from a variety of users that may have different interpretations, knowledge, etc., regarding the patterns. By accounting for feedback from multiple users, a chance of biased and/or inaccurate feedback can be reduced. For example, if a 9 out of 10 users indicate a pattern is accurate but one user indicates the pattern is inaccurate, the user indicating inaccuracy may not have a clear understanding of the pattern, may be biased against the pattern, etc. In this way, by receiving feedback from multiple users, the feedback can be aggregated to determine a relative consensus of users. If no consensus exists among users (e.g., half of users agree with a pattern and the other half does not), a confidence level of the pattern may be decreased as it may be unclear whether the pattern is accurate. In general, feedback of users can be used to determine an overall confidence of patterns. If most users indicate a pattern is valid, a confidence level of the pattern may be higher as opposed to if most users disagree with the pattern. Determining a confidence level can be useful information for an end user to estimate how reliable a particular pattern is.

In some embodiments, chat bot engine 602 collects feedback from users and provides the feedback to inference engine 604. Based on the feedback, inference engine 604 can deduce new information. Further, inference engine 604 may extract new information by applying logical rules to CSK database 124. In this way, inference engine 604 can combine capabilities of both hypothesis engine 120 and CSK engine 122. As an example, if a natural disaster impacts a supply chain of a company, inference engine 604 may utilize information stored in CSK database 124 as well as feedback on patterns generated by hypothesis engine 120 to deduce real time actions that may occur after the supply chain issue. Any new information deduced by inference engine 604 may be provided back to CSK engine 122 to be stored in CSK database 124.

In some embodiments, chat bot engine 602 may allow a user such as an analyst to indicate that they desire new information to be deduced based on a graph. In this case, chat bot engine 602/pattern validator 126 can access predicted patterns generated by hypothesis engine 120 and contact experts to evaluate the predicted patterns. Based on expert opinions and a reasoning of facts associated with the opinions, chat bot engine 602 and/or inference engine 604 can predict future states of actions for CSK engine 122. In this way, the analyst (or other type of user) can initiate a process to ensure that information stored in CSK database 124 is update to date and includes newly deduced information (if available).

As a brief summary of pattern validator 126, chat bot engine 602 can initiate chat bots to communicate with experts to obtain feedback on patterns generated by hypothesis engine 120. Feedback of the users can be aggregated to determine a confidence level of the pattern, identify new information provided by the experts, etc. Further, inference engine 604 can utilize the feedback to deduce new information. Any and/or all information gathered and/or deduced by components of pattern validator 126 can be stored in CSK database 124, used to update models of hypothesis engine 120, etc. Likewise, verified/validated patterns can be provided to pattern graph generator 128 to allow users to view the patterns and perform further analysis.

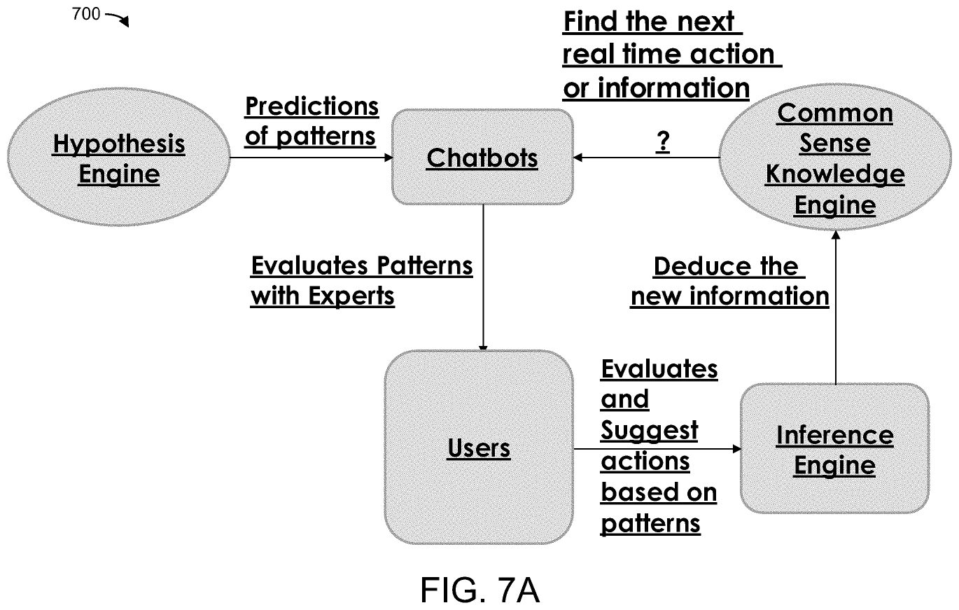

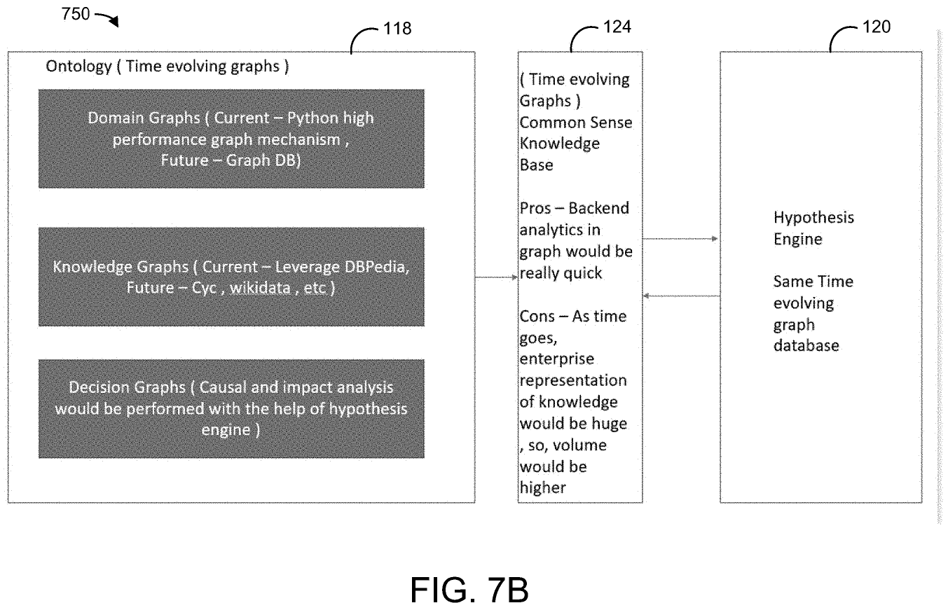

Referring now to FIG. 7A, a flow diagram of a process 700 illustrating communication and operation among hypothesis engine 120, CSK engine 122, and pattern validator 126 is shown, according to some embodiments. It should be appreciated that process 700 illustrates an example of how hypothesis engine 120, CSK engine 122, and pattern validator 126 can operate with one another. In other words, hypothesis engine 120, CSK engine 122, and pattern validator 126 may communicate/operate with one another in other ways other than as shown in process 700.

As shown in process 700, hypothesis engine 120 can provide predictions of patterns to chat bots managed by chat bot engine 602. The patterns may include historical patterns, predicted future patterns, etc. Based on the patterns, the chat bots can operate to evaluate the patterns with experts (shown as users in process 700). The evaluation can include soliciting feedback of the experts regarding whether they agree with the patterns, a reasoning of why or why not, additional information that may be useful in generation of new patterns, etc. Further, the experts may provide suggestions on actions that may occur based on the patterns.

In process 700, the feedback of the experts/users is shown to be provided to inference engine 604. Based on the feedback, inference engine 604 can deduce new information. The newly deduced information along with any other information extracted from the feedback can be provided to CSK engine 122 to be stored in CSK database 124. Based on the stored information, CSK engine 122 can identify a next real time action and/or other information.

Referring now to FIG. 7B, an illustration 750 of an interaction between CSK database 124 with ontology graph generator 118 and hypothesis engine 120 are shown, according to some embodiments. As shown in illustration 750, ontology graph generator 118 can provide domain, knowledge, and decision graphs to CSK database 124. Also shown in illustration 750, hypothesis engine 120 can exchange information with CSK database 124 (e.g., trend predictions). It should be noted that, as CSK database 124 can be in a graph format, CSK database 124 can provide for efficient backend analytics that may reduce processing requirements as compared to other database structures. However, as time progress, an amount of information stored in CSK database 124 may become quite large, and as such, updating CSK database 124 may become progressively more taxing.

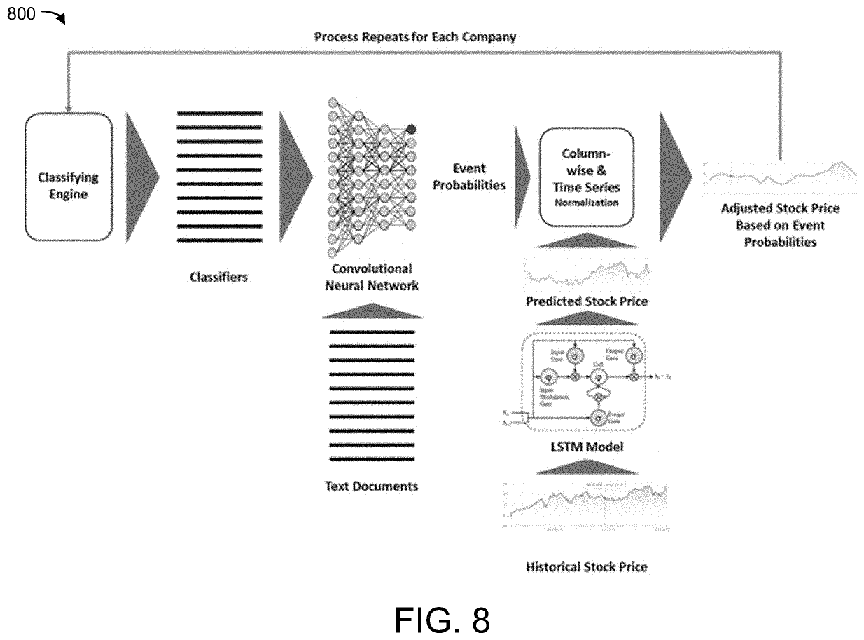

Referring now to FIG. 8, a flow diagram of a process 800 for generating predictions of stock prices are shown, according to some embodiments. In some embodiments, process 800 is performed by hypothesis engine 120. In particular, hypothesis engine 120 may perform some and/or all steps of process 800 for predicting stock prices for various companies of interest. As such, various steps of process 800 may be performed by components of hypothesis engine 120 as described with reference to FIGS. 1 and 2.

Process 800 is shown to include a classifying engine that generates classifiers. In some embodiments, the classifying engine stores classifiers defined by linguists, users, and/or other individuals. In some embodiments, the classifying engine may automatically define classifiers. For example, may identify classifiers used for companies and determine synonymous or antonymous words/phases that can be used as new classifiers.

In some embodiments, the classifying engine includes some and/or all of the functionality of auto-topic discovery engine 206 as described with reference to FIG. 2. As such, the classifying engine may identify prevalent key-words surrounding a tag (i.e., a classifier). In this way, the classifying engine can identify prevalent key-words that, if encountered in a text document, may indicate that the text document has a high probability of being associated with a particular classifier.

The classifying engine can provide the classifiers and associated key-words to a CNN. In some embodiments, the CNN is representative of the historical pattern model described above with reference to FIG. 2. The CNN can also be provided text documents (articles) to parse through. Based on the classifiers and text documents, the CNN can generate event probabilities. The event probabilities can be provided to a component for column-wise and time-series normalization (e.g., to normalization engine 216).

Process 800 is also shown to include providing historical stock prices to an LSTM model (i.e., the future pattern model). It should be appreciated that stock prices are shown for sake of example. Process 800 can utilize and provide predictions for any other appropriate variable or other descriptor describing companies and/or other establishments. Based on the historical stock prices, the LSTM model can generate predicted stock prices over time. The predictions can also be provided for normalization.

Process 800 can include performing a normalization process based on the event probabilities and predicted stock prices. The normalization process may include column-wise and time-series normalization to adjust the predicted stock prices based on the event probabilities. In this way, advantages of the CNN and the LSTM model can be combined to generate adjusted stock prices that are based on the event probabilities. The normalization can ensure that predictions account for events based on probabilities of particular events occurring.

Process 800 can be repeated for each company of interest. The companies of interest may be identified by users and/or may be predefined in process 800. By performing process 800 repeatedly for each company, specific CNN and LSTM models can be used for each company. Using specialized CNN and LSTM models for each company can ensure that predictions for one company do not directly affect predictions for another company.

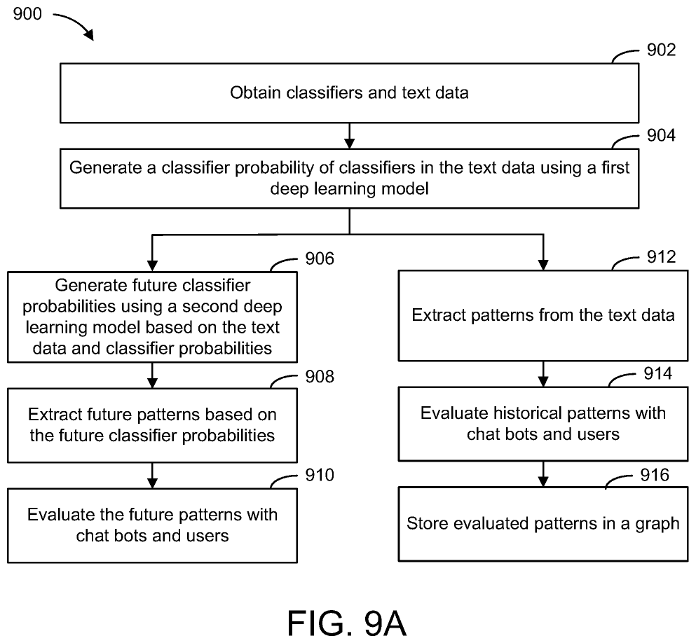

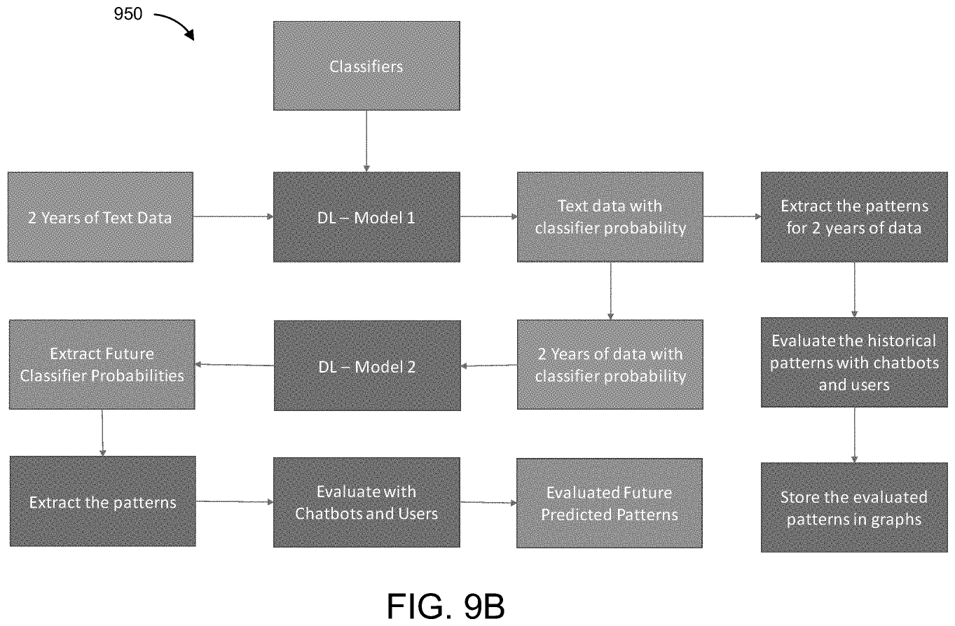

Referring now to FIG. 9A, a flow diagram of a process 900 for generating and evaluating historical and future patterns is shown, according to some embodiments. In some embodiments, process 900 is performed by various components of language computing system 100.

Process 900 is shown to include obtaining classifiers and text data (step 902). In some embodiments, the classifiers are retrieved from a database that stores classifiers. In some embodiments, the classifiers may be obtained from users and/or automatically generated based on available information (e.g., based on existing classifiers, identified based on the text data, etc.). In some embodiments, an amount of the text data obtained is required to meet a minimum requirement before process 900 can proceed to step 904. For example, step 902 may require at least two years of text data to be obtained, at least 1,000 documents to be obtained, etc. In some embodiments, step 902 is performed by article collector 114 and/or hypothesis engine 120.

Process 900 is shown to include generating a probability of the classifiers in the text data using a first deep learning model (step 904). In other words, step 904 can include determining a probability of each classifier being included in the text data (e.g., in each article). The first deep learning model may be, for example, a convolutional neural network model or other appropriate deep learning model. After step 904, process 900 can branch to both step 906 and step 912. In some embodiments, step 904 is performed by hypothesis engine 120.

Process 900 is shown to include generating future classifier probabilities using a second deep learning model based on the text data and classifier probabilities (step 906). In effect, the second deep learning model can utilize output of the first model. The second deep learning model may be, for example, a LSTM model used to generate future pattern predictions. In some embodiments, step 906 is performed by hypothesis engine 120.

Process 900 is shown to include extracting future patterns based on the future classifier probabilities (step 908). The future classifier probabilities may indicate how likely the classifiers are to show up in the future (e.g., in future articles). As such, future patterns can be extrapolated based on the future classifier probabilities to generate trend (pattern) predictions for the future. In some embodiments, step 908 is performed by hypothesis engine 120.

Process 900 is shown to include evaluating the future patterns with chat bots and users (step 910). The future patterns can be provided to the users such that the users can provide feedback regarding whether they believe the future patterns to be accurate, reasoning why they believe the future patterns to be accurate or inaccurate, etc. The feedback can be utilized to refine the first and second deep learning models such that the models can generate more accurate outputs in later iterations of process 900. Results of the evaluation may also be stored in a common sense knowledge database for future reference. In some embodiments, step 910 is performed by pattern validator 126.

Process 900 is also shown to include extracting patterns from the text data (step 912). The patterns extracted in step 912 may be indicative of historical patterns. In this way, the patterns can indicate information such as what events led to other events in the past, what classifiers are commonly associated with certain events, etc. The patterns can be extracted directly from the output of the first deep learning model. In some embodiments, step 912 is performed by hypothesis engine 120.

Process 900 is shown to include evaluating historical patterns with chat bots and users (step 914). In some embodiments, step 914 is similar to and/or the same as step 910. In this case, however, the patterns evaluated in step 914 may be historical patterns such that the users can indicate whether the patterns are accurate based on actual historical information. In some embodiments, step 914 is performed by hypothesis engine 120.

Process 900 is shown to include storing evaluated patterns in a graph (step 916). If the evaluations in step 914 were positive (e.g., the patterns were evaluated as accurate), the evaluated patterns can be stored in graph form with a relatively high confidence level. In other words, if the users indicated the historical patterns are accurate, the graph associated with the patterns may be accurate. If the patterns were evaluated in step 914 as inaccurate, the graph associated with the patterns may be modified to fit the evaluations and/or may be discarded completely (in which case step 914 may or may not occur). In some embodiments, step 916 is performed by CSK engine 122/CSK database 124.

Referring now to FIG. 9B, a flow diagram of a process 950 for generating and evaluating historical and future patterns is shown, according to some embodiments. In some embodiments, process 950 is similar to and/or the same as process 900 as described with reference to FIG. 9A. More specifically, process 950 can illustrate a flow of information into different models and processes for analyzing the data. Process 950 can also illustrate how two separate deep learning models can be utilized for generating classifier probabilities and generating future classifier probabilities. It should be appreciated that lengths of time shown in process 950 (e.g., two years) are given for sake of example. Other lengths of time can be utilized in various embodiments.

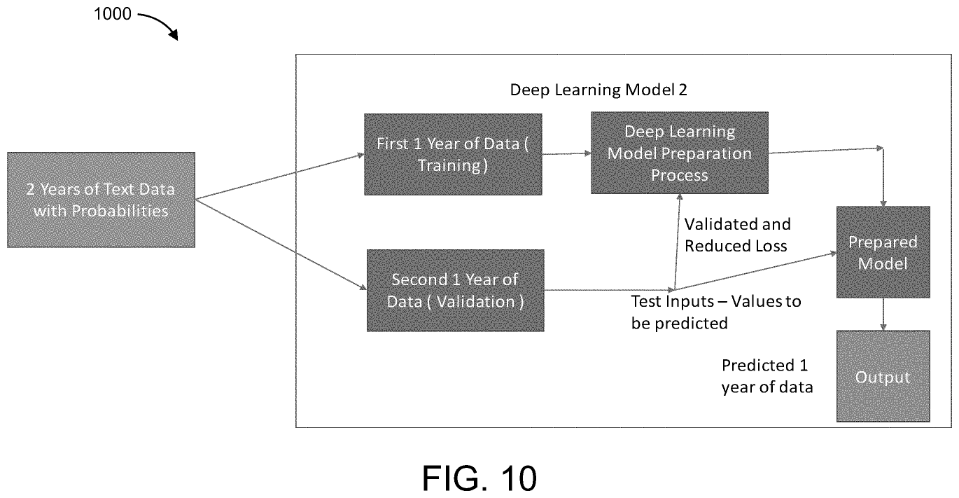

Referring now to FIG. 10, a flow diagram of a process 1000 performed by the second deep learning model of processes 900 and 950 is shown, according to some embodiments. Process 1000 can illustrate how the second deep learning model can utilize text data and associated probabilities to extract/identify future classifier probabilities.

In process 1000, the second deep learning model splits two years of text data with probabilities into a first year of data and a second year of data. As should be appreciated, two years is given for sake of example. If, for example, three years of text data and probabilities are available, the three years may be split into 1.5 year segments.

In some embodiments, the first year of data represents training data for the deep learning model. The second year of data can be used to validate the model after generation. As shown in process 1000, the first year of training data can be provided to a deep learning model preparation process than can include training the second deep learning model. The second year of validation data can be used to ensure the second deep learning model accurately generates probabilities for text data. In particular, the text data of the second year can be passed into the model to generate a validation set of classifier probabilities. The validation set of classifier probabilities can be compared against the actual classifier probabilities of the second year of validation data. If the validation set is similar to the actual probabilities, the second model may be valid. If the validation set is not similar to the actual probabilities, the model may be retrained using different data.

In process 1000, once the model is prepared, the second year of data can be passed into the model to generate a first predicted year of data as output of the second deep learning model. In other words, the second year of data can be passed into the model to generate classifier probability predictions for a third year (i.e., a year following the second year).

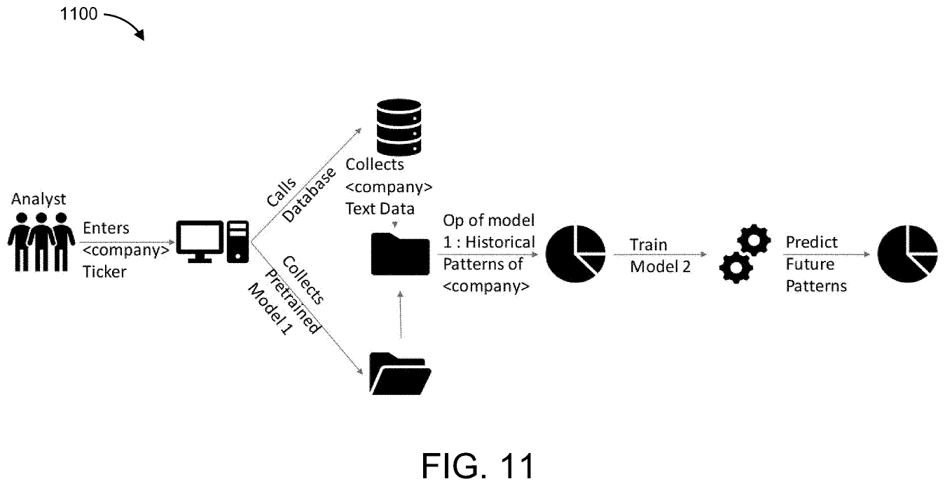

Referring now to FIG. 11, a flow diagram of a process 1100 for providing predicted patterns to a user is shown, according to some embodiments. In some embodiments, process 1100 is performed by components of language computing system 100. Process 1100 can illustrate an example of how a user (e.g., an analyst) can request and be provided feedback regarding a particular company.

Process 1100 is shown to include an analyst providing a company ticker symbol to a computing system (i.e., language computing system 100). The ticker symbol is given as for purposes of example. The analyst may provide other uniquely identifiers of the company of interest such as a name of the company.

Based on the ticker symbol (or other unique identifier), a database can be called to collect text data of the company. Likewise, a historical pattern model describing the company can be retrieved. If no historical pattern model is available, process 1100 may include generating a historical pattern model. In process 1100, the text data can be passed through the historical pattern model to generate/determine historical patterns of the company. These historical patterns can be used to train a second model, namely a future pattern model, to predict future patterns of the company. These future patterns predicted by the second model can be provided back to the analyst to allow the analyst to make informed decisions. For example, the future patterns may indicate anticipated stock prices such that the analyst can determine whether to hold, sell, and/or buy stock in the company.

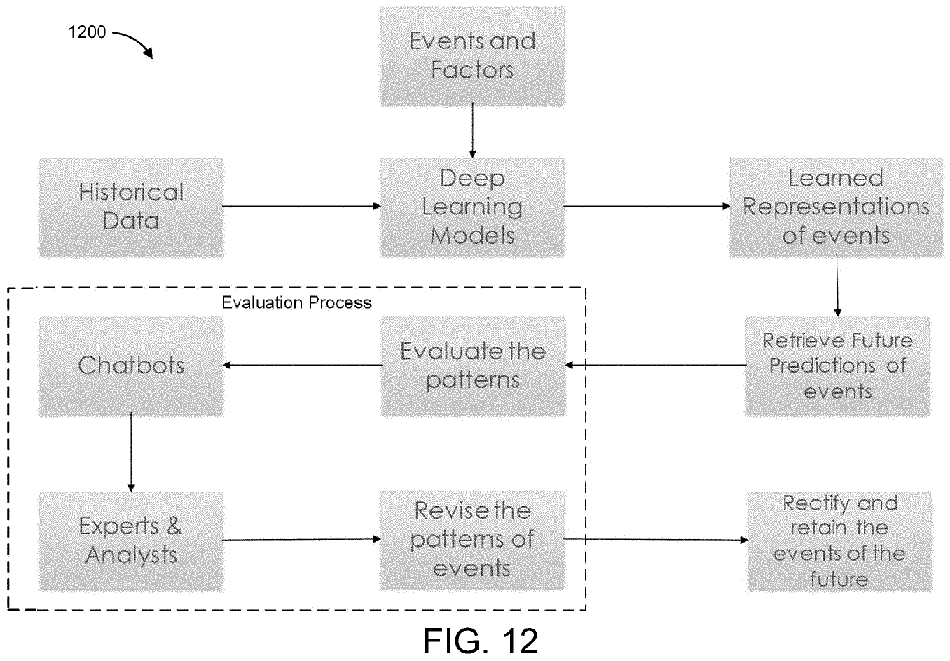

Referring now to FIG. 12, a flow diagram of a process 1200 for generating and revising predicted patterns is shown, according to some embodiments. Process 1200 can be performed by various components of language computing system 100.

Process 1200 is shown to include deep learning models receiving historical data as well as events and factors. In process 1200, a historical pattern model and a future pattern model may be generated based on the historical data as well as the events and factors. The historical data may include any articles/text documents regarding a specific company that can be used to obtain an understanding of trends of the company. The events and factors may define various classifiers that can be identified in the historical data. The events and factors may be provided by a user, automatically generated, etc. The deep learning models may be any appropriate model type (e.g., CNN, LSTM, etc.).

As a result of providing the historical data, events, and factors to the deep learning models, learned representations of events can be generated. In some embodiments, the learned representations represent historical patterns of the company. As shown in process 1200, based on the learned representations and the deep learning models, future predictions of events can be retrieved. The future predictions may be retrieved based on output from the future pattern model of the deep learning models.

Process 1200 is shown to include an evaluation process and a step for initiation thereof. The evaluation process can be performed to verify accuracy of the patterns and/or determine if adjustments (e.g., retraining) of the models may be necessary. The evaluation process can include providing the patterns to users via chat bots. In this way, after the patterns are generated, the chat bots can automatically provide the patterns to experts and analysts for verification/validation. It should be noted that experts and analysts are provided for sake of example. The patterns can be provided to any user capable of providing useful feedback on the patterns. In some embodiments, the chat bots are triggered by a user indicating that the patterns should be validated as opposed to the chat bots being automatically triggered.

Based on feedback from the experts and analysts, the patterns of events can be revised. The patterns may be revised based on information provided by the experts and analysts such as, for example, whether the experts and analysts believe the patterns to be accurate, additional articles provided by the experts and analysts for consideration, reasoning of opinions, etc. In some embodiments, revising the patterns of events is the last step of the evaluation process in process 1200. The last step in process 1200 can include rectifying and retaining the events of the future. In some embodiments, rectifying and retaining the events only occurs if feedback from the experts and analysts can be successfully integrated if/when revising the patterns. If the experts and analysts indicate the patterns are extremely inaccurate and/or are invalid, the patterns may be discarded and process 1200 can be performed again to generate new patterns.

Rectification and retainment of events can include storing the events in a common sense knowledge database (e.g., CSK database 124 as described with reference to FIG. 1), providing the events to users for further analysis, etc. In this way, the events can be referenced at later a later time. Further, by retaining the events, comparisons can be performed later to determine if the future patterns were accurate with actual real world events. For example, if the future patterns indicate certain events will occur within a year, a comparison can be made at the end of the year to determine whether the predictions of the future patterns were accurate. If the predictions are accurate, the deep learning models may be reinforced. However, if the predictions end up being inaccurate if compared to actual events, the models may be retrained to account for the inaccuracies. By performing process 1200, language computing system 100 can generate historical and future patterns of events, can verify the accuracy/validity of the patterns with experts and analysts as well as modify the patterns if necessary, and can rectify and retain the events of the future.

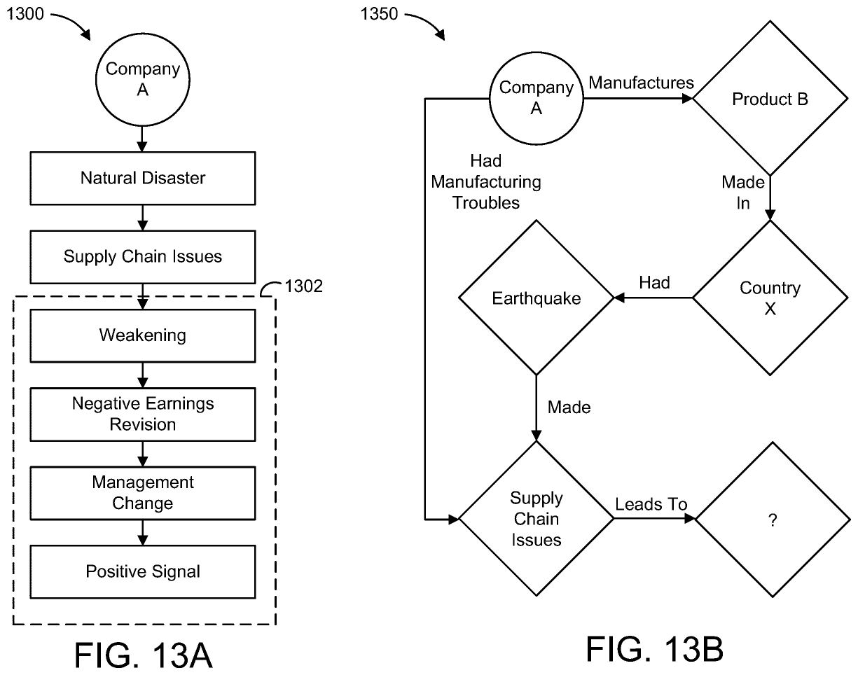

Referring now to FIG. 13A, an illustration 1300 of an event pattern that can be generated by hypothesis engine 120 is shown, according to some embodiments. Illustration 1300 is provided purely for sake of example of an event pattern that may be generated for a particular company. As such, the events shown in illustration 1300 are not intended to be limiting on the present disclosure.

The event pattern shown in illustration 1300 can be associated with a Company A. Based on articles obtained regarding Company A, hypothesis engine 120 may determine that a natural disaster has occurred which led to supply chain issues. Identification of the natural disaster and supply chain issues may be identified by historical pattern identifier 202 as described with reference to FIG. 2. In this way, historical pattern identifier 202 may generate a historical pattern indicating that the natural disaster resulted in the supply chain issues. The event can various types of phenomena or events including but not limited to war, rebellion, disease, famine, weather, legal or regulatory changes, tariffs, etc.

Illustration 1300 is shown to include a predicted pattern 1302. Predicted pattern 1302 can represent a future pattern of events predicted based on the natural disaster or other event affecting the supply chain as identified by historical pattern identifier 202. Predicted pattern 1302 may be generated by future pattern predictor 204. Specifically, future pattern predictor 204 can utilize a future pattern model available for Company A and determine what future events may occur as a result of the supply chain issues and natural disaster. In the example of illustration 1300, predicted pattern 1302 is shown to include a weakening of Company A thereby leading to a negative earnings revision resulting from the supply chain issues. Based on the negative earnings revision, predicted pattern 1302 is shown to include a prediction that a management change will occur in Company A followed by a positive signal indicating some recovery from the weakening. Intuitively, the predictions of predicted pattern 1302 are reasonable as supply chain issues may be generally associated with various problems for companies (e.g., lost earnings, damaged products or locations, etc.). As such, if an expert/analyst were provided predicted pattern 1302, the expert/analyst may indicate in this scenario that some and/or all of the predictions of predicted pattern 1302 are valid, thereby reinforcing the predictive models and increasing a confidence level of the predictions.

Referring now to FIG. 13B, a graph 1350 of associations that can be stored in CSK database 124 are shown, according to some embodiments. In some embodiments, graph 1350 is generated by ontology graph generator 118 and/or CSK engine 122. As compared to illustration 1300 as described with reference to FIG. 13A, graph 1350 can represent obtained knowledge describing Company A. For example, graph 1350 is shown to indicate that Company A manufactures a Product B which is made in Country X. Further, graph 1350 is shown to indicate that Country X had an earthquake that made supply chain issues. Likewise, graph 1350 is shown to indicate that Company A had manufacturing troubles that were associated with supply chain issues. It should be noted that graph 1350 does not indicate what the supply chain issues lead to. As graph 1350 is can be generated by ontology graph generator 118 and/or CSK engine 122, graph 1350 may not include any predictive information. As compared to illustration 1300, graph 1350 can capture information extractable from articles and/or other sources of textual information whereas illustration 1300 may include predictions based on the known information.

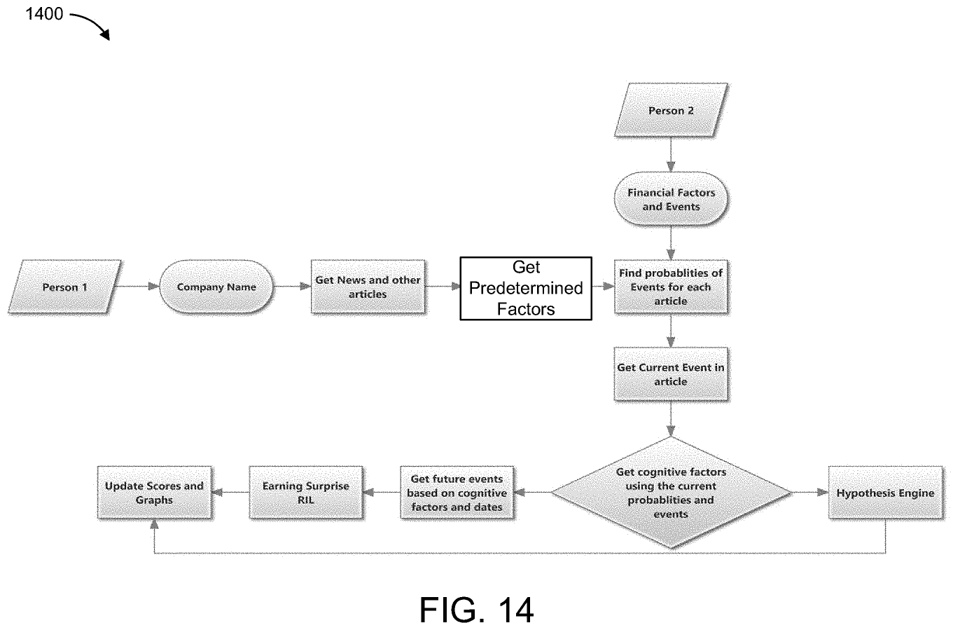

Referring now to FIG. 14, a flow diagram of a process 1400 for allowing users to provide information for generating predictions and updating the predictions is shown, according to some embodiments. Process 1400 illustrates an example of how users may interact with language computing system 100 and how language computing system 100 may operate as a result of the interaction.

In process 1400 a first user can provide a company name and/or other unique identifier of a company (e.g., a ticker symbol). Based on the company name, news and other articles describing the company can be gathered. In some embodiments, the news and articles are gathered by article collector 114. Further, predetermined factors associated with the company can be gathered for later determinations regarding what factors resulted in certain events occurring. The predetermined factors may be based on factors for other companies, general factors associated with a particular industry the company participates in (e.g., the financial industry), etc.

As shown in process 1400, a second user can provide financial factors and events. In some embodiments, the second user provides the financial factors and events via user device 112. Based on the information gathered and provided by the users, a probability of events in each article can be found. In effect, process 1400 can include generating probabilities that the events occur in each article. In some embodiments, generating the probabilities is performed by historical pattern identifier 202 as described with reference to FIG. 2.

Process 1400 is also shown to include getting a current event in an article. In some embodiments, the current event defines an event with a highest probability in the article. In some embodiments, the current event defines a most recent event to occur with regard to a company (e.g., a primary event in an article with a timestamp closest to a current time).

Based on the current probabilities and events, cognitive factors can be obtained. The cognitive factors may define factors that are most likely to result in certain events occurring. Based on the cognitive factors, a hypothesis engine (e.g., hypothesis engine 120) can be initiated and future events can be obtained. In effect, based on the cognitive factors, historic and future patterns can be generated. Particularly based on the future patterns, an earnings surprise can be estimated. An earnings surprise is given for sake of example of a variable that can be predicted based on the predicted future events. Other variables may include, for example, a future stock price, EPS, etc. Based on the earnings surprise and outputs of the hypothesis engine, scores and graphs can be updated. In some embodiments, the scores reflect a relative accuracy of the predictive models. The scores and graphs may be updated based on user feedback, comparing real world observations to model predictions, etc.

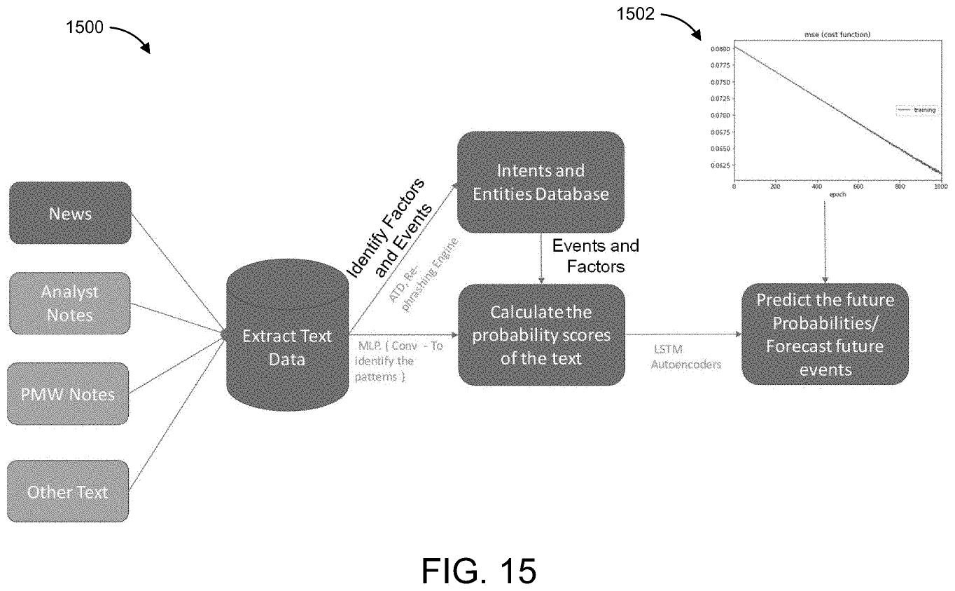

Referring now to FIG. 15, a flow diagram of a process 1500 for predicting future probabilities and forecasting future events is shown, according to some embodiments. Process 1500 can reflect how gathered articles and/or other textual information can be used to generate predictions. In some embodiments, process 1500 is performed by language computing system 100.

Process 1500 is shown to include extracting text data from various text sources. In particular, process 1500 is shown to include extracting text data from news sources, analyst notes, PMW notes, and other text (e.g., Twitter, Facebook, earnings calls, etc.). Sources of textual information may be highly configurable and customizable depending on a type of source desired, what sources are available, etc. In effect, process 1500 can include obtaining all forms of input text related to an organization. Text data extraction can be include extracting the text using various applications such as a Web scraper, manual entry by users, database retrieval, and/or other suitable forms of text extraction. Before the text data is utilized, process 1500 may include cleaning the data. Cleaning the data can remove unnecessary, corrupted, and/or inaccurate information from the text data. For example, cleaning the data may include deleting any extracted text in a foreign language if the foreign language is not supported for analysis. As another example, cleaning the data may include removing any text associated with advertisements that obtained in Web scrapping. Cleaning of data can be performed by a user and/or automatically by article collector 114.

In some embodiments, extracting the text data includes identifying factors and events associated with the text data. In some embodiments, the factors and events are partially and/or completely identified based on information provided by users.

Based on the extracted text data and the identified factors and events, an intents and entities database can be utilized to organize important events and factor data. In some embodiments, the intents and entities database is a component of CSK database 124 as described with reference to FIG. 1. As such, the relationships between events and factors may be stored in a graph format (e.g., factors lead to events occurring). As shown in process 1500, the events and factors stored in the intents and entities database along with the text data can be provided for calculation of probability scores of the text. In some embodiments, calculating the probabilities scores of the text is performed by a CNN. In this way, the CNN can be used to identify patterns. High accuracy in probability calculations (e.g., >80%, >90%, etc.) for current factors (e.g., current financial factors) can be particularly useful in predicting a current event. In some embodiments, calculating the probability scores in the text is performed by hypothesis engine 120.

Process 1500 can also include, based on the calculated probability scores, predicting future probabilities and/or forecasting future events. In some embodiments, LSTM autoencoders are used to identify the most important factors that lead to a future event for an organization. Based on a quality of the text data, the accuracy of the event prediction may vary. FIG. 15 is also shown to include a graph 1502 illustrating an example of LSTM autoencoder accuracy over time. Graph 1502 can illustrate an example of how little accuracy loss may occur in existing data for a company.

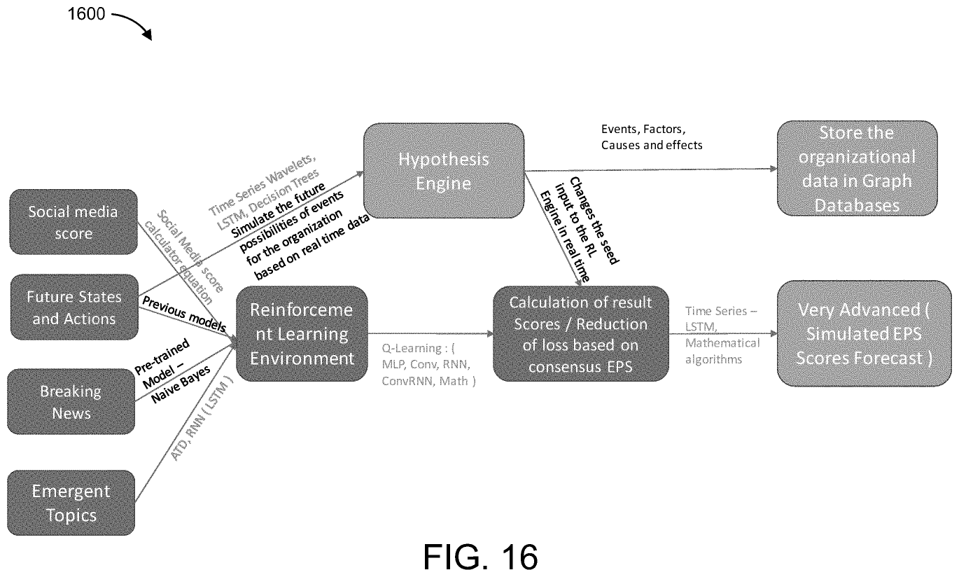

Referring now to FIG. 16, a flow diagram of a process 1600 for generating predictions and storing knowledge of regarding a company is shown, according to some embodiments. Process 1600 is shown as an example of forecasting EPS. However, process 1600 can be similarly applied in forecasting other variables (e.g., stock price, earnings surprise, etc.) of the company. In some embodiments, process 1600 is performed by language computing system 100.

As shown in process 1600, multiple sources of information can be accessed for obtaining information regarding the company. Specifically, process 1600 is shown to include obtaining a social media score based on a social media score calculator equation, future states and actions based on previous models, breaking news based on a pre-trained model (e.g., a naïve Bayes model), and emergent topics based on an ATD and a RNN (e.g., an LSTM) model. The social media score may be a score indicating an overall sentiment of users (e.g., employees, customers, business partners, etc.) on social media. The social media score calculator equation can calculate the social media score based on user posts, ratings, interactions (e.g., likes/dislikes, shares, etc.), and/or other appropriate metrics to generate an overall score of the company on social media. The social media score can be useful in determining how the public views the company which may impact aspects of the company such as sales, active litigations, market share, stock price, etc. Advantageously, the future states and actions can be determined based on previous models. In this way, previous models of regarding patterns of the company are not immediately discarded and can be used for identifying new patterns of the company. The breaking news and emergent topics can be determined/identified based on models that identifying new updates in the news that may affect the company as well as topics emerging in a particular field. For example, new technology may result in a new field of research that can be identified as a new topic that may result in occurrence of certain events for the company. It should be appreciated that the sources of company information shown in process 1600 are given for sake of example. Any appropriate source of information can be accessed for obtaining information regarding the company.

The information regarding the company can be provided to a reinforcement learning environment. In some embodiments, the reinforcement learning environment is managed/maintained by reinforcement learning module 212 as described with reference to FIG. 2. The reinforcement process is described in greater detail above with reference to FIG. 2. In essence, based on the provided information, the reinforcement learning environment can identified actions for each upcoming event and can calculate associated reward scores.

As shown in process 1600, the future states and actions can also be provided to a hypothesis engine (e.g., hypothesis engine 120). The hypothesis engine can identify historical patterns and information regarding the company and can predict future patterns of the company. The hypothesis engine can provide events, factors, causes, and effects to be stored in graph databases (e.g., CSK database 124). In this way, organizational data can be stored in a graph format for later retrieval and reference. Based on output of the hypothesis engine and the reinforcement learning environment, result scores can be calculated as well as a reduction of loss based on a consensus EPS. In this example, if the resultant scores are higher, a high earnings surprise may be anticipated. If the reward is lower, the earnings surprise may also be low compared to the consensus. In this case, more data can ensure a higher accuracy and reliability of the models used in process 1600.

Process 1600 is also shown to include simulating the forecast of the EPS scores in real time based on the real time calculations of the rewards, past EPS scores, and numerical data. The simulation can generate forecasted values of EPS that may be helpful to users. For example, the forecasted EPS may be used by users to determine whether to buy or sell stock in the company.

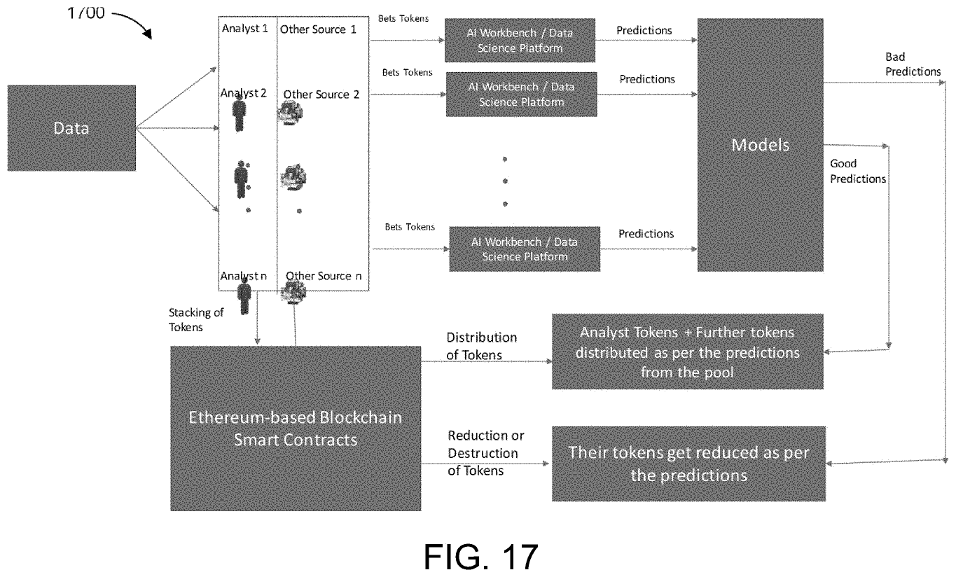

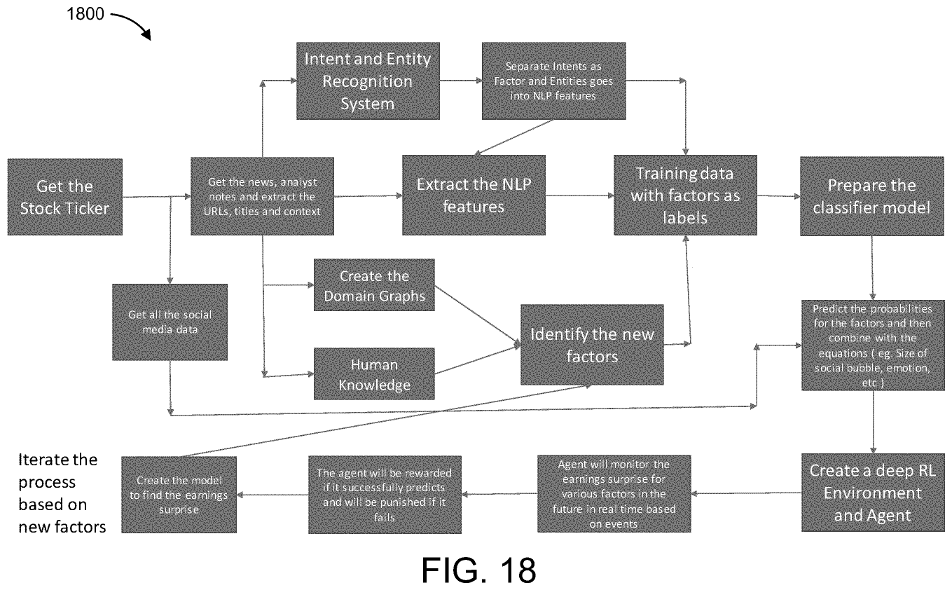

Referring now to FIG. 17, a block diagram of a decentralized AI system 1700 is shown, according to some embodiments. Decentralized AI system 1700 can be utilized to validate data with analysts (or other sources of verification/validation). Decentralized AI system 1700 can be particularly helpful in validation of prediction scores, making changes to an environment as per the credibility of sources, and in assigning a weightage score to the sources. Advantageously, decentralized AI system 1700 can provide incentives for analysts to provide feedback on data (e.g., patterns generated by language computing system 100). As such, language computing system 100 may utilize and/or include decentralized AI system 1700 in validating patterns and/or other data. In particular, pattern validator 126 may use decentralized AI system 1700 to gather feedback from analysts.

Decentralized AI system 1700 is shown to include providing data to analysts. For example, the data provided to analysts may include patterns for validation/verification. Based on the data, the analysts can bet tokens and provide predictions (or other analyses) on historical and/or future patterns. In some embodiments, betting token includes allowing a user to set an amount of token to bet with a prediction. In this case, analysts may place higher bets if they believe their prediction is accurate and valuable. Decentralized AI system 1700 may place a maximum token threshold that can be associated with a particular prediction. In some embodiments, a bet is a constant amount of tokens set by decentralized AI system 1700. In this case, analysts may all bet the same amount of tokens if providing predictions.

The analyst predictions can be evaluated by a model to determine whether the predictions are appropriate or are poor. If the predictions are good, the analyst can have the tokens they originally bet returned as well as be rewarded with further tokens from a token pool. In some embodiments, the amount of additional tokens provided to the analyst is scalable based on a quality of the prediction (e.g., higher quality predictions receive more tokens). In this case, the analyst may be associated with a higher weightage, thereby indicating their feedback may be more valuable. However, if the analyst provides bad predictions are determined by the model to be inaccurate, the analyst may lose some and/or all of the tokens they originally bet. Further, the analyst may be associated with a lower weightage, thereby indicating their feedback may not be as valuable in reviewing data.

Each time an analyst bets tokens, the “transaction” can be recorded in a blockchain-based smart contract. In decentralized AI system 1700, the Ethereum blockchain is shown as a blockchain of choice for sake of example. Other blockchain systems that support smart contracts can be utilized.

Decentralized AI system 1700 can provide a meaningful system for obtain feedback from analysts on trends and/or other patterns. Decentralized AI system 1700 can incentivize analysts to provide the highest quality analyses of the patterns by distributing tokens as rewards for accurate and insightful analyses. Conversely, decentralized AI system 1700 can punish analysts for providing poor analyses. Further, by utilizing a blockchain, decentralized AI system 1700 can provide a high reliable system in terms of properly distributing tokens to analysts. Assigning weightages to analysts can also ensure that the opinions and analyses provided by experts in a particular subject are valued more highly than analysts that are not as qualified in providing opinions and analyses.

Referring now to FIG. 18, a flow diagram of a process 1800 that can be performed by an AI system is shown, according to some embodiments. Process 1800 can illustrate how information regarding a company can be obtained and used to predict patterns of the company into the future. In some embodiments, process 1800 is performed by language computing system 100 as described with reference to FIG. 1.

Process 1800 is shown to include getting a stock ticker (or other unique identifier) to identify a company of interest. Based on the identified company of interest, news, analyst notes, social media data, articles, etc., regarding the company can be collected. Information extraction can be performed process 1800 to pull out information that may describe a history of the company and trends associated therewith. The extracted information can be used by an intent and entity recognition system to identify specific intents and entities. The intents can be separated as factors and entities can be provided for extraction of natural language processing (NLP) features. The extracted information regarding the company can also be used to create domain graphs describing the company and to determine/identify specific human knowledge. The domain graphs and human knowledge can be used to identify new factors that may be applicable to the company. Based on the NLP features and new factors among other information, training data can be compiled with factors being utilized as labels.

Process 1800 can include preparing a classifier model using the training data and labels. Based on the classifier model and social media data, probabilities of the factors can be predicted and combined with equations (e.g., size of social bubble, emotions, etc.). Based on the predicted probabilities, the AI system can create a deep RL environment and agent. In this case, the agent can monitor, in real time, a variable (e.g., earnings surprise) for various factors in the future based on events. If predictions of the agent are successful, the AI system can reward the agent. If the predictions fail, the AI system may punish the agent. Relative to an amount the agent has been awarded/punished, a model can be created by the AI system to find the earnings surprise (or other variable). In this way, the AI system can obtain a model useful for generating predictions for a company. Process 1800 can be iterated based on any new factors that are identified/received.

Referring now to FIG. 19, a flow diagram of a process 1900 for performing auto-topic discovery and validating results of the auto-topic discovery is shown, according to some embodiments. In some embodiments, process 1900 is language computing system 100 as described with reference to FIG. 1. Advantageously, process 1900 can help improve accuracy of pattern generation by preparing classifiers with associated topics and phrases for individual organizations that can be used in pattern generation.

As shown in process 1900, based on a new dataset, ATD can be performed to identify topics, phrases, candidates, etc. In some embodiments, ATD in process 1900 is performed by ATD engine 206 as described with reference to FIG. 2. In this way, prevalent key-words and/or phrases can be identified that are associated with a particular classifier. For smaller datasets, the information generated by ATD can be provided to an individual user via a user interface (UI) (e.g., presented on a user device). In some embodiments, various steps of process 1900 associated with interfacing with users is performed by pattern validator 126. With smaller datasets, a single user may be able to parse through all the relevant information to identify what information can be appropriately stored in an intents and entities database. In some embodiments, the intents and entities database is a component of CSK database 124. However, for larger datasets, input from multiple users may be required.

If input from multiple users is required, process 1900 may include performing A/B testing with multiple users. In A/B testing, a user can be presented with two variants of information. For example, a user may be presented with two separate phrases and can select which is more appropriate for a given classifier. In some embodiments, other types of testing are utilized to obtain feedback from users.

Results of the A/B testing can be applied in reinforcement learning based gamification environment that utilizes a bot (e.g., a chatbot) to gather information from users. In some embodiments, a game managed by the bot includes multiple rounds to gather information from users on multiple topics associated with the datasets. For example, a first round may gather feedback on topics, phrase reactions, and tier tags. A second round may gather, for example, information regarding candidates and topics via a multiple choice format. A third round may gather, for example, information regarding classes and themes as well as a hierarchical grouping of the classes and themes.

Based on feedback on the datasets, an intents and entities database can be populated. The intents and entities database can include information such as classifiers, classes, themes, and phrases that can be used in various application. For example, the classifiers, classes, themes, and phrases may be used to estimate a market size of a company, generate knowledge and decision graphs, analyzed by a natural language understanding (NLU) engine, predict an earnings surprise of a company, etc.

Process 1900 can be performed for various classifiers and for multiple companies. In this way, auto-topic discovery can be applied to identify prevalent key-words and/or phrases associated with a classifier for each classifier associated with a company. As the information can be validated with users, accuracy of the prevalent key-words and/or phrases can be verified.

Referring now to FIG. 20, a block diagram of an emotion recognition system 2000 is shown, according to some embodiments. Emotion recognition system 2000 can be used to obtain information regarding an emotional state of a person based on their speech. For example, emotion recognition system 2000 may monitor a pitch, a volume, intonations, and/or other indicators in a person's voice. Emotion recognition system 2000 can integrate neural networks to gather more acute understandings of a person's emotional state based on their speech. In particular, LSTM based deep embedding features can be used to determine emotional states and/or other emotion information related to a speech signal.

In some embodiments, emotion recognition system 2000 is used in tandem with and/or is integrated in language computing system 100 as described with reference. For example, emotion recognition system 2000 may be utilized by pattern validator 126 to obtain audio feedback from an expert regarding a generated pattern. Specifically, emotion recognition system 2000 can provide emotion information regarding the expert's feedback that may indicate information regarding how the expert views a pattern. For example, if emotion recognition system 2000 determines an overall tone of the expert is positive, the determination in combination with actual feedback can be used to rate an accuracy of the pattern.

Emotion recognition has many applications particularly in the field of human computer interaction (HCI) and in designing systems that can act according to a state of mind of a person. Human speech can include information related to the emotional state of a person either in the language or in the way they utter speech. For example, there may be a difference in the way people ask “What?” when they are angry which may be quick as compared to exclaiming “What!” when they are surprised which may be more elongated.

In particular, emotion recognition system 2000 can combine features in speech processing with deep learning to gain a better understanding of human emotion. Deep learning can be used to improve performance of various machine learning tasks. As such, deep features can be used by emotion recognition system 2000 to improve results in emotion recognition over standard systems through utilization of neural architectures. For example, emotion recognition system 2000 can utilize deep learning to label audio data as labeling audio data may typically take lot of time and effort. In this case, LSTM autoencoder based features can be used, for example, to automatically label audio data as opposed to necessitating time-consuming manual labeling.

Emotion recognition can be used potentially in various tasks related to HCI to make them more interactive and natural. Standard indicators of emotion recognition from various kinds of signals may include speech, face expressions, physiological signals (e.g., heart rate), electrodermal activity, etc. As it can be noted that people emote through their language and the way they speak, it can be assumed that emotion recognition is possible by analyzing speech signals. As such, machine learning techniques can be applied to classify various emotions. However, deep neural architectures have improved the performance and usability of emotion recognition systems.

Machine learning techniques that can be utilized in speech emotion recognition can include techniques such as hidden Markov models (HMM), Gaussian mixture models (GMM), etc. Deep learning models are more recent and are used in speech emotion recognition. In GMM-based emotion recognition, a universal background model (UBM), a GMM formed using a lot of collective speech data including all emotions from various people, can be developed and the variations while adapting each utterance from this initial state can be used for classifying between emotions. In this case, support vector machines (SVM) can be used for classification of emotions. Deep neural networks (DNN) do appear to provide many benefits in emotion recognition. The advantages of these network-based recognition systems can include scalability and improved performance as the amount of data increases. However, obtaining data in emotion recognition tasks can be difficult as it is expensive and time taking. This is due to the fact that elicited emotions may require professional actors to act these emotions who need to be paid and that labeling data requires man power and time. To mitigate these and other costs, unsupervised and/or semi-supervised emotion recognition techniques can be utilized.

As described in greater detail below, emotion recognition system 2000 can define utterances that indicate elicited emotions. Emotion recognition system 2000 can utilize input data from various databases (e.g., the interactive emotional dyadic motion capture (IEMOCAP) database) for extracting and evaluating features in speech emotion recognition task. In conversations indicated by the input data, the utterances can be segmented and labeled by users and divided into different categories (e.g., happy, sad, excited, neutral, angry, frustrated, etc.). As described in detail below, emotion recognition system 2000 may use the categories of happy, neutral, sad, and angry in recognizing emotions for sake of example. However, the categories used by emotion recognition system 2000 can be customized and configured as desired.

Emotion recognition system 2000 is shown to include a communications interface 2008 and a processing circuit 2002. In some embodiments, communications interface 2008 and processing circuit 2002 are similar to and/or the same as communications interface 108 and processing circuit 102 as described with reference to FIG. 1, respectively. In some embodiments, emotion recognition system 2000 can use techniques as described in U.S. Pat. No. 9,727,371 granted Aug. 8, 2017, U.S. patent Ser. No. 10/268,507 granted Apr. 23, 2019, U.S. patent application Ser. No. 16/293,801 filed Mar. 6, 2019, and U.S. Provisional Patent Application No. 62/887,609 filed Aug. 15, 2019, each of which are incorporated by reference herein in their entirety. In some embodiments, the results of the emotion processing described in the patent incorporated by reference herein can be used as additional input or combined with the result data associated with emotion recognition system 2000. Communications interface 2008 may include wired or wireless interfaces (e.g., jacks, antennas, transmitters, receivers, transceivers, wire terminals, etc.) for conducting data communications with various systems, devices, or networks. For example, communications interface 2008 may include an Ethernet card and port for sending and receiving data via an Ethernet-based communications network and/or a Wi-Fi transceiver for communicating via a wireless communications network. Communications interface 2008 may be configured to communicate via local area networks or wide area networks (e.g., the Internet, a building WAN, etc.) and may use a variety of communications protocols (e.g., BACnet, IP, LON, etc.). Communications interface 2008 may be a network interface configured to facilitate electronic data communications between emotion recognition system 2000 and various external systems or devices (e.g., user device 112).

Processing circuit 2002 is shown to include a processor 2004 and memory 2006. Processor 2004 may be a general purpose or specific purpose processor, an application specific integrated circuit (ASIC), one or more field programmable gate arrays (FPGAs), a group of processing components, or other suitable processing components. Processor 2004 may be configured to execute computer code or instructions stored in memory 2006 or received from other computer readable media (e.g., CDROM, network storage, a remote server, etc.).

Memory 2006 may include one or more devices (e.g., memory units, memory devices, storage devices, etc.) for storing data and/or computer code for completing and/or facilitating the various processes described in the present disclosure. Memory 2006 may include random access memory (RAM), read-only memory (ROM), hard drive storage, temporary storage, non-volatile memory, flash memory, optical memory, or any other suitable memory for storing software objects and/or computer instructions. Memory 2006 may include database components, object code components, script components, or any other type of information structure for supporting the various activities and information structures described in the present disclosure. Memory 2006 may be communicably connected to processor 2004 via processing circuit 2002 and may include computer code for executing (e.g., by processor 2004) one or more processes described herein. In some embodiments, one or more components of memory 2006 are part of a singular component. However, each component of memory 2006 is shown independently for ease of explanation.

Memory 2006 is shown to include a low level descriptor analyzer 2010. Low level descriptor analyzer 2010 can be used to analyze speech at a frame-level. Low level descriptor analyzer 2010 can receive a speech signal from a speech source 2024. Speech source 2024 can represent one or more sources of speech signals that can be analyzed by emotion recognition system 2000. For example, speech source 2024 may include a microphone, a website that provides audio recordings, a phone call, etc.

In some embodiments, speech source 2024 is a universal serial bus (USB) device (or other storage device) that allows stored audio files of the USB to be uploaded to emotion recognition system 2000. In this case, the USB may be handled by a call operator of a call center such that the USB can record all conversations between the call operator and customers if connected to a device (e.g., a computer, a laptop, a phone, a headset, etc.) of the call operator. In this case, the USB may include functionality for transcribing calls associated with the call operator. Including functionality on the USB allocated for a particular user allows the functionality to be trained for the particular user, the particular speech patterns of the user, the particular requests associated with the user, the user's typical responses, etc. The USB can be helpful in a variety of cases. For example, the USB may store all conversations between the call operator and customers for later retrieval and can act as mobile storage for the call operator. If the USB is connected to a device (e.g., a computer, a server, etc.) that can communicate with emotion recognition system 2000, all of the stored audio files of the USB can be provided to emotion recognition system 2000 as speech source 2024. In this way, emotion recognition system 2000 can parse through each recording and identify emotions of the call operator and/or customers. This can be useful for quality assurance in the call center by ensuring the call operator is kind to customers and customers are not upset during calls with the call operator.

In some embodiments, speech source 2024 is a bot that can monitor and record audio information. For example, in a call center, the bot may monitor and record conversations between call operators and customers. In this example, every time a new conversation is initiate between a call operator and a customer, the bot can be activated and can track and record the new conversation. Once the conversation is complete, the bot can provide recorded audio data from the conversation to emotion recognition system 2000 for processing.

Speech can be considered a non-stationary signal as the frequencies and the way speech is produced can change rapidly. As such, speech can be analyzed by low level descriptor analyzer 2010 at the frame-level where the whole speech is divided into frames of certain length and features for each frame can be computed. Low level descriptor analyzer 2010 may utilize varying lengths of a frame length and a frame shift in analyzing speech. For example, low level descriptor analyzer 2010 may utilize a frame length and a frame shift or 25 milliseconds (ms) and 10 ms, respectively.

Low level descriptor analyzer 2010 is shown to include a mel-frequency cepstral coefficient (MFCC) generator 2014. MFCCs are traditional features that can be used for representing speech. MFCCs can be used in speech recognition, speech emotion recognition, speak recognition, etc. due to their ability to capture information related to the vocal tract. MFCCs can be obtained by MFCC generator 2014 by passing mel-filter bank energies of the log of spectrum of speech signal through a discrete cosine transform (DCT) filter. In this case, MFCC generator 2014 can extract these features where 13 dimensional MFCC vectors for each frame can be obtained which includes one dimension for representing the energy of the signal.

Low level descriptor analyzer 2010 is also shown to include a linear prediction cepstral coefficient (LPCC) generator 2016. LPCCs are features which can be used in tasks where voice compression is a primary goal (e.g., voice coding tasks). Linear prediction techniques can allow speech signals to be separated into vocal tract filter and excitation source approximations where LPCC coefficients are used to represent the vocal tract filter characteristics as an all-pole filter. In some embodiments, LPCC generator 2016 can utilize LPCC features for emotion recognition task, particularly to determine if improvements can be obtained using embedding features.

Low level descriptor analyzer 2010 is also shown to include a residual MFCC generator 2018. As described above, MFCCs and LPCCs can capture information related to the vocal tract, the other key part of speech production being underrepresented in this case. However, the excitation source signal is known to include information related to emotion recognition. As such, features can be extracted from the residual signal which may be an approximation of the excitation source signal computed using linear prediction analysis by inverse filtering the speech signal through the all-pole filter from the LPCC. RMFCC can be used in various speech related tasks such as child vocalization analysis, speaker verification, etc.

Memory 2006 is shown to include an utterance level descriptor analyzer 2012. As categorical emotions labels for a speech signal may be given at an utterance level, there may be various ways of constructing emotion recognition system 2000. Some such constructions may include developing features at an utterance level or to consider a label given to an utterance as the label for all the frames within it and to develop systems using all frames as training data. In the latter systems, testing can be done using some sort of majority voting or median voting strategies. However, the disadvantage of such systems is that temporal information is not taken into account and statistics are only captured at a classifier level instead of at a feature level. Hence, utterance level descriptor analyzer 2012 can use the former approach where features are developed for each utterance. Even in such kind of approach, one approach that has been followed in the past was Gaussian mixture modeling (GMM) where the differences in Gaussian mixture components between each utterances are analyzed and used for classifying between emotions. Disadvantages of this approach include a requirement of a large dataset for initial modeling of speech for a starting point of GMM called the universal background model (UBM) and the inability to capture time-series information. As such, utterance level descriptor analyzer 2012 can use LSTM based deep-features for capturing information from the LLDs described above and can also extract other features. The other features may include, for example, LSTM autoencoder representation, LSTM categorical embeddings, jitter, shimmer, harmonics-to-noise ratio (HNR), and probability of voicing. The latter features of jitter, shimmer, HNR and probability of voicing may be extracted from a voice report. From the voice report, all the types of jitter, shimmer, HNR and probability of voicing are used which resulted in 14 features.

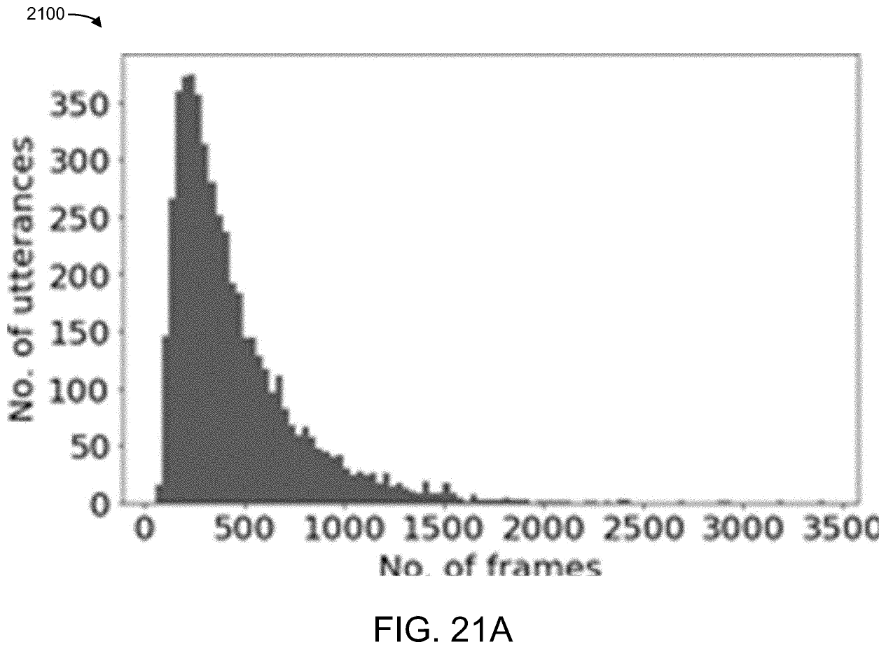

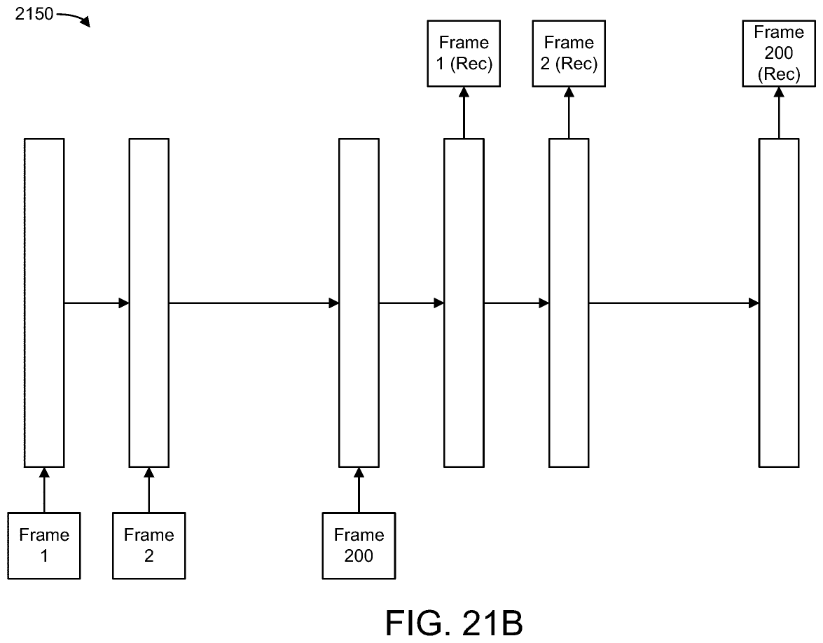

Utterance level descriptor analyzer 2012 is shown to include an LSTM autoencoder 2020. To capture information in an utterance as a single vector, LSTM autoencoder 2020 can train an LSTM network to predict itself and collect the hidden representation at the end of the encoder to represent the speech signal. In this process, all utterances may be required to have a unique length as the LSTM network may be fixed. As such, as extracting the LLDs, a number of frames in each utterance can be analyzed. An example histogram plot of a number of frames versus a number of utterances is shown below with reference to FIG. 21A. An example diagrammatic representation of the LSTM autoencoder network is shown below with reference to FIG. 21B.

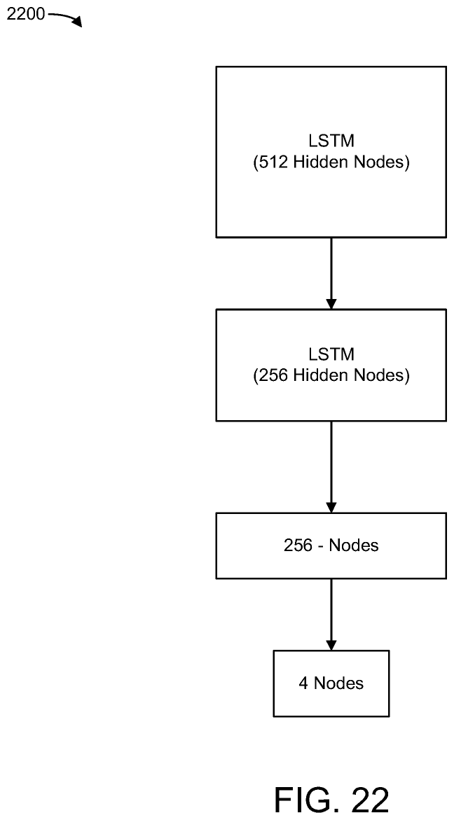

Utterance level descriptor analyzer 2012 is also shown to include a LSTM categorical embedding extractor 2022 for performing LSTM categorical embedding. The process regarding the low-level descriptors can be performed in a similar fashion as mentioned in an LSTM autoencoder representation framework. In some embodiments, the structure of the network may include two-stack LSTMS followed by a fully connected layer to a hidden layer with a rectified linear unit (ReLU) activation function. The ReLU layer can be considered as a representation layer and it can in turn be connected to the output layer with a softmax activation. In this case, LSTM categorical embedding extractor 2022 can train the network for each LLD which can be referred to as MFCC_cat_embedding, LPCC_cat_embedding, and RMFCC_cat_embedding. As a specific example structure of the LSTM autoencoder network is described below with reference to FIG. 22.

Based on components of low level descriptor analyzer 2010 and utterance level descriptor analyzer 2012, a performance of each feature representation can be evaluated using a leave-one-subject-out cross validation approach with a weighted and unweighted recall, precision, and F1-score as metrics. The results for the same can be observed below in Table 3.

TABLE 3
Mean and Variance Values of Metrics for Features

| | Unweighted | | | Weighted | | |
|---|---|---|---|---|---|---|
| Metrics | | | F1- | | | F1- |
| Features | Recall | Precision | score | Recall | Precision | score |
| Jitter, Shimmer, | 31.50 | 31.50 | 31.50 | 33.47 | 34.43 | 27.60 |
| HNR, U/V ratio | (5.52) | (5.52) | (5.52) | (2.61) | (3.42) | (3.56) |
| Opensmile | 52.70 | 52.70 | 52.70 | 54.35 | 52.79 | 51.86 |
| (PC 2010) | (3.19) | (3.19) | (3.19) | (2.73) | (3.56) | (3.80) |
| MFCC | 43.40 | 43.40 | 43.40 | 40.32 | 47.46 | 37.72 |
| Autoencoder | (2.43) | (2.43) | (2.43) | (1.97) | (5.21) | (1.56) |
| LPCC | 34.20 | 34.20 | 34.20 | 36.15 | 36.83 | 29.70 |
| Autoencoder | (5.06) | (5.06) | (5.06) | (3.48) | (7.65) | (3.22) |
| RMFCC | 42.95 | 42.95 | 42.95 | 38.44 | 40.18 | 33.68 |
| Autoencoder | (5.14) | (5.14) | (5.14) | (4.54) | (12.64) | (5.86) |
| MFCC cat embed | 54.13 | 54.13 | 54.13 | 52.17 | 54.72 | 52.32 |
| | (2.63) | (2.63) | (2.63) | (2.31) | (2.71) | (2.44) |
| LPCC cat embed | 43.42 | 43.42 | 43.42 | 38.18 | 35.39 | 32.97 |
| | (5.38) | (5.38) | (5.38) | (4.18) | (5.84) | (4.44) |
| RMFCC | 51.53 | 51.53 | 51.53 | 49.09 | 51.36 | 48.25 |
| cat embed | (2.06) | (2.06) | (2.06) | (2.32) | (3.73) | (3.09) |

In the case of jitter, shimmer, HNR, probability of voicing, and opensmile features, data from one participant is left out for testing and the remaining data from 9 participants is used for training the classifier. In the case of LSTM based deep features, both the network and the classifier are only trained on 9 participants, leaving one subject out for testing. Hence, in this example, the network is trained only for 20 epochs for the LSTM Autoencoder and 50 epochs where the model with best results is captured every time. In both cases, 20 and 50 epochs were chosen based on empirical observations that the validation accuracy started to follow a decreasing trend within these epochs.

It can be observed from Table 3 that LSTM-autoencoder based features performed poorly compared to the other supervised features as would be expected. However, the LSTM-autoencoder based features can capture some and/or all information for achieving emotion recognition. In particular, MFCC and RMFCC based autoencoders performed better compared to LPCC based autoencoder. Also, similar trends have been observed to occur in supervised deep feature setting as well. Hence, it could be inferred that MFCC and RMFCC features perform better at emotion recognition task as compared to LPCC features. It can be seen that jitter, shimmer, HNR and probability of voicing combined together performed poorly in the recognition task. While each feature individually was analyzed, it can be observed that shimmer performed the best followed by probability of voicing followed by GNR and jitter when evaluated using the F1-score. In terms of unweighted F1-score, it can be observed that shimmer performed the best followed by HNG, probability of voicing, and jitter.

It can also be seen from the results in Table 3, that there is not much improvement in performance of deep features as compared to opensmile features. It could be attributed to the simplicity of models being used. It should be appreciated that more complex networks in which attention layers could be included may lead to better results. Further, combing various deep-features may result in improvements in results as opensmile includes all these features and many other LLDs.

As a brief summary, emotion recognition system 2000 can utilize a high-level feature extraction technique using LSTM techniques in both supervised and unsupervised settings. In this case, it can be observed that MFCC and RMFCC features performed better as compared to LPCC features at utterance-level features. Also, it has been observed that opensmile features performed comparable to the deep supervised features. This fact may be attributed to the simplicity of the model. However, using an attention layer and more complex networks may improve accuracy of the deep features. Since unsupervised features can solve problems that arise due to sparsity of data, other architectures may be utilized to address this problem. Further, using better unsupervised techniques such as variational autoencoders or generative adversarial autoencoders may improve results in supervised task. Further yet, combinations of features through feature fusion may improve performance. For example, as MFCC features include vocal tract information and RMFCC includes excitation source information, fusion of higher level representations of the features may result in better features.

In some embodiments, the descriptors identified by low level descriptor analyzer 2010 and utterance level descriptor analyzer 2012 are provided to a user device 2026. In some embodiments, user device 2026 is similar to and/or the same as user device 112 as described with reference to FIG. 1. Based on the descriptors and/or other information identified by emotion recognition system 2000, a user can make determinations regarding a relative emotional state of various speech recordings.

In some embodiments, the descriptors are provided to some other device or system. For example, if the speech data is related to an earnings call for a company, the descriptors can be provided to language computing system 100 for gaining additional insight regarding an overall sentiment of the earnings call which may be valuable in predicting future trends (e.g., negative sentiment may result in negative earnings revisions). As a specific example, if a CEO of a company is interpreted by emotion recognition system 2000 to have a nervous emotional speech pattern at the beginning of the earnings call, language computing system 100 may be able to utilize information associated with the nervous emotional speech pattern to determine that the earnings call may be an overall negative call. In this case, language computing system 100 may recommend to sell stock earlier in the earnings call prior to the CEO saying something that would otherwise hurt a stock price of the company. As another example, if speech source 2024 is a USB that can transcribe and store audio information for calls of a call operator (or other individual responsible for answering calls), emotion information extracted from the audio information stored on the USB may be provided by emotion recognition system 2000 to a central system for compiling emotion data related to all call operators in a call center. In this case, each call operator may have a separate USB (or other storage device) that can store call information for a particular call operator. At some point, each call operator may take their USB to a central computer/system that runs emotion recognition system 2000 such that audio information on their USB can be processed for emotion information. After being processed for emotion information, emotion recognition system 2000 may provide the emotion information for each call operator to a separate system that rates each call operator. In this case, based on the emotion information provided by emotion recognition system 2000, the separate system can identify which call operators have overall positive calls with customers and which call operators have overall negative calls with customers. This information can be useful in, for example, determining which call operators to promote, determining which call operators need training on etiquette, etc.

Referring now to FIG. 21A, a graph 2100 illustrating a number of frames versus a number of utterances is shown, according to some embodiments. In some embodiments, graph 2100 is generated by emotion recognition system 2000 as described above with reference to FIG. 20. As shown in FIG. 21A, graph 2100 is a histogram plot of an example distribution of a number of frames versus a number of utterances. In particular, graph 2100 was generated based on an example scenario with a total of 4936 utterances where 595 are “happy,” 1708 are “neutral,” 1103 are “angry,” and 1084 are “sad.”

As can be seen in graph 2100, a peak exists around 250 frames in the example scenario. In this case, an accuracy of LSTM autoencoder 2020 can be computed using 150, 200, 250, and 300 frames where training can be performed with the first 80% of the training set (i.e., the frames) and validation can be performed with the remaining 20%. In the example scenario, 200 frames can be determined to provide a slightly higher performance. Hence, all utterances in the example scenario can be truncated or padded with zeros to include 200 frames only. An LSTM autoencoder can be developed in this way for each LLD which can be referred to as MFCC_LSTM_Autoencoder, LPCC_LSTM_Autoencoder, and RMFCC_LSTM_Autoencoder. In this case, a dimension of the representations can be designed to be 256. An example diagrammatic representation of the LSTM autoencoder network is shown below with reference to FIG. 21B.

Referring now to FIG. 21B, an illustration 2150 representing an example structure of an LSTM autoencoder is shown, according to some embodiments. In some embodiments, the LSTM autoencoder represented by illustration 2150 is developed based on information indicated by graph 2100 as described with reference to FIG. 21A. As such, the LSTM autoencoder is shown to utilize a structure associated with 200 frames. The LSTM autoencoder is shown to include an autoencoder embedding. An example of autoencoder embedding is described below with reference to FIG. 22. In some embodiments, illustration 2150 represents an example structure of LSTM autoencoder 2020 as described with reference to FIG. 20.

Referring now to FIG. 22, an illustration 2200 of a structure of an LSTM categorical embedding extractor is shown, according to some embodiments. In some embodiments, the LSTM categorical embedding extractor of illustration 2200 represents an example of LSTM categorical embedding extractor 2022 as described with reference to FIG. 20. In some embodiments, illustration 2200 is associated with the example scenario of FIGS. 21A-21B. In this case, the LSTM categorical embedding extractor can be used in processing of low-level descriptors, similar to the LSTM autoencoder representation framework where 200 frames are chosen to represent each utterance as described in FIGS. 21A-21B.

The structure of the network of illustration 2200 is shown to include two-stacked LSTMs with 512 and 256 hidden units respectively, followed by a fully connected layer to a hidden layer of 256 nodes with a ReLU activation function. The layer with 256 nodes can be considered as a representation layer and can in turn be connected to an output layer with a softmax activation including 4 nodes. A network can trained for each LLD and can be referred to as MFCC_cat_embedding, LPCC_cat_embedding, and RMFCC_cat_embedding.

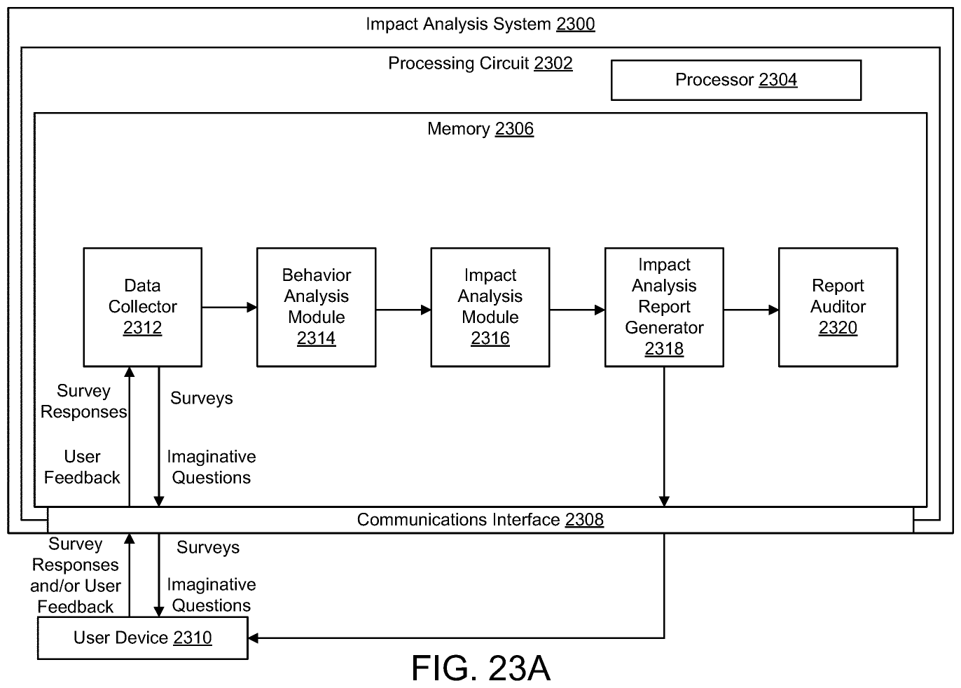

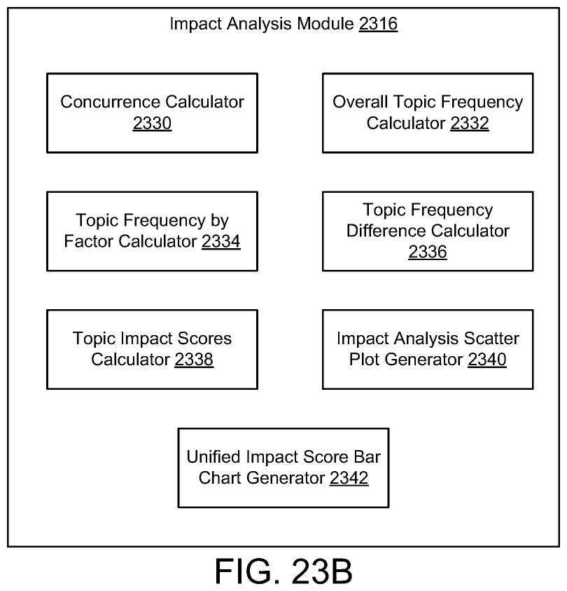

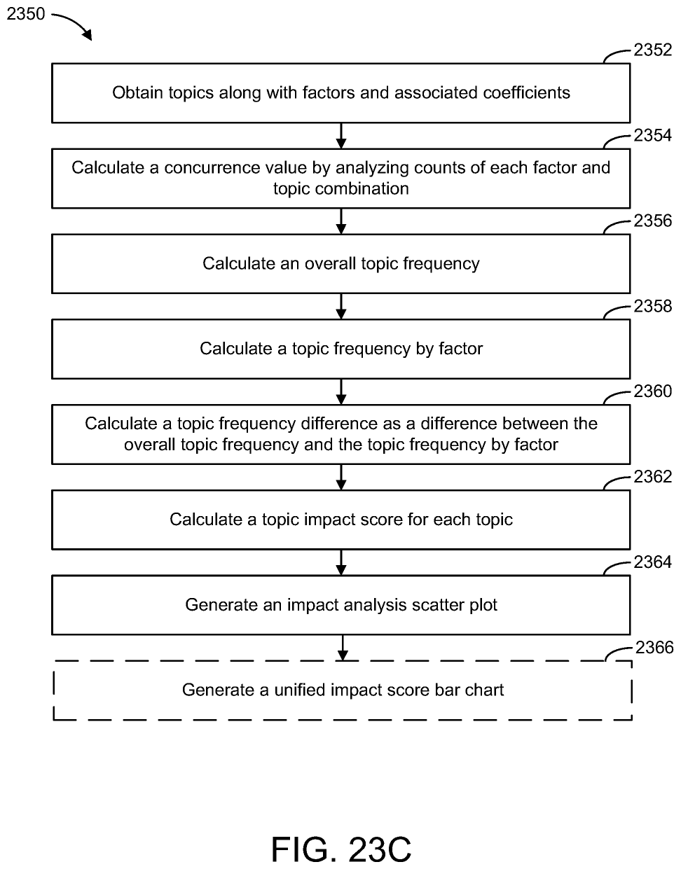

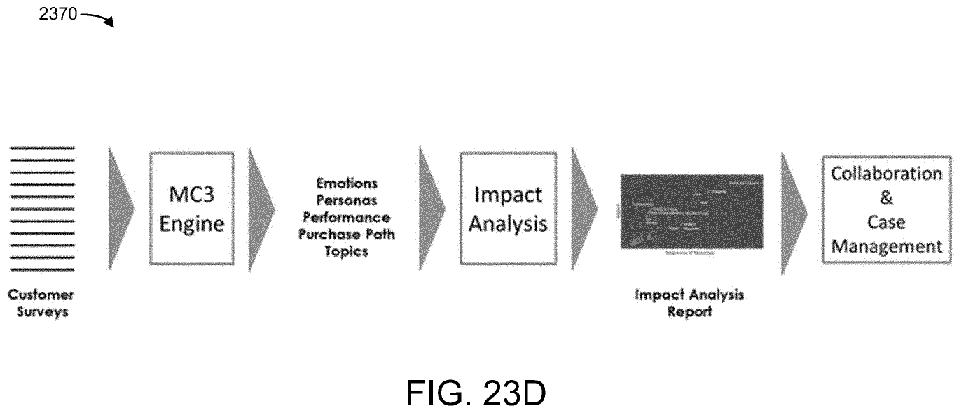

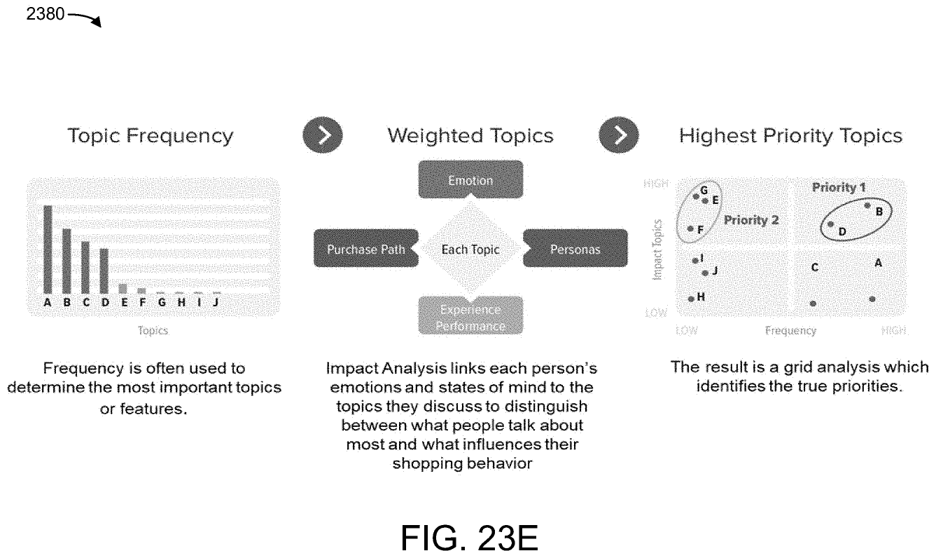

Referring now to FIG. 23A, a block diagram of an impact analysis system 2300 for identifying an impact of topics on customer behavior changes is shown, according to some embodiments. Specifically, impact analysis system 2300 can identify the impact of topics on an overall positive and negative customer behavior change. Impact analysis system 2300 can quantify the impact, also referred to herein as an impact score, for additional analysis. In some embodiments, the impact score is combined with a frequency of topic mentions (i.e., topic frequency) in a two-by-two graphical matrix to identify topics that may include, but are not limited to, high impact-high volume, high impact-low volume, low impact-high volume, and low impact-low volume. Based on analysis, reports such as a negativity impact analysis report and a positivity impact analysis report can be generated.

In some embodiments, impact analysis system 2300 provides a graphically rich and easy to understand summary of topics mentioned in survey responses to differentiate what people talk about versus what motivates and inspires customer behavior change. These features can allow users (e.g., executive, managers, etc.) to easily identify topics for improvement and to prioritize investments. In some embodiments, impact analysis system 2300 performances auditing, compliance, governance, and/or other management analytics on the identified impacts to ensure quality of information provided to users.

In some embodiments, impact analysis system 2300 is a component of language computing system 100 and/or is utilized in tandem with impact analysis system 2300. For example, language computing system 100 may utilize an impact analysis generated by impact analysis system 2300 to determine possible historical and/or future trends. As a more specific example, language computing system 100 may utilize request impact analysis system 2300 to generate an impact analysis regarding a Company A for use in determining whether to buy and/or sell stock in Company A.

Impact analysis system 2300 is shown to include a communications interface 2308 and a processing circuit 2302. In some embodiments, communications interface 2308 and processing circuit 2302 are similar to and/or the same as communications interface 108 and processing circuit 102 as described with reference to FIG. 1, respectively. Communications interface 2308 may include wired or wireless interfaces (e.g., jacks, antennas, transmitters, receivers, transceivers, wire terminals, etc.) for conducting data communications with various systems, devices, or networks. For example, communications interface 2308 may include an Ethernet card and port for sending and receiving data via an Ethernet-based communications network and/or a Wi-Fi transceiver for communicating via a wireless communications network. Communications interface 2308 may be configured to communicate via local area networks or wide area networks (e.g., the Internet, a building WAN, etc.) and may use a variety of communications protocols (e.g., BACnet, IP, LON, etc.). Communications interface 2308 may be a network interface configured to facilitate electronic data communications between impact analysis system 2300 and various external systems or devices (e.g., user device 112).

Processing circuit 2302 is shown to include a processor 2304 and memory 2306. Processor 2304 may be a general purpose or specific purpose processor, an application specific integrated circuit (ASIC), one or more field programmable gate arrays (FPGAs), a group of processing components, or other suitable processing components. Processor 2304 may be configured to execute computer code or instructions stored in memory 2306 or received from other computer readable media (e.g., CDROM, network storage, a remote server, etc.).

Memory 2306 may include one or more devices (e.g., memory units, memory devices, storage devices, etc.) for storing data and/or computer code for completing and/or facilitating the various processes described in the present disclosure. Memory 2306 may include random access memory (RAM), read-only memory (ROM), hard drive storage, temporary storage, non-volatile memory, flash memory, optical memory, or any other suitable memory for storing software objects and/or computer instructions. Memory 2306 may include database components, object code components, script components, or any other type of information structure for supporting the various activities and information structures described in the present disclosure. Memory 2306 may be communicably connected to processor 2304 via processing circuit 2302 and may include computer code for executing (e.g., by processor 2304) one or more processes described herein. In some embodiments, one or more components of memory 2306 are part of a singular component. However, each component of memory 2306 is shown independently for ease of explanation.

Memory 2306 is shown to include a data collector 2312. Data collector 2312 can be configured to obtain input data (or other information) for use in performing an impact analysis. The input can data include any data that can be used to determine an impact of topics on customer behavior changes. As such, the data obtained by data collector 2312 can be highly configurable and customizable depending on what information is desired for extraction. In some embodiments, the input data is received from a user device 2310. In some embodiments, user device 2310 is similar to and/or the same as user device 112 as described with reference to FIG. 1. For example, user device 2310 may allow the user to view graphs, provide feedback on predicted patterns, etc. User device 2310 may include any wearable or non-wearable device. Wearable devices can refer to any type of device that an individual wears including, but not limited to, a watch (e.g., a smart watch), glasses (e.g., smart glasses), bracelet (e.g., a smart bracelet), etc. User device 2310 may also include any type of mobile device including, but not limited to, a phone (e.g., smart phone), a tablet, a personal digital assistant, etc. In some embodiments, user device 2310 includes other computing devices such as a desktop computer, a laptop computer, etc.

In some embodiments, the input data includes survey responses and/or user feedback. A survey response can be completed by a user based on a survey provided to user device 2310. The surveys can be generated to capture user sentiments towards particular topics of interest. In some embodiments, the surveys include one or more imaginative questions. An imaginative question (IQ) can be designed to engage a user (e.g., a customer) and elicit the user's true voice and emotion. Imaginative questions can help get people in a state that allows them to verbalize their emotions, as well as cognitive states, attitudes, and belief systems. If an IQ is one of only a small number of questions (e.g., 2 questions, 3 questions, etc.) in a survey, users may be incentivized to respond more thoughtfully due to a less daunting survey as compared to a survey with a large amount of questions (e.g., 50+ questions, 100+ questions, etc.).

As an example, a survey may request a user to respond to the following IQ: “Our fast-paced lives can make it difficult to devote all the time necessary to manage our financial future. Please take some time to tell us what aspects of your financial planning and future keep you up and night, how it makes you feel, and why. Please be as descriptive as possible.” As should be appreciated, the example IQ can hone in on the user's true emotions and feelings regarding their financial future as compared to a more simplistic question such as “are you worried about your financial future?” In essence, IQs can be designed to capture answers to multiple traditional survey questions and can reveal more accurate and richer insights into user behavior.

In some embodiments, data collector 2312 is configured to generate IQs and/or surveys. In some embodiments, the IQs and/or surveys are stored in a database of data collector 2312 and can be accessed by data collector 2312 to provide to user device 2310. The IQs and/or surveys may be stored in the database by a user, may be generated and saved by data collector 2312 automatically, etc. If data collector 2312 automatically generates and saves the IQs and/or surveys, data collector 2312 may utilize a model, algorithm, and/or other process for determining what IQs/surveys are appropriate for gathering the most from particular users. For example, data collector 2312 may implement a neural network that learns what words/phrases/sentences in an IQ result in users responding in the greatest detail appropriate for impact analysis. In this case, the neural network may be trained, for example, by associating certain words/phrases/sentences that result a greatest number of words or characters in responses from user. In this way, the neural network can learn what IQs to generate and provide to users that result in more meaningful responses from the users.

In some embodiments, data collector 2312 may obtain other user feedback from user device 2310. User feedback can include any type of information that can indicate what motivates and inspires customer behavior change. For example, user feedback may include information such as online reviews posted by users, news articles about interest towards a product, etc. In some embodiments, user feedback is obtained from a device/system other than user device 2310. For example, user feedback may be obtained via a web scraper, from a cloud computing system, or any other appropriate source of user feedback.

In some embodiments, data collector 2312 generates a record for each survey response. A record generated by data collector 2312 may include, for example, appended text from one respondent included in one field that can be provided to a behavior analysis module 2314. In this way, a complete context of the respondent can be captured in the record at one time. In some embodiments, multiple records from the same respondent can be generated by data collector 2312. Data collector 2312 may generate multiple records from the same respondent if, for example, the respondent completes multiple surveys/reviews from various sources, the respondent completes multiple surveys/reviews at different times, the respondent completes surveys/reviews for multiple purchases, etc. In some embodiments, data collector 2312 provides the surveys and/or user feedback to behavior analysis module 2314 such that behavior analysis module 2314 generates the records.

Memory 2306 is also shown to include behavior analysis module 2314. Each record provided to (or generated by) behavior analysis module 2314 may include variables indicating various information regarding what motivates and inspires customer behavior change. Each of the variables may be set/determined by behavior analysis module 2314. As such, behavior analysis module 2314 may include functionality for parsing through text and extracting information regarding what motivates and inspires customer behavior change from the text. In this way, behavior analysis module 2314 may include text recognition functionality for analyzing text.

The variables included in records can include various information applicable for identifying what motivates and inspires customer behavior change. The variables may include binary variables, variables represented by strings of characters, ratings, etc. For example, binary variables of the records may include binary variables for emotions (e.g., anger, confusion, crave, disappointment, excitement, frustration, gratitude, happiness), personas (e.g., advocate, deal hunter, detractor, green buyer, hater, lover), performance (e.g., above all others, amaze, attitude behavior shift, needs met, needs unmet, recommend highly, recommend negative, recommend positive, trust negative, trust positive, value negative, value positive), purchase path (e.g., churn probable, client acquisition, purchase intent negative, purchase intent positive), and N topics that are determined by a machine learning classification algorithm implemented by data collector 2312 and/or behavior analysis module 2314. In some embodiments, topics are tagged as positive, neutral, or negative. For a negativity impact analysis described in detail below, negative and neutral topics may be included whereas for a positivity impact analysis, positive and neutral topics may be included.

In some embodiments, behavior analysis module 2314 analyzes the information provided by data collector 2312 for other information useful in the impact analysis. For example, behavior analysis module 2314 may calculate/determine information for the impact analysis such as a primary emotion (e.g., a name of a primary emotion or unclassified), a primary emotion confidence (e.g., high/medium/low), a valence direction (e.g., positive/neutral/negative), a valence confidence (e.g., high/medium/low), a standard intensity (e.g., narrative or personal), etc.

Information identified by behavior analysis module 2314 can be provided to an impact analysis module 2316. Impact analysis module 2316 can perform an impact analysis to determine/identify what motivates and inspires customer behavior change. In some embodiments, to perform the impact analysis, impact analysis module 2316 includes a Bayesian belief network (BBN) that quantifies an influence of factors on customer behavior change. In some embodiments, impact analysis module 2316 utilizes other models for quantifying the influence of factors on customer behavior change. In some embodiments, a model utilized by impact analysis module 2316 is selected such that a solid behavior outcome variable (e.g., churn, decreased, purchase amount, decreased purchase frequency, etc.) can be used for modeling for the impact analysis. Specifically, the model may be selected (e.g., by impact analysis module 2316 or a user) to allow for quantification of an impact of factors on a behavioral outcome (as described in detail below).

Each factor considered by impact analysis module 2316 may have an associated weight (coefficient) that can be used to calculate an overall impact score. Impact analysis module 2316 may define negative factors and positive factors that contribute to a customer's negative and positive behavior change, respectively. For example, negative factors and coefficients may include negative sentiment (0.115385 or 11.5%), negative recommend (0.153846 or 15.4%), negative purchase intent (0.192308 or 19.2%), anger (0.192308 or 19.2%), confusion (0.076923 or 7.7%), disappointment (0.115385 or 11.5%), and frustration (0.153846 or 15.4%). Positive factors and coefficients may include, for example, positive sentiment (0.115385 or 11.5%), positive recommend (0.153846 or 15.4%), positive purchase intent (0.192308 or 19.2%), excitement (0.192308 or 19.2%), happiness (0.076923 or 7.7%), crave (0.115385 or 11.5%), and (0.153846 or 15.4%). The above examples of negative factors and coefficients and positive factors and coefficients include the same number of factors/coefficients which may or may not be a requirement set by impact analysis module 2316 for performing the impact analysis. The coefficients can indicate what percentage each factor contributes to the impact score. For example, anger may contribute 19%, frustration may contribute 15%, etc., to a customer's negative behavior change. Likewise, positive recommend may contribute 15%, happiness may contribute 8%, etc. to a customer's positive behavior change. In some embodiments, the coefficients are used in calculating topic impact scores as described in detail below.

Impact analysis module 2316 can perform various steps to in the impact analysis. Specifically, the impact analysis performed by impact analysis module 2316 may include six high-level steps and one optional step. In some embodiments, the steps include calculating a concurrence, calculating an overall topic frequency, calculating a topic frequency by factor, calculating a topic frequency difference, calculating topic impact scores, generating an impact analysis scatter plot, and optionally generating a unified impact score bar chart. In various embodiments, generating the unified impact score bar chart is performed in place of generating the impact analysis scatter plot, in addition to generating the impact analysis scatter plot, or may not be performed. Each of the steps can be repeated once for negativity and once for positivity. For negativity, negative and neutral topics as well as positive factors can be used. For positivity, positive and neutral topics as well as negative factors can be used. The above steps as well as components of impact analysis module 2316 are shown in greater detail below with reference to FIG. 23B. Likewise, the steps of the impact analysis are further illustrated in process 2350 as described with reference to FIG. 23C.

Based on the impact analysis, positive and negative topics that lead to positive and negative customer behavior change can be identified. In some embodiments, the coefficients of the Bayesian belief network are the crux of the impact analysis. Advantageously, the impact analysis includes flexibility in terms of deliverables with regard to the negativity and positivity scatter plots. Further, the optional unified impact score chart can be used to help prioritize the topics.

Based on the impact analysis performed by impact analysis module 2316, an impact analysis report generator 2318 can generate an impact analysis report to provide to user device 2310 and/or a report auditor 2320. In some embodiments, impact analysis report generator 2318 generates both a negativity impact analysis report (e.g., including the negativity scatter plot) and a positivity impact analysis report (e.g., including the positivity scatter plot). In some embodiments, the positivity and negativity analysis reports are included in a single analysis report. The analysis reports can provide meaningful insight to a user regarding differences between what people talk about versus what motivates and inspires customer behavior change. As described about, the analysis reports can allow users such as executives or managers to easily identify topics for improvement, how to prioritize investments, etc.

In some embodiments, the analysis reports are provided to report auditor 2320. Report auditor 2320 can perform various auditing, compliance, and governance procedures to determine if generated analysis reports are appropriate. For example, report auditor 2320 may review analysis reports to identify inaccuracies or other issues with the analysis reports. In this case, report auditor 2320 may search for outlier variables/results that are not in line with other components of the analysis report. In some embodiments, report auditor 2320 may analyze the analysis reports to ensure the reports are not in violation of predefined rules/laws that restrict what information or types of information can be provided to users. For example, report auditor 2320 may restrict what information is provided to user device 2310 to ensure controversial/obscure results are not provided to users that may otherwise result in lost confidence in accuracy of future analysis reports. In some embodiments, impact analysis report generator 2318 provides analysis reports to report auditor 2320 prior to providing the analysis reports to user device 2310. In this case, impact analysis report generator 2318 may provide the analysis reports to user device 2310 responsive to a notification from report auditor 2320 that the analysis reports are safe or otherwise appropriate to provide to users.

Referring now to FIG. 23B, a block diagram of impact analysis module 2316 of FIG. 23A in greater detail is shown, according to some embodiments. Components of impact analysis module 2316 can be configured to perform various steps of an impact analysis process. Impact analysis module 2316 may include fewer, additional, and/or different components as shown. As such, components of impact analysis module 2316 can be configured based on what steps are included in the impact analysis process.

Impact analysis module 2316 is shown to include a concurrence calculator 2330. Concurrence calculator 2330 can calculate a concurrence by analyzing counts of each factor and topic combination. For example, concurrence calculator 2330 can calculate a count of people that have negative sentiment and mentioned topic A. In some embodiments, negative sentiment, negative recommend, and negative purchase intent are derived by behavior analysis module 2314 as described with reference to FIG. 23A. In some embodiments, a 1-to-1 relationship between a topic and an emotion exists. The relationship may occur if, for example, subject matter experts indicate a topic and a specific emotion are linked. If processing the data, topic and emotion can be mapped.

As an example of information calculated by concurrence calculator 2330, Table 4 is provided below.

TABLE 4
Concurrence Table

| | Neg | Neg | Neg | Neg | Neg | Neg | |
|---|---|---|---|---|---|---|---|
| | Topic | Topic | Topic | Topic | Topic | Topic | |
| | A | B | C | D | E | F | Total |
| Negative | 142 | 155 | 88 | 65 | 168 | 15 | 633 |
| Sentiment | | | | | | | |
| Negative | 122 | 123 | 69 | 59 | 99 | 8 | 480 |
| Recommend | | | | | | | |
| Negative | 98 | 49 | 59 | 37 | 60 | 12 | 315 |
| Purchase Intent | | | | | | | |
| Anger | 58 | 200 | 35 | 82 | 7 | 4 | 386 |
| Confusion | 37 | 59 | 100 | 5 | 53 | 21 | 275 |
| Disappointment | 150 | 90 | 54 | 95 | 24 | 15 | 428 |
| Frustration | 19 | 35 | 49 | 71 | 175 | 17 | 366 |
| Topic | 150 | 200 | 100 | 125 | 175 | 50 | |
| Frequency | | | | | | | |
| (Unique | | | | | | | |
| Responders) | | | | | | | |

In the example associated with Table 4, Topic A and Disappointment are linked. As such, Table 4 illustrates that 150 individuals mentioned Topic A and all 150 individuals are shown to be flagged with Disappointment. In other words, in this example, any time a customer mentions Topic A, they are disappointed. In this example, Topic B and Anger are linked, as are Topic C and Confusion, and Topic E and Frustration. Topics D and E are not linked to a specific emotion, but some emotions may be present for a Topic. For example, 95 people who mentioned Topic D expressed disappointment in their comments. It should be noted that concurrence calculator 2330 may identify any factors that have a small number of observations to avoid skewing of results in the impact analysis process. In some embodiments, concurrence calculator 2330 may require a minimum number of observations (e.g., 200 observations, 25 times the number of topics, etc.). For example, if only 4 respondents are flagged with Negative Purchase Intent and 3 mentioned Topic A and 1 mentioned Topic B, the Topic Frequency would be 75% and 25% respectively. If the overall mentions of Topic A is 30%, the difference would be 45% (75%−30%=45%) and this may skew the Impact Score for Topic A.

Impact analysis module 2316 is shown to include an overall topic frequency calculator 2332. Overall topic frequency calculator 2332 can calculate a frequency of each topic and a percentage of overall topic mentions. A topic frequency can refer to a number of unique respondents that mention a topic. In this case, a respondent may only be counted once even if the respondent mentions a topic multiple times. A topic frequency percentage can be calculated by overall topic frequency calculator 2332 as a percentage of all topic mentions.

As an example of information determined by overall topic frequency calculator 2332, Table 5 is given below.

TABLE 5
Overall Topic Frequency

| | Neg | Neg | Neg | Neg | Neg | Neg | |
|---|---|---|---|---|---|---|---|
| | Topic A | Topic B | Topic C | Topic D | Topic E | Topic F | Total |
| Topic | 150 | 200 | 100 | 125 | 175 | 50 | 800 |
| Frequency | | | | | | | |
| Topic | 19% | 25% | 13% | 16% | 22% | 6% | 100% |
| Frequency | | | | | | | |
| Percentage | | | | | | | |

As shown in the example associated with Table 5, 200 respondents mentioned Topic B. As topic B had 200 mentions, a topic frequency percentage for Topic B is 25% (i.e., 200/800).

Still referring to FIG. 23B, impact analysis module 2316 is shown to include a topic frequency by factor calculator 2334. In some embodiments, topic frequency by factor calculator 2334 is similar to overall topic frequency calculator 2332. Topic frequency by factor calculator 2334 can calculate the frequency of each topic by factor. In this case, topic frequency is the number of unique respondents that mention a topic. A respondent may only be counted once even if they mention a topic multiple times. In more technical terms, this calculation is a row percentage. Adding up all the percentages across a row should result in 100%. In an example below shown in Table 6, 52% of respondents that expressed Anger mentioned Topic B and 1% of respondents that expressed Anger mentioned Topic F.

TABLE 6
Topic Frequency by Factor Table

| | Neg | Neg | Neg | Neg | Neg | Neg | |
|---|---|---|---|---|---|---|---|
| | Topic | Topic | Topic | Topic | Topic | Topic | |
| | A | B | C | D | E | F | Total |
| Negative | 22% | 24% | 14% | 10% | 27% | 2% | 100% |
| Sentiment | | | | | | | |
| Negative | 25% | 26% | 14% | 12% | 21% | 2% | 100% |
| Recommend | | | | | | | |
| Negative | 31% | 16% | 19% | 12% | 19% | 4% | 100% |
| Purchase Intent | | | | | | | |
| Anger | 15% | 52% | 9% | 21% | 2% | 1% | 100% |
| Confusion | 13% | 21% | 36% | 2% | 19% | 8% | 100% |
| Disappointment | 35% | 21% | 13% | 22% | 6% | 4% | 100% |
| Frustration | 5% | 10% | 13% | 19% | 48% | 5% | 100% |

Impact analysis module 2316 is shown to include a topic frequency difference calculator 2336. Topic frequency difference calculator 2336 can calculate a difference between an overall topic frequency and a topic frequency by factor. This difference can show the topics that occur more frequently (or less frequently) for certain factors. In some embodiments, positive differences may indicate that a topic occurs more frequently compared to overall. Conversely, negative numbers may indicate a topic occurs less frequently compared to overall. In an example below given in Table 7, Topic B is mentioned 52% of the time a respondent expressed Anger, but only 25% overall, thereby resulting in a difference of 27%. In some embodiments, if a topic has no mentions for a factor, no difference is calculated as the difference would be 0%.

TABLE 7
Topic Frequency Difference Calculation

| | Neg | Neg | Neg | Neg | Neg | Neg |
|---|---|---|---|---|---|---|
| | Topic | Topic | Topic | Topic | Topic | Topic |
| | A | B | C | D | E | F |
| Anger | 15% | 52% | 9% | 21% | 2% | 1% |
| Topic | 19% | 25% | 13% | 16% | 22% | 6% |
| Frequency | | | | | | |
| Percentage | | | | | | |
| Difference | −4% | 27% | −3% | 6% | −20% | −5% |

Topic frequency difference calculator 2336 may repeat the calculation for each factor. An example illustrated below in Table 8 can show differences calculated for each factor. It should be noted in the below example that the topics that are linked to a factor have a high positive difference which makes intuitive sense as all respondents have the topic present for a specific factor.

TABLE 8
Topic Frequency Difference for All Factors

| | Neg | Neg | Neg | Neg | Neg | Neg |
|---|---|---|---|---|---|---|
| | Topic | Topic | Topic | Topic | Topic | Topic |
| | A | B | C | D | E | F |
| Negative | 4% | −1% | 1% | −5% | 5% | −4% |
| Sentiment | | | | | | |
| Negative | 7% | 1% | 2% | −3% | −1% | −5% |
| Recommend | | | | | | |
| Negative | 12% | −9% | 6% | −4% | −3% | −2% |
| Purchase Intent | | | | | | |
| Anger | −4% | 27% | −3% | 6% | −20% | −5% |
| Confusion | −5% | −4% | 24% | −14% | −3% | 1% |
| Disappointment | 16% | −4% | 0% | 7% | −16% | −3% |
| Frustration | −14% | −15% | 1% | 4% | 26% | −2% |

Impact analysis module 2316 is shown to include a topic impact scores calculator 2338. Topic impact scores calculator 2338 can calculate an impact score for each topic. In some embodiments, the coefficients described above can be utilized by topic impact scores calculator 2338. These coefficients can be multiplied by the differences calculated by topic frequency difference calculator 2336 to get an overall weighted average sum. Sums for each topic can be re-scaled into a final impact score. It should be noted that re-scaling the number may always result in one topic having an impact score of zero. In some embodiments, topic impact scores calculator 2338 cosmetically adjusts the score to a small positive (or negative) number for clarity purposes.

An example of information calculated by topic impact scores calculator 2338 is shown below in Tables 9-11. It should be appreciated that calculations of a weighted averages for a topic can be repeated for each topic. Further, the re-scaling of numbers can be performed by adding an inverse of the most negative number and multiplying by 100, according to some embodiments. In the example below detailed in Tables 9-11, 3.08% is added to each number and then each number is multiplied by 100.

TABLE 9
Calculating Weighted Average for a Topic

| | Neg | | | | Weighted |
|---|---|---|---|---|---|
| | Topic A | | Coefficient | | Avg. |
| Negative | 4% | | 11.5% | | 0.42% |
| Sentiment | | | | | |
| Negative | 7% | | 15.4% | | 1.03% |
| Recommend | | | | | |
| Negative | 12% | | 19.2% | | 2.38% |
| Purchase Intent | | | | | |
| Anger | −4% | X | 19.2% | = | −0.72% |
| Confusion | −5% | | 7.7% | | −0.41% |
| Disappointment | 16% | | 11.5% | | 1.88% |
| Frustration | −14% | | 15.4% | | −2.09% |
| | | | | Sum | 2.50% |

TABLE 10
Weighted Average Results for All Topics

| | Neg | Neg | Neg | Neg | Neg | Neg |
|---|---|---|---|---|---|---|
| | Topic | Topic | Topic | Topic | Topic | Topic |
| | A | B | C | D | E | F |
| Sum | 2.50% | 0.27% | 2.97% | −0.52% | −2.14% | −3.08% |

TABLE 11
Final Impact Score for All Topics

| | Neg | Neg | Neg | Neg | Neg | Neg |
|---|---|---|---|---|---|---|
| | Topic | Topic | Topic | Topic | Topic | Topic |
| | A | B | C | D | E | F |
| Impact | 5.58 | 3.35 | 6.06 | 2.56 | 0.94 | 0.00 |
| Score | | | | | | |

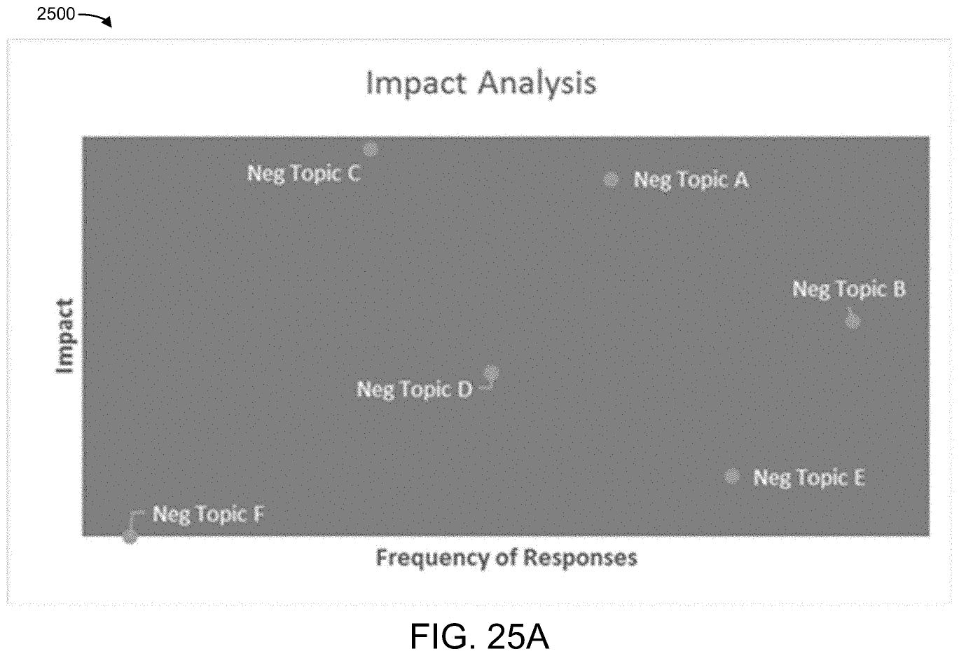

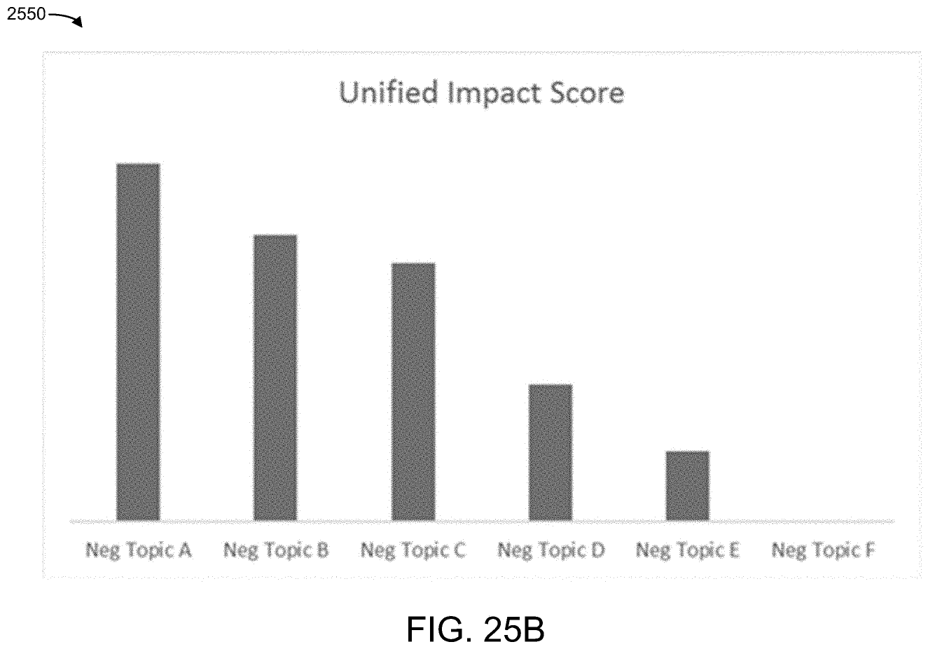

Impact analysis module 2316 is shown to include an impact analysis scatter plot generator 2340. Impact analysis scatter plot generator 2340 may generate an impact analysis scatter plot. In some embodiments, the impact analysis scatter plot is generated based on the topic frequency percentage calculated by overall topic frequency calculator 2332 and the impact scores calculated by topic impact scores calculator 2338. In this case, the X-axis of the scatter plot may be the topic frequency percentage whereas the Y-axis may be the impact scores. An example of a scatter plot generated by impact analysis scatter plot generator 2340 is described below with reference to FIG. 25A.

Still referring to FIG. 23B, impact analysis module 2316 is shown to include a unified impact score bar chart generator 2342. Unified impact score bar chart generator 2342 can generate a unified impact score bar chart. In some embodiments, the unified impact score bar chart is used in addition to, or in place of, the impact analysis scatter plot generated by impact analysis scatter plot generator 2340. In some embodiments, unified impact score bar chart generator 2342 is an optional component of impact analysis module 2316. In other words, the unified impact score bar chart may or may not be generated.

The unified impact score bar chart can be used to rank an order of topics from highest to lowest importance. A unified impact score indicated by the unified impact score bar chart can be calculated by multiplying the topic frequency score and impact score together. An example of a unified impact score bar chart is described below with reference to FIG. 25B.

Referring now to FIG. 23C, a flow diagram of a process 2350 for performing an impact analysis is shown, according to some embodiments. In some embodiments, process 2350 is performed by impact analysis module 2316 as described with reference to FIGS. 23A-23B.

Process 2350 is shown to include obtaining topics along with factors and associated coefficients (step 2352). In some embodiments, step 2352 is performed by impact analysis module 2316.

Process 2350 is shown to include calculating a concurrence value by analyzing counts of each factor and topic combination (step 2354). In some embodiments, step 2354 is performed by concurrence calculator 2330. Specifically, step 2354 can calculate a concurrence value by comparing counts of each factor and topic combination based on the topics and factors obtained in step 2352.

Process 2350 is shown to include calculating an overall topic frequency (step 2356). Step 2356 may include calculating a frequency of each topic and a percentage of overall topic mentions. In this case, a topic frequency is a number of unique respondents that mention a topic. In some embodiments, step 2356 is performed by overall topic frequency calculator 2332.

Process 2350 is shown to include calculating a topic frequency by factor (step 2358). In some embodiments, step 2358 is similar to step 2356. In the case of step 2358, a frequency is calculated for each topic by factor as obtained in step 2352. In some embodiments, step 2358 is performed by topic frequency by factor calculator 2334.

Process 2350 is shown to include calculating a topic frequency difference as a difference between the overall topic frequency and the topic frequency by factor (step 2360). Step 2360 can show the topics that occur more frequently (or less frequently) for certain factors. Positive numbers may indicate a topic occurs more frequently, compared to overall. Negative numbers may indicate a topic occurs less frequently, compared to overall. In some embodiments, step 2360 is performed by topic frequency difference calculator 2336.

Process 2350 is shown to include calculating a topic impact score for each topic (step 2362). In step 2362, the coefficients obtained in step 2352 can be utilized. Specifically, step 2362 may include multiplying the coefficients by the differences calculated in step 2360 to calculate an overall weighted average sum. In some embodiments, step 2362 includes re-scaling the sums for each topic into a final impact score. In some embodiments, step 2362 is performed by topic impact scores calculator 2338.

Process 2350 is shown to include generating an impact analysis scatter plot (step 2364). The impact analysis scatter plot is a graphical representation of the impact scores that can indicate an association between a frequency of responses and an impact of a topic. An example of the impact analysis scatter plot is described in detail below with reference to FIG. 25A. In some embodiments, step 2364 includes providing the impact analysis scatter plot to a user (e.g., via a user device). In some embodiments, step 2364 is performed by impact analysis scatter plot generator 2340.

Process 2350 is shown to include generating a unified impact score bar chart (step 2366). The unified impact score bar chart may be another type of graphical representation of the impact scores that can be provided to a user. Step 2366 is shown as an optional step in process 2350 as the unified impact score bar chart may or may not be utilized depending on what information is desired to be provided to a user. In some embodiments, the unified impact score bar chart is used in addition to, or in place of, the impact analysis scatter plot generated in step 2364. In some embodiments, step 2366 includes providing the unified impact score bar chart to a user (e.g., via a user device). In some embodiments, step 2366 is performed by unified impact score bar chart generator 2342.

In some embodiments, process 2350 is performed twice, once for negativity and once for positivity. For negativity, negative and neutral topics may be included and positive factors can be used. For positivity, positive and neutral topics may be included and negative factors can be used.

Referring now to FIG. 23D, a flow diagram of a process 2370 for performing an impact analysis is shown, according to some embodiments. In some embodiments, process 2370 illustrates steps that can be performed by impact analysis system 2300 as described with reference to FIG. 23A.

In process 2370, customer surveys can be obtained and provided to an MC3 engine. In some embodiments, the MC3 engine is equivalent to behavior analysis module 2314 of impact analysis system 2300. The MC3 engine can determine values of variables such as emotions, personas, performance, purchase path, topics, etc., that can be provided for use in an impact analysis. Based on results of the impact analysis, an impact analysis report can be generated. The impact analysis report can be used, for example, in collaboration and case management. Collaboration and case management may include tools for performing auditing, compliance, governance, and/or other functionality based on the impact analysis report.

Referring now to FIG. 23E, an illustration 2380 representing a flow of information in an impact analysis is shown, according to some embodiments. Illustration 2380 can provide insight into how impact analysis system 2300 as described with reference to FIG. 23A utilizes and generates information. In particular, in illustration 2380, a topic frequency is shown to be provided/identified. The topic frequency, as described, can be used to determine, for example, the most important topics or features in textual data. Based on the topic frequency, various variables (e.g., emotion, purchase path, experience performance, personas, etc.) can be defined. The impact analysis can link each person's emotions and states of mind to the topics they discuss in order to distinguish between what people talk about most and what influences their behavior (e.g., shopping behavior). Of course, shopping behavior is shown in illustration 2380 as an example; the impact analysis can be performed to determine user behavior in other settings. Based on the analysis process, the highest priority topics can be identified and plotted in a grid. In effect, a result of performing the impact analysis can include a grid analysis that identifies the true priorities of users.

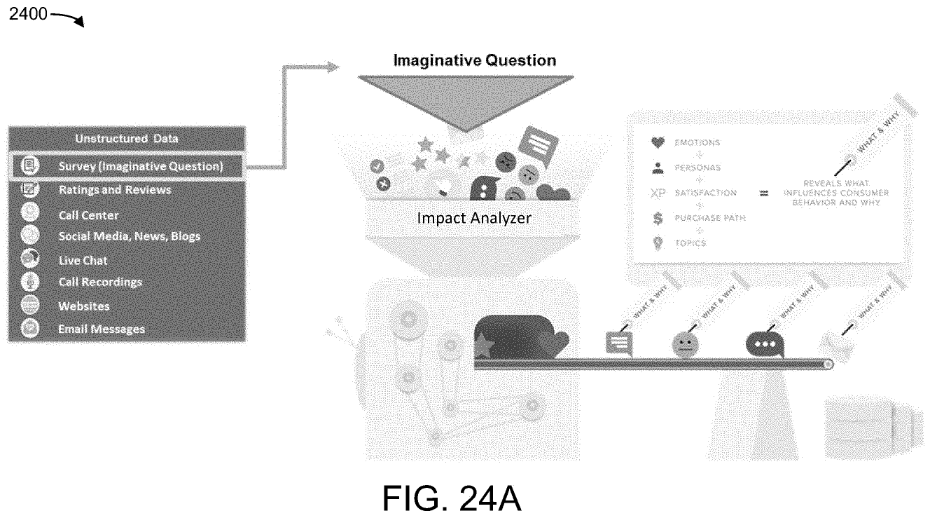

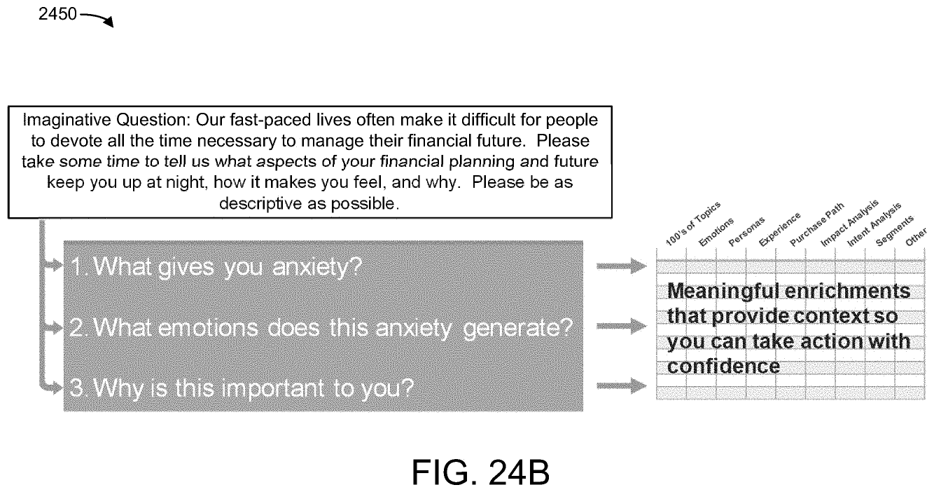

Referring now to FIG. 24A, an illustration 2400 of usage of an imaginative question is shown, according to some embodiments. Illustration 2400 can illustrate how an imaginative question can extract useful information from a user. In this case, unstructured data can be provided to an impact analyzer (e.g., impact analysis system 2300). In particular, integration of the imaginative question in a survey can result in obtaining valuable survey responses that indicate what motivates behaviors and why. Specifically, information such as emotions, personas, satisfaction, purchase path, and topics can be extracted from the unstructured data by the impact analyzer to determine what influences user (e.g., consumer) behavior and why.

Referring now to FIG. 24B, an illustration 2450 of information that can be extracted from an example imaginative question is shown, according to some embodiments. Illustration 2450 provides an example imaginative question that elicits a user to provide detailed information about how they view their financial future. Specifically, the imaginative question of illustration 2450 is, “Our fast-paced lives often make it difficult for people to devote all the time necessary to manage their financial future. Please take some time to tell us what aspects of your financial planning and future keep you up at night, how it makes you feel, and why. Please be as descriptive as possible.” Within this single question, multiple “hidden” question can be addressed such as what gives the user anxiety, what emotions the anxiety generates, why it is important to the user, etc. In this sense, multiple questions can be addressed within the framework of a single imaginative question.

Referring now to FIG. 25A, a graph 2500 illustrating an impact score scatter plot is shown, according to some embodiments. Graph 2500 is shown purely for sake of example of an impact score scatter plot that can be generated and is not intended to be limiting. In some embodiments, graph 2500 is generated by impact analysis system 2300 as described with reference to FIG. 23A. In graph 2500, the X-axis is shown as a topic frequency percentage that can be calculated by overall topic frequency calculator 2332. The Y-axis is an impact score that can be calculated by topic impact scores calculator 2338. The axes are scaled so that excess space around the perimeter of the plot area is eliminated. Further, axis labels are removed and points are labeled with a topic name. Further yet, graph 2500 is shown to be divided into 4 equal quadrants. In this example, graph 2500 can be generated based on the following data set shown below in Table 12 which is a combination of data included in Tables 5 and 11.

TABLE 12
Impact Analysis Values

| | Neg | Neg | Neg | Neg | Neg | Neg |
|---|---|---|---|---|---|---|
| | Topic | Topic | Topic | Topic | Topic | Topic |
| | A | B | C | D | E | F |
| Topic | 19% | 25% | 13% | 16% | 22% | 6% |
| Frequency | | | | | | |
| Percentage | | | | | | |
| Impact | 5.58 | 3.35 | 6.06 | 2.56 | 0.94 | 0.00 |
| Score | | | | | | |

Referring now to FIG. 25B, a graph 2550 illustrating a unified impact score bar chart is shown, according to some embodiments. Graph 2550 is shown purely for sake of example of a unified impact score bar chart that can be generated and is not intended to be limiting. Graph 2550 can be generated by unified impact score bar chart generator 2342 as described with reference to FIG. 23B. It should be noted that no gridlines or axis values are provided as the values may have no real meaning.

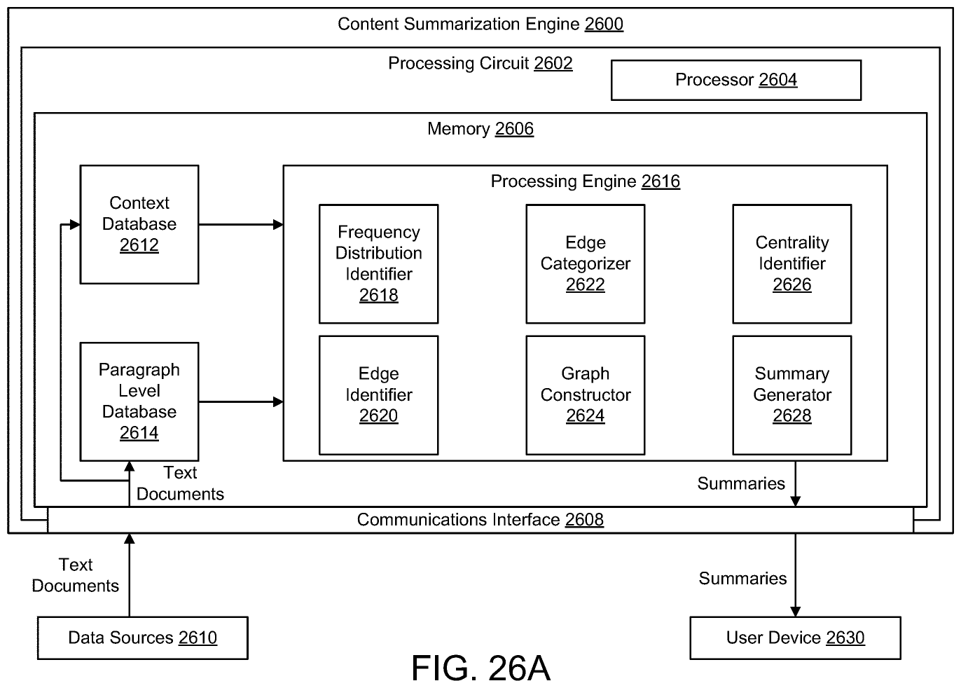

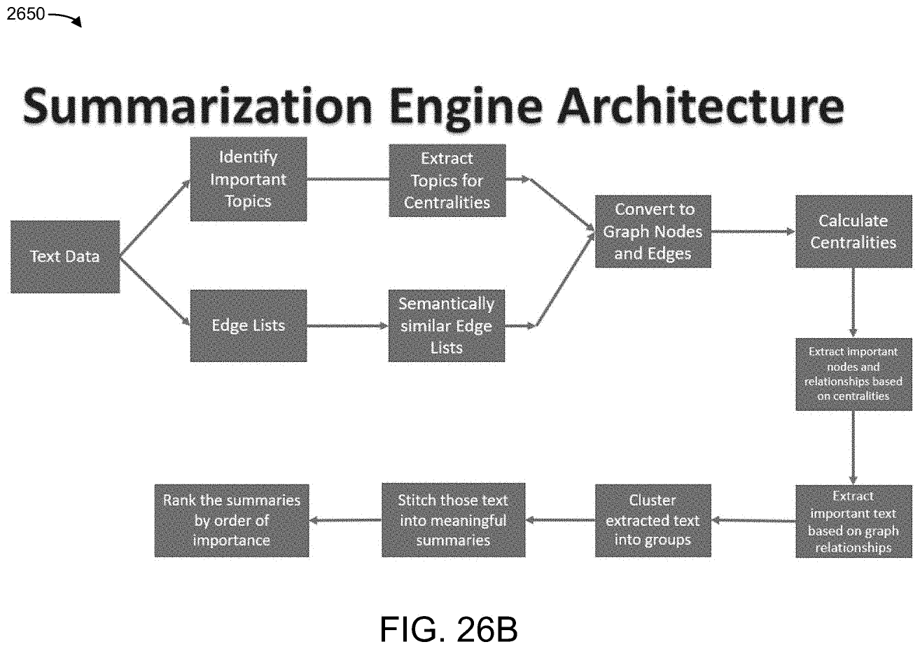

Referring now to FIG. 26A, a block diagram of a content summarization engine 2600 is shown, according to some embodiments. Content summarization engine 2600 can take a set of text documents and product a single summary of content included in the documents. Content summarization engine 2600 can effectively find relationships among text from multiple documents. Content summarization can refer to a process that produces a concise and fluent summary of text while preserving important content and meaning. In some embodiments, content summarization engine 2600 compiles various received text into a single summary that includes important information of the text in their respective context. Content summarization engine 2600 may utilize artificial intelligence models that can effectively stitch various important text from multiple documents into meaningful summaries for a reader. Content summarization engine 2600 may also include one or more text correction models that automatically corrects any spelling and/or grammatical mistakes in the final summaries to improve readability of summaries for an end user. Further, content summarization engine 2600 may have the capability to group summaries into meaningful classes for the comfort of an end user.

In some embodiments, content summarization engine 2600 can perform extractive summarization and abstractive summarization. Extractive summarization can refer to identifying important sections of text and generating them verbatim, thereby producing a subset of the sentences from the original text. Abstractive summarization can refer to reproduction of important material in a new way after interpretation and examination of the text to generate a shorter text that conveys the most critical information from the original text. In some embodiments, content summarization engine 2600 uses advanced natural language techniques to perform abstractive summarization.

In some embodiments, extractive summarization can be further decomposed into corpus summarization and document summarization. Corpus summarization can address information across several, presumably related documents. Document summarization can examine content within a specific text.

Based on the extracted/abstracted topics (nodes), content summarization engine 2600 can determine/identify related nodes (e.g., by edges). Content summarization engine 2600 can employ analysis techniques to determine which topics and relationships are significant. Content summarization engine 2600 can examine original text documents provided to content summarization engine 2600 for a content of the topics and relationships. Along the way, content summarization engine 2600 may filter duplicates and low value data.

In some embodiments, content summarization engine 2600 is heavily parallelized. Advantageously, this may allow content summarization engine 2600 to be able to handle very large big data even in a single machine. Content summarization engine 2600 may be built on top of a stable load balancer (e.g., Nginx) and an HTTP server (e.g., Gunicorn) in combination with a virtualization system (e.g., Docker) to help run content summarization engine 2600 in a distributed fashion.

Content summarization engine 2600 is shown to include a communications interface 2608 and a processing circuit 2602. In some embodiments, communications interface 2608 and processing circuit 2602 are similar to and/or the same as communications interface 108 and processing circuit 102 as described with reference to FIG. 1, respectively. Communications interface 2608 may include wired or wireless interfaces (e.g., jacks, antennas, transmitters, receivers, transceivers, wire terminals, etc.) for conducting data communications with various systems, devices, or networks. For example, communications interface 2608 may include an Ethernet card and port for sending and receiving data via an Ethernet-based communications network and/or a Wi-Fi transceiver for communicating via a wireless communications network. Communications interface 2608 may be configured to communicate via local area networks or wide area networks (e.g., the Internet, a building WAN, etc.) and may use a variety of communications protocols (e.g., BACnet, IP, LON, etc.). Communications interface 2608 may be a network interface configured to facilitate electronic data communications between content summarization engine 2600 and various external systems or devices (e.g., data sources 2610).

Processing circuit 2602 is shown to include a processor 2604 and memory 2606. Processor 2604 may be a general purpose or specific purpose processor, an application specific integrated circuit (ASIC), one or more field programmable gate arrays (FPGAs), a group of processing components, or other suitable processing components. Processor 2604 may be configured to execute computer code or instructions stored in memory 2606 or received from other computer readable media (e.g., CDROM, network storage, a remote server, etc.).

Memory 2606 may include one or more devices (e.g., memory units, memory devices, storage devices, etc.) for storing data and/or computer code for completing and/or facilitating the various processes described in the present disclosure. Memory 2606 may include random access memory (RAM), read-only memory (ROM), hard drive storage, temporary storage, non-volatile memory, flash memory, optical memory, or any other suitable memory for storing software objects and/or computer instructions. Memory 2606 may include database components, object code components, script components, or any other type of information structure for supporting the various activities and information structures described in the present disclosure. Memory 2606 may be communicably connected to processor 2604 via processing circuit 2602 and may include computer code for executing (e.g., by processor 2604) one or more processes described herein. In some embodiments, one or more components of memory 2606 are part of a singular component. However, each component of memory 2606 is shown independently for ease of explanation.

Memory 2606 is shown to include a context database 2612 and a paragraph level database 2614. Both context database 2612 and a paragraph level database 2614 are shown to receive text documents (or other forms of information) from data sources 2610. Data sources 2610 can include one or more data sources that can provide text documents to content summarization engine 2600. For example, data sources 2610 may include NewsApi, DowJones, 10K filings to the U.S. Securities and Exchange Commission (SEC), 8K filings to the SEC, and/or other document sources as required by the corpus. Data sources 2610 can serve as a filter to the dataset in that they may exclude information such as marketing, PR, opinion, and/or other noise. In some embodiments, context database 2612 and/or paragraph level database 2614 selectively store information to exclude unnecessary information.

In some embodiments, context database 2612 stores abstracted information. Abstracted information can include broad topics such as headlines, quotes, highlighted material, etc. In some embodiments, paragraph level database 2614 stores extracted information. In this case, each paragraph (or other length of text such as a page) can be isolated and deconstructed into sentences, phrases, and eventually n-grams that can be stored as extracted information in paragraph level database 2614. N-grams in text can be defined as a set of co-occurring words in a text corpus. N-grams can reveal powerful information by calculating frequencies of occurrence removing. N-grams are described in greater detail with reference to U.S. Provisional Patent Application No. 62/887,609 filed Aug. 15, 2019, the entirety of which is incorporated by reference herein.

Context database 2612 and paragraph level database 2614 can provide abstracted information and extracted information to a processing engine 2616, respectively. Processing engine 2616 can include various components for performing a summarization process. Specifically, processing engine 2616 can include components for processing the information provided by context database 2612 and paragraph level database 2614. In some embodiments, processing engine 2616 includes a frequency distribution identifier 2618, an edge identifier 2620, an edge categorizer 2622, a graph constructor 2624, a centrality identifier 2626, and a summary generator 2628.

Frequency distribution identifier 2618 can be configured to determine a frequency of occurrence of words, phrases, and sentence fragments. Frequency distribution identifier 2618 can read in data in chunks and validate each chunk to remove empty and non-textual data. For example, frequency distribution identifier 2618 may strip the text of spaces, Unicode characters, HTML/Twitter tags, and/or other insignificant strings. As should be appreciated, frequency distribution identifier 2618 may apply various data cleaning operations.

Frequency distribution identifier 2618 can tokenize and parse the surviving text into N-grams. The N-grams can be cleaned by frequency distribution identifier 2618 to remove punctuation, stop words and digits at the beginning and end of phrases, etc. Frequency distribution identifier 2618 may apply other N-gram processing operations such as checking word length, term length, etc.

In some embodiments, frequency distribution identifier 2618 places N-grams and their value counts in a hash map. If frequency distribution identifier 2618 places the N-grams and their value counts in the hash map, frequency distribution identifier 2618 may apply a map reduce algorithm to the hash table to merge duplicate N-grams. The map reduce algorithm can be ran in parallel to reduce processing time. An output of the map reduce algorithm may be a dictionary of unique N-grams and value counts.

Frequency distribution identifier 2618 can calculate frequency distributions by comparing the dictionary of N-grams to a set of tags provided to content summarization engine 2600. Phrase counts and frequency distributions can be merged and reduced to create a combined set of unique grams. Frequency distribution identifier 2618 may calculate a frequency mean of each gram, with a mean greater than 0.5 indicating a gram of very high quality. High quality grams can be compared by frequency distribution identifier 2618 for similarity and merged to reduce the set of interesting concepts (e.g., to improve processing performance). In some embodiments, the set is further filtered by frequency percentile. In this case, a latent indexing technique may be used to calculate influence scores between the high quality and merged result set.

In some embodiments, frequency distribution identifier 2618 applies a sentiment analysis to the resulting set. A lexical dictionary can be created to house vocabularies and sentiment terms (e.g., phrases that include modifiers, negations, or positives). Sentiment scores can be created and applied to the dictionary by frequency distribution identifier 2618.

Still referring to FIG. 26A, edge identifier 2620 can determine edges between discovered concepts. In some embodiments, edge identifier 2620 specifically utilizes input from paragraph level database 2614. Similar to frequency distribution identifier 2618, edge identifier 2620 can clean the text data by removing Twitter tags, HTML tags, etc. Utilizing combined phrase and parts of speech (POS) identified by frequency distribution identifier 2618, edge identifier 2620 can extract meaningful edge topics. In this case, an edge can define a connection, and possibly a relationship, between two nodes. A node may be an identified topic extracted or abstracted from the corpus of text provided for analysis.

Edge identifier 2620 can also check whether the edge topics for each text in the corpus are close and/or match to the already extracted sentiment top phrases. In some embodiments, edge identifier 2620 calculates edge permutation combinations and/or edge permutation combination scores from the remaining edge topics.

Based on the edge list permutations, edge categorizer 2622 can sort the edge list permutations and provide one or more sorted edge lists based on the values. The sorted edge lists sets can be converted into dictionaries. In some embodiments, edge categorizer 2622 identifies similar edges and removes non-similar edge. In other words, edge categorizer 2622 may categorize similar and dissimilar edges. Edges can be compared to one another similar to and/or the same as N-grams are compared as described above. Specifically, edge categorizer 2622 may determine similarity of edges based on processes such as, contextual embeddings, vector scoring, cosine similarity, similarity edge calculations, etc. Further, edge categorizer 2622 can discard non-similar edges from the edge dictionary. Based on the various processing performed by edge identifier 2620 and edge categorizer 2622, edge identifier 2620 can output scored and sorted edge list permutations with non-similar edges removed.

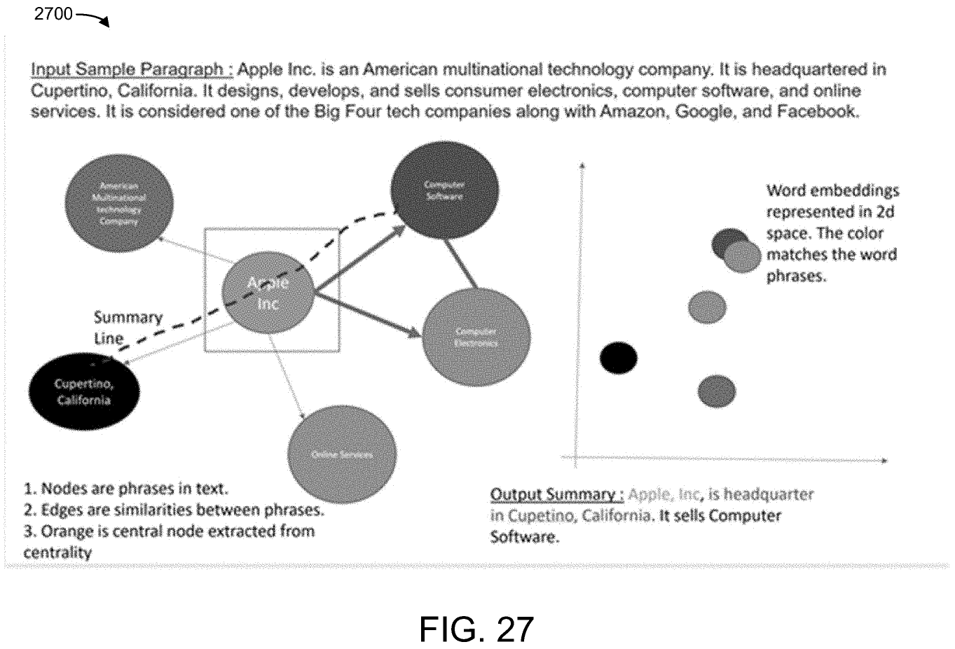

Graph constructor 2624 can generate/construct a graph illustrating the nodes and edges described above. In some embodiments, graph constructor 2624 specifically generates a domain graph. For example, graph constructor 2624 may generate a graph that indicates that the topic “Apple Computer” is strongly connected to the topic “Computer Software” and the topic “Computer Hardware,” whereas “Apple Computer” is weakly connected to the topic “Cupertino, Calif.” An example graph generated by graph constructor 2624 is described below with reference to FIG. 27.

Graph constructor 2624 can load the lexical dictionary into the graph such that each topic becomes a node. Likewise, graph constructor 2624 can load the edge dictionary into the graph such that each connection becomes an edge. Graph constructor 2624 can rearrange nodes and edges such that adjacent nodes are placed in proximity. Adjacency can be determined by values in the connecting edges. Rearrangement of nodes and edges can improve traversal time of the graph, thereby reducing computational complexity in graph traversal.

Graph constructor 2624 can add/remove nodes and edges from the graph as new text is process. In this way, the graph can be dynamically updated to account for new information.

In some embodiments, graph constructor 2624 examines some and/or all nodes of the graph for adjacency. In other words, graph constructor 2624 can examine each node to determine which nodes are connected and what is a value of the connection. Closely/highly connected nodes can be identified as neighbors. At any time, each node of the graph may include its data and an adjacency object that identifies its closely related neighbors. As the graph grows in size and complexity, node adjacency can allow for rapid transversal and sub-graphing. Specifically, graph constructor 2624 may identify sub-graphs and connectedness scores to help get influence scores of each node. In effect, an output of graph constructor 2624 can include a populated graph with nodes, relevant edges, and identified neighbors. The output may also include the identified sub-graphs based on neighbors and connectedness scores.

Processing engine 2616 is also shown to include centrality identifier 2626. The graph generated by graph constructor 2624 can be viewed as a combination of smaller, more specific, sub-graphs. Centrality identifier 2626 can identify the sub-graphs by computing centrality. To calculate centrality, centrality identifier 2626 may perform steps including calculating a single source shortest path (e.g., by applying a breadth first search methodology to calculate a single source shortest path) calculating a Dijkstra path for nodes and edges with weights, rescaling the nodes and edges by normalizing weights, and calculating an edge “between-ness” centrality. The edge between-ness can allow centrality identifier 2626 to extract related topics and/or identify central parts of the graph. The importance of the graph and text corpus may be higher in the central parts of the graph. In some embodiments, centrality identifier 2626 removes edges which have centrality scores equal to 0.0 and sorts edges based on their centrality scores.

Centrality identifier 2626 can also extract topics. Topics can be defined as sub-graphs with high edge between-ness scores (i.e., topic centrality). To extract topics, centrality identifier 2626 may calculate a degree for all nodes in the sorted centralities. In this case, if a length of edges and a length of sorted centralities are greater than 1, the centralities can be extracted. Based on the extracted centralities clusters, centrality identifier 2626 can calculate sentiment scores from the sentiment top phrases. If present in sentiment top scores, centrality identifier 2626 may leave the centrality nodes as is. Otherwise, centrality identifier 2626 may remove the sentiment top scores from the centrality nodes.

Based on operations performed by centrality identifier 2626, centrality identifier 2626 may output topics extracted based on centrality in the graph generated by graph constructor 2624.

Still referring to FIG. 26A, processing engine 2616 is shown to include summary generator 2628. Summary generator 2628 can extract and organize a summary. Based on the key topics identified and ordered by importance (i.e., centrality), context database 2612 and paragraph level database 2614 can be inspected for content related to the key topics. Starting with the cleaned source text, summary generator 2628 can extract content related to each topic. To extract raw summaries, summary generator 2628 can extract edge lists of the rows in the text data where it is not empty. Likewise, summary generator 2628 can extract raw text where the edge list is not empty. Based on the raw text, sentences (or other measures of text) can be extracted where it matches the centrality cluster of nodes and includes the topic centralities. In this way, the extracted sentences may belong to the top centrality cluster of nodes.

In some embodiments, summary generator 2628 cleans the raw summaries. For example, summary generator 2628 may remove the text of Unicode, Twitter tags, HTML tags, etc., from the raw summaries and/or perform other data cleaning operations from the raw summaries. In this way, summary generator 2628 can generate initial summaries.

Based on the initial summaries, summary generator 2628 can merge/combine and rank summaries. Content can be combined into similar topics, which can be determined by the adjacency of the topic node. Summary generator 2628 can also remove duplicate summary sentences. The remaining set of topics can be converted to vectors and measured by cosine similarity. Summary generator 2628 can define a threshold value for clustering. For example, summary generator 2628 may require a minimum threshold value of 0.8 for clustering.

Based on the combined summaries, summary generator 2628 can rank the summaries. Summary generator 2628 can apply an algorithm (e.g., PageRank algorithm) for the summary groups of vectors and can rank the summary vectors in each group. Summary generator 2628 can then convert the summary group of vectors back to summary sentences and can clean the summary cluster groups. In effect, summary generator 2628 can generate unique summary cluster groups.

In some embodiments, summary generator 2628 further extracts linguistic structures and obtains topic linguistic phrases based on the summary cluster groups. In particular, summary generator 2628 can extract phrases belonging to, for example, nouns, verbs, and adjectives. From the summary sentences, an extraction algorithm (e.g., the rapid automatic keyword extraction (RAKE) algorithm) can be applied to extract the keyword phrases. Keywords that follow the linguistic pattern and are similar to the linguistic phrases can also be extracted. The extracted keywords that follow the linguistic pattern and the phrases extracted from nouns, verbs, and adjectives (or others) can be combined by summary generator 2628. Using the extraction algorithm (e.g., RAKE algorithm) and latent indexing techniques, summary generator 2628 can calculate influence scores for the linguistic structures. Based on the influence scores, summary generator 2628 can identify all the linguistic phrases with the top scores. Specifically, summary generator 2628 can find a phrase with a max score and provide the phrase as a topic. Finally, summary generator 2628 can apply an aspect level sentiment identification to obtain better influence in the experimentation phase for later information. As a result of the processing, summary generator 2628 can generate topic phrases.

Overall, summary generator 2628 can generate one or more summaries for a user. In some embodiments, summary generator 2628 employs one or more machine learning models to cluster and stich the important text into meaningful summaries. Further, summary generator 2628 can rank the summaries based on an order of importance. A single summary can include text important in a particular context. In some embodiments, summary generator 2628 applies text correction to the summaries to automatically correct spelling and grammatical mistakes in the final summaries. As should be appreciated, summary generator 2628 can apply any various techniques to provide clean and understandable summaries for users.

In some embodiments, the summaries generated by summary generator 2628 are provided to a user device 2630. In some embodiments, user device 2630 is similar to and/or the same as user device 2310 as described with reference to FIG. 23A. In this way, a user can be provided with a concise summary(s) describing relationships among text in documents.

Referring now to FIG. 26B, a diagram 2650 of a summarization engine architecture is shown, according to some embodiments. Specifically, diagram 2650 can illustrate some and/or all of the functionality of content summarization engine 2600 as described with reference to FIG. 26A.

Referring now to FIG. 27, an illustration 2700 of an example domain graph is shown, according to some embodiments. In some embodiments, the domain graph shown in illustration 2700 is generated by summary generator 2628 as described with reference to FIG. 26A. In this case, an input sample paragraph is shown in illustration 2700 that can be provided to content summarization engine 2600. Based on the input paragraph, content summarization engine 2600 can define nodes as phrases in the text, edges as similarities between phrases, and can also define a central node extracted from centrality. Based on information determined/identified by content summarization engine 2600, content summarization engine 2600 can generate an output summary as shown. It should be appreciated that the output summary includes important information from the input sample paragraph, but is concise and easily for user interaction. Illustration 2700 is also shown to include a two-dimensional representing of word embeddings. The two-dimensional graph can illustrate a closeness of phrases. In this example, “computer software” may be very similar to “computer electronics.” However, “Cupertino Calif.” may not be as similar to “computer software,” “computer electronics,” or “online services.”

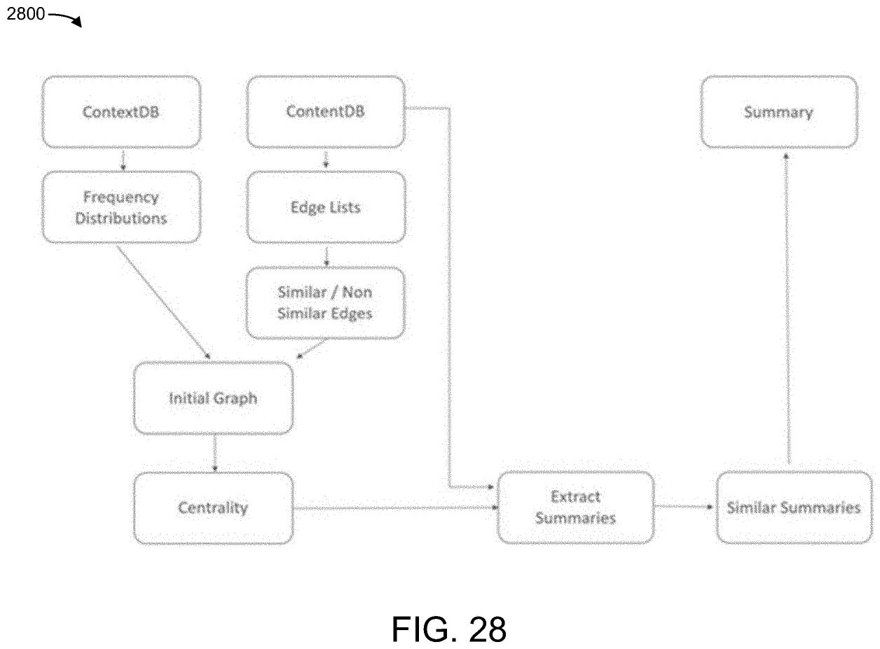

Referring now to FIG. 28, a flow diagram of a process 2800 for generating a content summarization is shown, according to some embodiments. In some embodiments, process 2800 is performed by content summarization engine 2600 as described with reference to FIG. 26A.

Process 2800 is shown to include a context database providing information to determine frequency distributions. Likewise, a content database is shown to provide information for identifying edge lists. Based on the edge lists, similar and non-similar edges can be identified.

Process 2800 is also shown to include generating an initial graph using the frequency distributions and the similar/non-similar edges. A centrality value(s) can be extracted from the initial graph. Based on the centrality value(s) and the information stored in the content database, initial summaries can be extracted. Process 2800 can further include identifying and combining similar summaries to generate one or more unique and meaningful summaries for an end user.

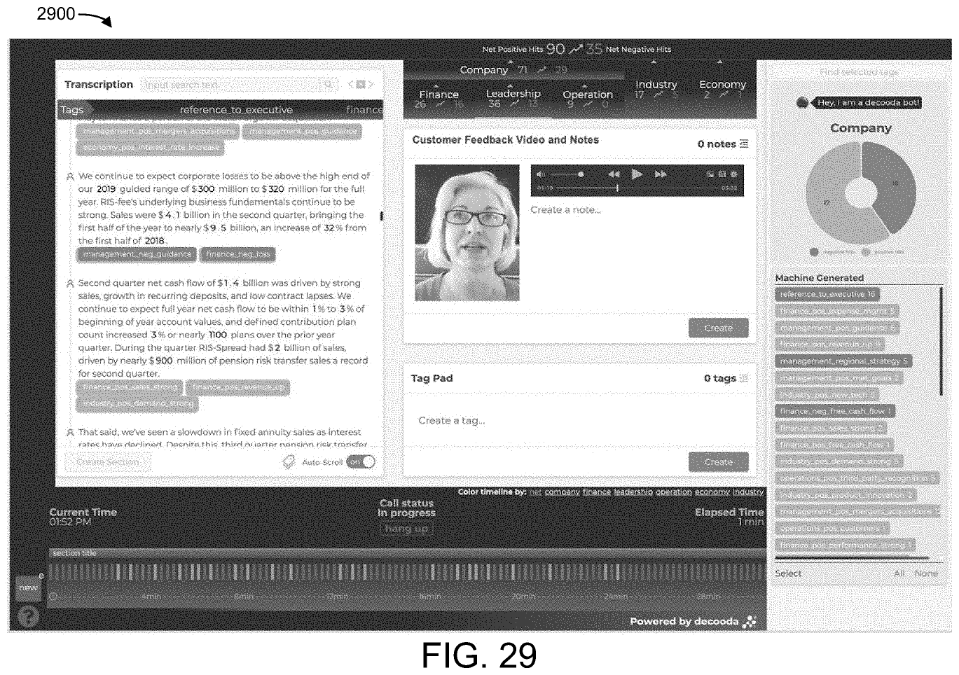

Referring now to FIG. 29, a graphical illustration 2900 of a user interface that can be provided to a user device is shown, according to some embodiments. In some embodiments, graphical illustration 2900 is generated by language computing system 100 as described with reference to FIG. 1, impact analysis system 2300 as described with reference to FIG. 23A, and/or another system described in the FIGURES. Graphical illustration 2900 can illustrate information that can be provided to a user. Specifically, graphical illustration 2900 can indicate key words and phrases detected in an audio recording (which may also include a video recording). In some embodiments, the key words and phrases are indicated by green and red markers at timestamps at which the words/phrases are detected in the audio recording. In this case, the green markers can indicate words/phrases associated with a positive sentiment whereas the red markers may indicate words/phrases associated with a negative sentiment. Advantageously, graphical illustration 2900 can provide a straightforward and comprehensive view for a user regarding an overall sentiment in a particular audio recording or textual document analyzed via various systems and methods described herein.

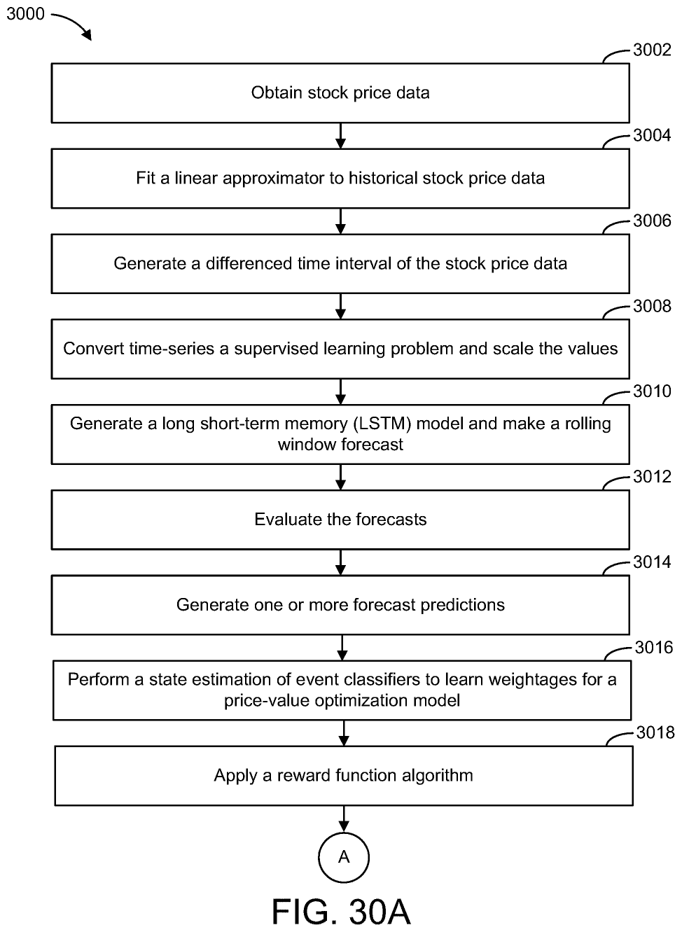

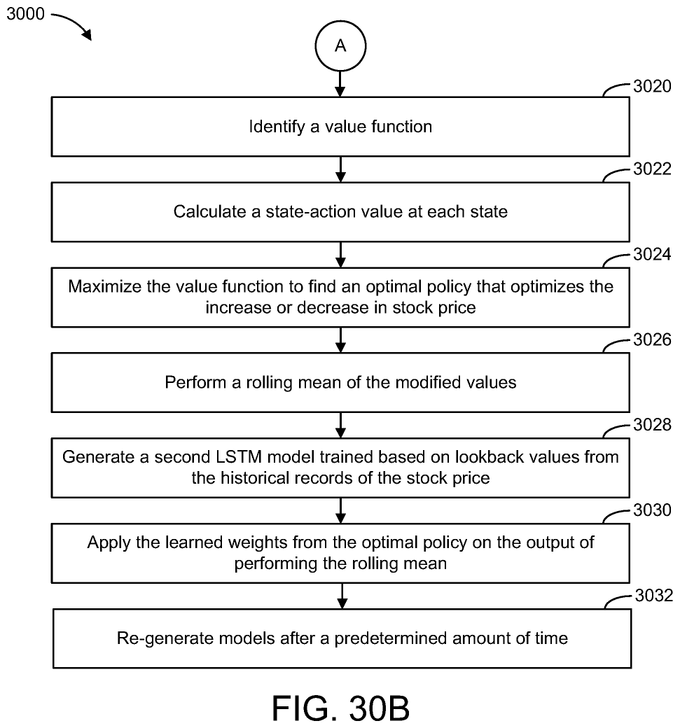

Referring now to FIGS. 30A and 30B, a flow diagram of a process 3000 for utilizing a price-value optimization model is shown, according to some embodiments. Process 3000 is shown and described with regard to stock prices. However, process 3000 may be utilized in optimizing predictions in other settings. For example, a similar process to process 3000 may be utilized to optimize predictions of a cost of products over time.

As described in detail below, process 3000 can utilize a price-value optimization model. The price-value optimization model can optimize predicted stock prices to reduce an error rate. Textual events and factors that operate over continuous action spaces can be utilized such that modification of the predicted stock prices can occur such that the error rate is reduced. In the case of stock prices, the error rate may be defined as a difference between predicted stock prices and actual stock prices for a time period. Advantageously, the price-value optimization model can identify sudden changes in trends in order to reduce the error rate. To identify the sudden changes in trends, the price-value optimization model may utilize textual factors. In some embodiments, the price-value optimization model optimizes price values to increase a reward.

In some embodiments, a multi-variate regression model is used instead of the price-value optimization model. However, the multi-variate regression model may result in a higher error rate as compared to the price-value optimization model as the multi-variate regression model may inevitably end up mixing already predicted probabilities of future events with the error from predictions of future stock price. In this case, the error rate may nonetheless be high even if regularizations and the like are performed.

Process 3000 can be performed by various systems throughout the FIGURES. In particular, some and/or all steps of process 3000 may be performed by language computing system 100, and more specifically by hypothesis engine 120 as described with reference to FIGS. 1 and 2. By utilizing the price-value optimization model, hypothesis engine 120 can refine predicted future stock prices to reduce the error rate. In this way, a user can be provided with more accurate stock price predictions to base decisions on.

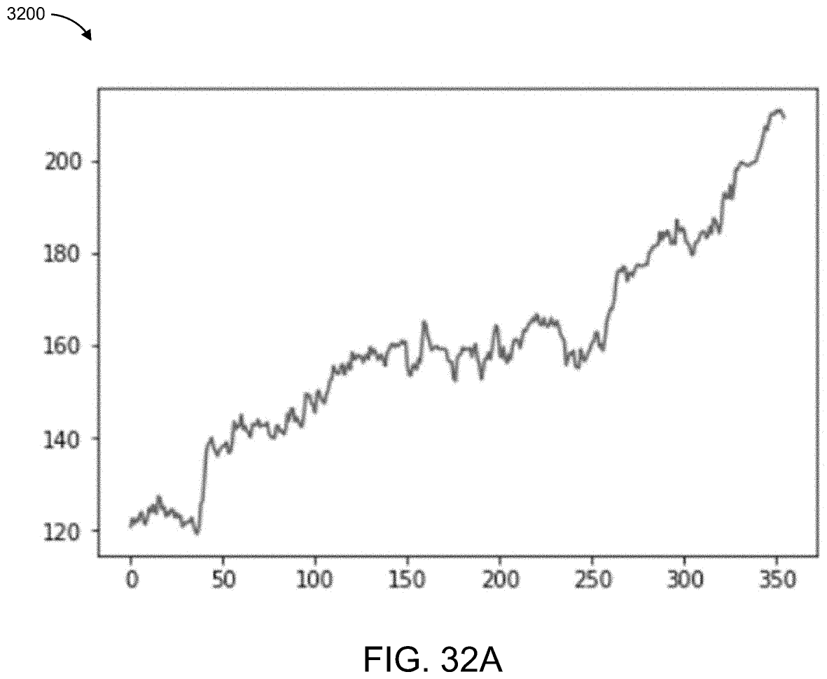

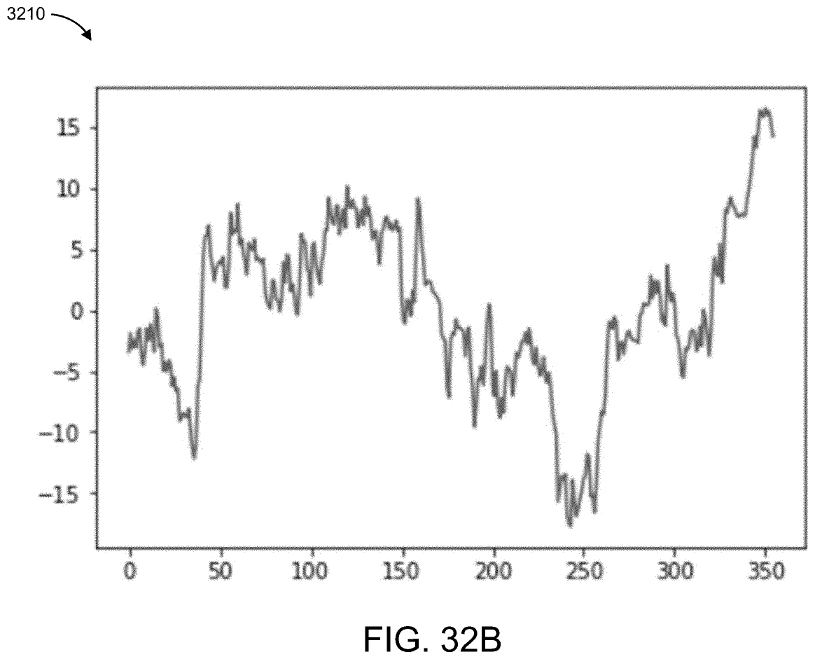

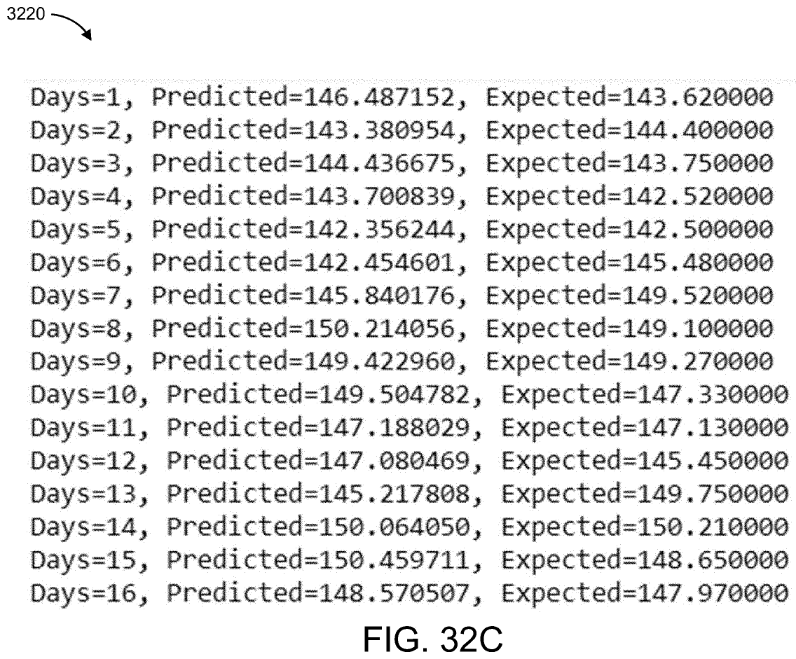

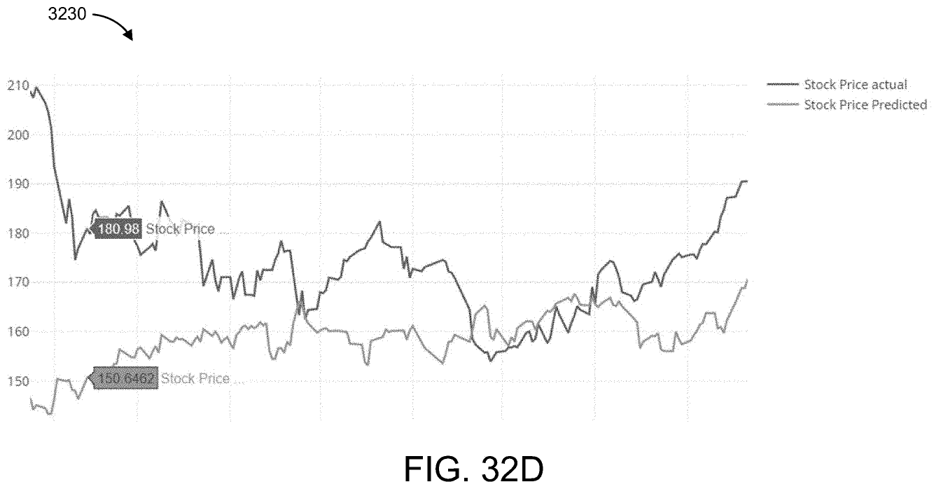

Process 3000 is shown to include obtaining stock price data (step 3002). The stock price data obtained in step 3002 may include historical stock price data and/or predicted stock price data. The stock price data can be obtained from various sources such as, for example, directly via manual entry from a user, from data published by a stock exchange, from news sites that report stock prices, and/or any other appropriate source of stock price data. An example of stock price data that can be loaded and used in process 3000 is described below with reference to FIG. 32A.

Process 3000 is shown to include fitting a linear approximator to historical stock price data (step 3004). The linear approximator can help reduce and/or eliminate bias caused due to trends in time-series data of the stock prices. An example of utilizing the linear approximator on historical stock price data is described below with reference to FIG. 32B. In the example, the same time-series data obtained in step 3002 can be de-trended to eliminate the bias during the predictions.

Process 3000 is shown to include generating a differenced time interval of the stock price data (step 3006). In effect, step 3006 can include determining the differenced time interval based on a start time and end time of the stock price data.

Process 3000 is shown to include converting time-series to a supervised learning problem and scaling the values (step 3008). Conversion of the time-series to the supervised learning problem can be based on the differenced time interval determined/generated in step 3006. By performing the conversion, the time-series (of the stock price data) can be appropriately utilized in a machine learning scenario. Scaling the values in the supervised learning problem may be necessary to later calculate an error in predictions.

Process 3000 is shown to include generating an LSTM model and making a rolling window forecast (step 3010). The LSTM model can be generated respective of the supervised learning problem defined in step 3008. The rolling window forecast can be set to have a predefined size. For example, the rolling window forecast may be set to a length of one day. In this case, predicted and expected values can be compared for each day. An example of the rolling window forecast is described below with reference to FIG. 32C.

Process 3000 is shown to include evaluating the forecasts (step 3012). Evaluation of the forecasts may include, for example, comparing predicted and expected values of the rolling window forecast for each day (or other period of time). If the predicted and expected values are similar (e.g., expected values are within a range of ±10% of the predicted values), the LSTM model may be evaluated as being overall accurate.

Process 3000 is shown to include generating one or more forecast predictions (step 3014). An example of predictions generated in step 3014 is described below with reference to FIG. 32D. In this case, problems related to a trend, assessment of the correct stock movement, etc., may be solved in models described below.

Process 3000 is shown to include performing a state estimation of event classifiers to learn weightages for a price-value optimization model (step 3016). Classifiers that may be utilized in step 3016 are described in greater detail above with reference to FIG. 1. In some embodiments, the price-value optimization model is a stochastic-multi agent system. As such, a Bayesian approximation methodology (e.g., a Bayesian belief network) may be applied to perform the state estimation. In some embodiments, generic weightages can be assigned to the classifiers. In some embodiments, domain knowledge from analysts and/or other sources is utilized to model the belief networks to allow for learning of the weightages as each new model is created. In this case, new models may be generated after a predefined amount of time (e.g., a week) for each company (or other establishment) of interest. As should be appreciated, each company of interest may be associated with an independent set of negative and positive classifiers describing a particular company.

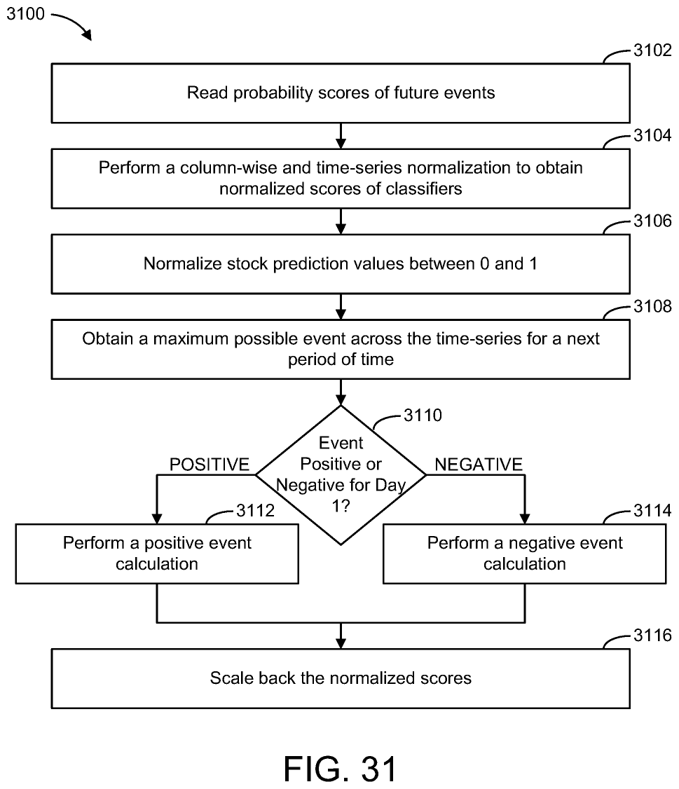

Process 3000 is shown to include applying a reward function algorithm (step 3018). In some embodiments, the reward function algorithm is based on the following equation:

$${G}_{t} ≐ {R}_{t + 1} + γ {R}_{t + 2} + {γ}^{2} {R}_{t + 3} + … = {\sum }_{k = 0}^{∞} {γ}^{k} {R}_{t + k + 1}$$

where Gₜ is an overall reward, Rₜ denotes a reward at time t, and γ is a discount-rate. An example of a reward function that can be applied in step 3018 is described in greater detail below with reference to FIG. 31. After step 3018, process 3000 may continue to step 3020 as shown in FIG. 30B.

Referring specifically to FIG. 30B, process 3000 is shown to include identifying a value function (step 3020). The value function can indicate how appropriate (good) it is to be in a particular state. In this case, states may indicate events for a day (or other time frame) when a reward is calculated. An example of the value function that may be utilized in step 3020 is provided by the following equation:

$${v}_{π} ( s ) ≐ {E}_{π} [ {G}_{t} \vert {S}_{t} = s ] = {E}_{π} [ {\sum }_{k = 0}^{∞} {γ}^{k} {R}_{t + k + 1} \vert {S}_{t} = s ] , \\ for all s ∈ S$$

where v_{π}(s) is an expected return starting with state s and successively following policy π, and S is a set of states.

Process 3000 is shown to include calculating a state-action value at each state (step 3022). The state-action value can indicate how appropriate an action can be at a particular state. In this case, the actions may include, for example, buying, selling, or holding a stock. In some embodiments, the state-action value for a state is calculated by the following equation:

$${q}_{π} ( s , a ) ≐ {E}_{π} [ {G}_{t} \vert {S}_{t} = s , {A}_{t} = a ] = {E}_{π} [ {\sum }_{k = 0}^{∞} {γ}^{k} {R}_{t + k + 1} \vert {S}_{t} = s , {A}_{t} = a ]$$

where q_{π}(s,a) is an action-value of the pair (s,a) under π, a is an action, and A is a set of actions. In some embodiments, calculation of the state-action value at each state accounts for emotion cognitive states as well.

Process 3000 is shown to include maximizing the value function to find an optimal policy that optimizes the increase or decrease in stock price (step 3024). In some embodiments, the maximization is performed based on the following equation:

$${π}^{*} = arg {max}_{π} {V}^{π} ( s ) ∀ s ∈ S$$

where π* is the optimal policy and V^{π}(s) defines a value of policy π at s. In some embodiments, if a large set of classifiers is available, an actor-critic model may be utilized in process 3000 to improve accuracy as opposed to the Q-learning model described.

Process 3000 is shown to include performing a rolling mean of the modified values (step 3026). Step 3026 can be performed to offset a large increase or decrease from the reward function calculation performed in step 3018. In some embodiments, performing the rolling mean can utilize an output of step 3018. However, if the policy iteration methodology is available (i.e., if step 3024 can be performed), performing the rolling mean can utilize an output of step 3024 (i.e., the optimal policy). It should be appreciated that if a proper function approximation and a good optimal policy calculation are performed in process 3000, the rolling mean may not be necessary. In this case, step 3026 may be optional in process 3000.

Process 3000 is shown to include generating a second LSTM model trained based on lookback values from the historical records of the stock price (step 3028). In some embodiments, the lookback values are included in the stock price data obtained in step 3002.

Process 3000 is shown to include applying the learned weights from the optimal policy and on the output of performing the rolling mean (step 3030). In effect, step 3030 can include applying the learned weights from step 3024 on the output of step 3026. Step 3030 may further include making necessary predictions based on applying the learned weights. Step 3030 can help maintain a trend but with necessary changes based on textual factors.

Process 3000 is shown to include re-generating models after a predetermined amount of time (step 3032). Re-generating the models can ensure that new events and factor probabilities that can further help with optimization are captured. In some embodiments, re-generation of the models may occur on a fixed time internal (e.g., every day, every week, etc.). In some embodiments, re-generation of the models is initiated by a user or automatically by a system.

Referring now to FIG. 31, a flow diagram of a process 3100 for calculating a reward function is shown, according to some embodiments. Specifically, process 3100 can further illustrate step 3018 of process 3000 as described with reference to FIG. 30A. As such, process 3100 may have any and/or all information available with regards to step 3018 of process 3000. Further, process 3100 may be performed by hypothesis engine 120 as described with reference to FIGS. 1 and 2.

Process 3100 is shown to include reading probability scores of future events (step 3102). In some embodiments, the probability scores are generated by an LSTM model for a company of interest.

Process 3100 is shown to include performing a column-wise and time-series normalization to obtain normalized scores of classifiers (step 3104). The column-wise and time-series normalization can allow for certain events (e.g., one-off events) to be muted and other events (e.g., events with high recurring likelihood) to be amplified.

Process 3100 is shown to include normalizing stock prediction values between 0 and 1 (step 3106). In this way, step 3106 can ensure a minimum possible value of the stock predictions is 0 whereas a maximum possible value is 1 which may be helpful in further calculations.

Process 3100 is shown to include obtaining a maximum possible event across the time-series for a next period of time (step 3108). The next period of time can be of any predefined length. For example, the next period of time may include the next six months.

Process 3100 is shown to include determining whether the maximum possible event is positive or negative for a first day (step 3110). If the event is positive for the first day (step 3110, “POSITIVE”), process 3100 can proceed to step 3112. If the event is negative for the first day (step 3110, “NEGATIVE”), process 3100 can proceed to step 3114. It should be appreciated that positive and negative in step 3110 refers to a positive/negative connotation of events as opposed to a literal value.

Process 3100 is shown to include performing a positive event calculation (step 3112). In some embodiments, step 3112 includes calculating a solution to the following equation:

|predₙₒᵣₘ+pₙₒᵣₘ|·w_{c}

where predₙₒᵣₘ is a normalized prediction for the particular day, pₙₒᵣₘ is a normalized event probability score for the particular day, and w_{c} is a weightage of the classifier.

Process 3100 is shown to include performing a negative event calculation (step 3114). In some embodiments, step 3114 includes calculating a solution to the following equation:

|predₙₒᵣₘ−pₙₒᵣₘ|·w_{c}

It should be noted that in steps 3112 and 3114, a movement of stock price based on the positivity and negativity of the events can be measured and calculated. Steps 3112 and 3114 can be further improved with additional classifiers.

Process 3100 is shown to include scaling back the normalized scores (step 3116). By scaling back the normalized scores, values that reflect actual stock prices can be obtained. In other words, the normalized scores can be scaled to not necessarily be between 0 and 1 (unless of course the scaled values themselves are between 0 and 1).

Referring now to FIG. 32A, a graph 3200 illustrating an example stock price over time is shown, according to some embodiments. In some embodiments, graph 3200 illustrates an example of stock price data that can be loaded/obtained in step 3002 of process 3000 as described with reference to FIG. 30A.

Referring now to FIG. 32B, a graph 3210 illustrating a de-trended version of graph 3200 of FIG. 32A is shown, according to some embodiments. In some embodiments, graph 3210 is generated by fitting a linear approximator to historical stock prices to eliminate bias caused due to trends in time-series. In some embodiments, graph 3210 is reflective of an output of step 3004 of process 3000.

Referring now to FIG. 32C, an illustration 3220 of an example rolling window forecast is shown, according to some embodiments. Illustration 3220 can show how a rolling window forecast can be made for each day (or other length of time) over a time period. In the rolling window forecast, predicted and expected values can be included. In some embodiments, illustration 3220 is a result of performing step 3010 of process 3000.

Referring now to FIG. 32D, a graph 3230 of an example comparison between actual stock prices versus predicted stock prices is shown, according to some embodiments. In some embodiments, graph 3230 can be generated by performing step 3014 of process 3000. It should be noted even though the predictions are included in graph 3230, there are various problems related to the trend, assessing the correct stock movement, etc. The problems can be addressed by other models.

In some embodiments, any and/or all of the systems and/or methods described herein can incorporate techniques as described in U.S. Pat. No. 9,727,371 granted Aug. 8, 2017, U.S. patent Ser. No. 10/268,507 granted Apr. 23, 2019, U.S. patent application Ser. No. 16/293,801 filed Mar. 6, 2019, and U.S. Provisional Patent Application No. 62/887,609 filed Aug. 15, 2019, each of which are incorporated by reference herein in their entirety.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A language computing system, the system comprising:
one or more processing circuits comprising one or more processors and memory storing instructions that, when executed by the one or more processors, cause the one or more processors to perform operations comprising:
obtaining one or more textual documents including information related to a company;
generating a future pattern model describing patterns of the company;
providing the one or more textual documents to the future pattern model to generate a predicted pattern of the company; and
providing the predicted pattern to a user.

2. The language computing system of claim 1, the operations further comprising:
extracting the information related to the company from the one or more textual documents; and
generating an ontological graph based on the extracted information, the ontological graph describing one or more relationships of the company.

3. The language computing system of claim 2, wherein the ontological graph is at least one of:
a domain graph;
a knowledge graph; or
a decision graph.

4. The language computing system of claim 1, the operations further comprising:
providing the predicted pattern to a second user for validation;
in response to receiving an indication that the predicted pattern is valid, the predicted pattern to the user; and
in response to receiving an indicated that the predicted pattern is not valid, retraining the future pattern model.

5. The language computing system of claim 1, the operations further comprising:
obtaining one or more classifiers;
generating a historical pattern model for estimating a probability that a particular textual document includes each of the one or more classifiers; and
providing the one or more textual documents to the historical pattern model to obtain a set of probabilities;
wherein the future pattern model is generated based on the set of probabilities.

6. The language computing system of claim 1, wherein the future pattern model is a long short-term memory model.

7. The language computing system of claim 1, wherein the predicted pattern is a predicted stock trend for the company.

8. A method for generating pattern predictions, the method comprising:
obtaining one or more textual documents including information related to a company;
generating a future pattern model describing patterns of the company;
providing the one or more textual documents to the future pattern model to generate a predicted pattern of the company; and
providing the predicted pattern to a user.

9. The method of claim 8, further comprising:
extracting the information related to the company from the one or more textual documents; and
generating an ontological graph based on the extracted information, the ontological graph describing one or more relationships of the company.

10. The method of claim 9, wherein the ontological graph is at least one of:
a domain graph;
a knowledge graph; or
a decision graph.

11. The method of claim 8, further comprising:
providing the predicted pattern to a second user for validation;
in response to receiving an indication that the predicted pattern is valid, the predicted pattern to the user; and
in response to receiving an indicated that the predicted pattern is not valid, retraining the future pattern model.

12. The method of claim 8, further comprising:
obtaining one or more classifiers;
generating a historical pattern model for estimating a probability that a particular textual document includes each of the one or more classifiers; and
providing the one or more textual documents to the historical pattern model to obtain a set of probabilities;
wherein the future pattern model is generated based on the set of probabilities.

13. The method of claim 8, wherein the future pattern model is a long short-term memory model.

14. The method of claim 8, wherein the predicted pattern is a predicted stock trend for the company.

15. An emotion recognition system for speech processing, the system comprising:
one or more processing circuits comprising one or more processors and memory storing instructions that, when executed by the one or more processors, cause the one or more processors to perform operations comprising:
receiving a speech signal;
analyzing the speech signal at a frame-level to identify one or more low-level descriptors of the speech signal;
analyzing the speech signal at an utterance level to identify one or more utterance-level descriptors; and
determining an emotion associated with the speech signal based on the one or more low-level descriptors and the one or more utterance-level descriptors.

16. The emotion recognition system of claim 15, wherein the one or more low-level descriptors comprise at least one of:
a mel-frequency cepstral coefficient;
a linear prediction cepstral coefficient; or
a residual mel-frequency cepstral coefficient.

17. The emotion recognition system of claim 15, wherein analyzing the speech signal at the utterance level comprises:
training a long short-term memory (LSTM) autoencoder to predict itself; and
collecting a hidden representation at an end of the LSTM autoencoder, the hidden representation representing the speech signal.

18. The emotion recognition system of claim 15, the operations further comprising providing the determined emotion associated with the speech signal to a user.

19. An impact analysis system, the system comprising:
one or more processing circuits comprising one or more processors and memory storing instructions that, when executed by the one or more processors, cause the one or more processors to perform operations comprising:
obtaining results of a customer survey;
identifying one or more topics based on the customer survey;
performing an impact analysis to calculate topic impact scores for each of the one or more topics, wherein a topic impact score for a topic indicates an impact of the topic on customer behavior changes;
generating an impact analysis report indicating the topic impact scores; and
providing the impact analysis report to a user.

20. The impact analysis system of claim 19, the operations further comprising identifying one or more factors and associated coefficients, wherein the topic impact scores are calculated with respect to the one or more factors and associated coefficients.

21. The impact analysis of claim 20, wherein performing the impact analysis comprises:
calculating a topic frequency difference as a difference between an overall topic frequency and a topic frequency by the one or more factors; and
calculating the topic impact scores based on the topic frequency difference and coefficients associated with the one or more factors.

22. The impact analysis system of claim 19, wherein the impact analysis report comprises at least one of:
a scatter plot illustrating the topic impact scores; or
a bar chart illustrating the topic impact scores.

23. The impact analysis system of claim 19, the operations further comprising auditing the impact analysis report for accuracy prior to providing the impact analysis report to the user.
